(19) United States
(12) Patent Application Publication
(10) Pub. No.: US 2024/0270267 A1
(43) Pub. Date: Aug. 15, 2024

(54) MANAGEMENT METHOD FOR DRIVING-CHARACTERISTICS IMPROVING ASSISTANCE DATA

(71) Applicant: PANASONIC AUTOMOTIVE SYSTEMS CO., LTD., Kanagawa (JP)

(72) Inventors: Toshihiro MIYAMICHI, Kanagawa (JP); Naoki USUI, Kanagawa (JP); Tsuyoshi NISHIO, Chiba (JP)

(73) Assignee: PANASONIC AUTOMOTIVE SYSTEMS CO., LTD., Kanagawa (JP)

(21) Appl. No.: 18/643,442

(22) Filed: Apr. 23, 2024

Related U.S. Application Data
(63) Continuation of application No. PCT/JP2022/032660, filed on Aug. 30, 2022.

(30) Foreign Application Priority Data
Oct. 25, 2021 (JP) 2021-174125
Nov. 29, 2021 (JP) 2021-193603
Jul. 29, 2022 (JP) 2022-121788

(51) Int. Cl. B60W 50/08; B60W 50/00; B60W 50/04

(52) U.S. Cl. CPC B60W 50/08; B60W 50/045; B60W 2050/0083; B60W 2050/046; B60W 2556/45

(57) ABSTRACT

A control method executable by a computer configured to cooperate with at least a first vehicle and a second vehicle, the control method includes receiving input of personal-characteristics data corresponding to a driver who drives the first vehicle, the personal-characteristics data being acquired by the first vehicle and being used for improving assistance of driving-characteristics of the driver, and when a predetermined condition is satisfied, outputting the personal-characteristics data corresponding to the driver such that the personal-characteristics data can be used by the second vehicle.

### CROSS-REFERENCE TO RELATED APPLICATIONS

The present application is a continuation application of PCT/JP2022/032660 that claims priority to Japanese Patent Application No. 2021-174125 filed on Oct. 25, 2021, Japanese Patent Application No. 2021-193603 filed on Nov. 29, 2021, and Japanese Patent Application No. 2022-121788 filed on Jul. 29, 2022, the entire contents of which are incorporated herein by reference.

### TECHNICAL FIELD

The present disclosure relates to a management method for driving-characteristics improving assistance data.

### BACKGROUND ART

In the related art, there has been a vehicle warning device and a driving assistance device for assisting safety confirmation, driving operation, and the like during the driving of the driver.

For example, Patent Literature 1 discloses a driver identification system that acquires biological information on the driver of the vehicle and identifies the driver based on the acquired biological information. The driver identification system acquires the biological information periodically and if it is determined that information from an electronic device mounted on the vehicle satisfies a predetermined condition.

For example, Patent Literature 2 discloses a vehicle warning device that determines whether the driver needs to confirm the safety based on the correlation between a predetermined road parameter of the road on which the vehicle travels and the steering angle, and issues a warning to the driver if it is determined that safety confirmation is not performed. Patent Literature 3 discloses a driving assistance device that learns the driving proficiency level of the driver based on the history of driving operations of the driver and performs driving assistance according to a driving assistance level based on the driving proficiency level. Patent Literature 4 discloses a driving assistance device that estimates the driver state of the driver with respect to the external environment from an environmental difficulty level required for a driving operation of the driver by the external environment of the vehicle and a driving skill based on the driving operation of the driver, and performs or prohibits driving assistance according to the driving skill and the driver state.

For example, Patent Literature 5 discloses an information processing device including a processor that controls the transfer of learning data used for training a first artificial intelligence module to a second artificial intelligence module when receiving a transfer instruction of artificial intelligence module. Patent Literature 6 discloses method for providing an artificial intelligence service including: receiving input of user data including user biological information; and providing an artificial intelligence service by applying an artificial intelligence model generated by user adaptive training of converting a base artificial intelligence model to fit the characteristics of the user data. Patent Literature 7 discloses an artificial intelligence system including: a first artificial intelligence unit that, in a non-secure environment accessible from the outside of the artificial intelligence system, acquires information on a user and outputs a learning result based on the information on the user to the outside; and a second artificial intelligence unit that, in a secure environment not accessible from the outside, acquires the information on the user from the first artificial intelligence unit and accumulates data related to the information on the user. If the information on the user acquired from the outside is delivered to the second artificial intelligence unit, the information on the user is deleted from the non-secure environment related to the first artificial intelligence unit.

### CITATION LIST

### Patent Literature

Patent Literature 1: JP2015-71319A
Patent Literature 2: JP2007-233476A
Patent Literature 3: JP2009-48307A
Patent Literature 4: JP2015-110417A
Patent Literature 5: JP2021-18457A
Patent Literature 6: JP2021-529978A
Patent Literature 7: JP2021-105796A

### SUMMARY OF INVENTION

### Technical Problem

However, according to the information processing device, the artificial intelligence service providing method, and the artificial intelligence system described above, if driving assistance for the same driver is to be performed in a plurality of different vehicles, the driving assistance that can be implemented in each vehicle is different, which leaves room for improvement.

An object of the present disclosure is to provide a control method for assisting the management of driving-characteristics data on a driver collected by different vehicles and the transfer of the driving-characteristics data on the driver between the vehicles.

### Solution to Problem

The present disclosure provides a control method executable by a computer configured to cooperate with at least a first vehicle and a second vehicle. The control method includes: receiving input of personal-characteristics data corresponding to a driver who drives the first vehicle, the personal-characteristics data being acquired by the first vehicle and being used for improving assistance of driving-characteristics of the driver; and, when a predetermined condition is satisfied, outputting the personal-characteristics data corresponding to the driver such that the personal-characteristics data can be used by the second vehicle.

### Advantageous Effects of Invention

According to the present disclosure, it is possible to assist the management of driving-characteristics data on a driver collected by different vehicles and the transfer of the driving-characteristics data on the driver between the vehicles.

### BRIEF DESCRIPTION OF DRAWINGS

FIG. 1 is a diagram illustrating an example of a use case example of a driving-characteristics management system according to Embodiment 1.

FIG. 2 is a block diagram illustrating an example of the internal configuration of a vehicle according to Embodiment 1.

FIG. 3 is a block diagram illustrating an example of the internal configuration of a driving-characteristics server according to Embodiment 1.

FIG. 4 is a block diagram illustrating an example of the internal configuration of a license server according to Embodiment 1.

FIG. 5 is a sequence diagram illustrating an example of a driver initial registration procedure of the driving-characteristics management system according to Embodiment 1.

FIG. 6 is a flowchart illustrating an example of the driver initial registration procedure in a vehicle.

FIG. 7 is a flowchart illustrating an example of a vehicle ID registration procedure in the vehicle.

FIG. 8 is a flowchart illustrating an example of a license ID registration procedure in the vehicle.

FIG. 9 is a flowchart illustrating an example of a driver face image registration procedure in the vehicle.

FIG. 10 is a flowchart illustrating an example of the driver initial registration procedure in the driving-characteristics server.

FIG. 11 is a flowchart illustrating an example of the vehicle ID registration procedure in the driving-characteristics server.

FIG. 12 is a flowchart illustrating an example of the license ID registration procedure in the driving-characteristics server.

FIG. 13 is a flowchart illustrating an example of the driver face image registration procedure in the driving-characteristics server.

FIG. 14 is a sequence diagram illustrating an example of a driver driving-characteristics data collection procedure of the driving-characteristics management system according to Embodiment 1.

FIG. 15 is a flowchart illustrating an example of a driver driving-characteristics data acquisition procedure in the vehicle.

FIG. 16 is a flowchart illustrating an example of a driver driving-characteristics data collection procedure in the driving-characteristics server.

FIG. 17 is a diagram illustrating an example of a use case of the driving-characteristics improving assistance system according to Embodiment 2.

FIG. 18 is a block diagram illustrating an example of the internal configuration of a vehicle according to Embodiment 2.

FIG. 19 is a diagram illustrating an example of a driving-characteristics history table.

FIG. 20 is a block diagram illustrating an example of the internal configuration of a driving-characteristics improving server according to Embodiment 2.

FIG. 21 is a diagram illustrating an example of a driving-characteristics improving management table.

FIG. 22 is a diagram illustrating an example of a safety confirmation behavior during left turn.

FIG. 23 is a diagram illustrating an example of a safety confirmation behavior during right turn.

FIG. 24 is a diagram illustrating an example of a safety confirmation behavior during backward movement.

FIG. 25 is a diagram illustrating an example of a safety confirmation behavior when moving forward on a straight long road.

FIG. 26 is a diagram illustrating an example of sensing the safety confirmation behavior of the driver for each driving situation.

FIG. 27 is a diagram illustrating an arrangement example of warning display lamps.

FIG. 28 is a diagram illustrating an arrangement example of speakers.

FIG. 29 is a diagram illustrating a modification of driving-characteristics improving assistance.

FIG. 30 is a flowchart illustrating an example of the operation procedure of the driving-characteristics improving assistance system according to Embodiment 2.

FIG. 31 is a flowchart illustrating an example of the operation procedure of the driving-characteristics improving assistance system according to Embodiment 2.

FIG. 32 is a diagram illustrating an example of a use case of the driving-characteristics improving assistance system according to Embodiment 3.

FIG. 33 is a block diagram illustrating an example of the internal configuration of a vehicle according to Embodiment 3.

FIG. 34 is a block diagram illustrating an example of the internal configuration of a driving-characteristics improving server according to Embodiment 3.

FIG. 35 is a block diagram illustrating an example of the internal configuration of an operation terminal according to Embodiment 3.

FIG. 36 is a diagram illustrating an example of a personal information/personal-characteristics data table.

FIG. 37 is a sequence diagram illustrating a transfer procedure example 1 of transfer data on the driver in the driving-characteristics management system according to Embodiment 3.

FIG. 38 is a sequence diagram illustrating a transfer procedure example 2 of the transfer data on the driver in the driving-characteristics management system according to Embodiment 3.

FIG. 39 is a diagram illustrating transfer examples 1 and 2 of the transfer data on the driver.

FIG. 40 is a diagram illustrating Modification 1 of the driving-characteristics improving assistance operation between vehicles.

FIG. 41 is a diagram illustrating Modification 2 of the driving-characteristics improving assistance operation between vehicles.

FIG. 42 is a screen transition diagram for explaining an example of deleting the transfer data.

FIG. 43 is a screen transition diagram illustrating an example of setting the transfer data.

FIG. 44 is a screen transition diagram for explaining an example of searching the transfer data.

FIG. 45 is a screen transition diagram for explaining an example of editing the transfer data.

### DESCRIPTION OF EMBODIMENTS

### (Background of Embodiment 1)

In recent years, systems capable of implementing online user identity confirmation include, for example, electronic Know Your Customer (eKYC). The eKYC acquires a face image or a video obtained by imaging the face of the user transmitted from a user terminal (for example, a personal computer (PC), a smart phone, a tablet terminal, or the like), and a video of an identity confirmation document describing both the personal information such as the name, address, date of birth, and the like of the user and the face image of the user (for example, a driver's license, a residence card, a passport, a My Number Card, or the like). The eKYC performs identity confirmation of the user by comparing registration information related to the user registered in advance (for example, a video, various personal information described in the identity confirmation document, and the like) with the acquired face image or video of the user and the video of the identity confirmation document.

In the related art, there has been a driver identification system that identifies the driver by acquiring biological information on the driver and information related to a driving operation of the driver from the vehicle, and records driving feature information on the identified driver in association with a vehicle ID driven by the driver (for example, Patent Literature 1: JP2015-71319A). However, since the driver identification system records the driving feature information on the driver in association with the vehicle ID driven by the driver, it is difficult to record and manage the driving feature information for each driver if the vehicle is a vehicle driven by a plurality of different drivers such as a rental car and a shared car.

In addition, in recent years, accidents caused by driving operation errors due to the aging of elderly drivers have increased. Efforts for preventing such accidents include, for example, cognitive function tests for elderly drivers upon updating the driver's license, prompting elderly drivers of a predetermined age or more to give up the driver's license, and the like. However, if the driver's license is given up, an elderly driver may lose the transportation means, which is necessary for independent daily life. Therefore, in the determination of the necessity of giving up the driver's license, it is desired to visualize the change in the driving operation of an elderly driver by objectively evaluating the driving operation of the elderly driver using the collected driving-characteristics data. However, the driver identification system is not assumed to collect or manage the driving-characteristics data for the above-described purpose of obtaining the driving evaluation for each driver.

The following Embodiment 1 describes an example of a management method for driving-characteristics data and an on-vehicle device for more efficiently collecting the driving-characteristics data for each driver and assisting the management of the collected driving-characteristics data.

Hereinafter, embodiments for specifically disclosing the management method for driving-characteristics data, the on-vehicle device, and a management method for driving-characteristics improving assistance data according to the present disclosure will be described in detail with reference to the drawings as appropriate. However, unnecessarily detailed descriptions may be omitted. For example, the detailed description of well-known matters and the redundant description of substantially the same configuration may be omitted. This is to avoid unnecessary redundancy of the following description and facilitate understanding of those skilled in the art. The accompanying drawings and the following descriptions are provided for those skilled in the art to fully understand the present disclosure and are not intended to limit the subject matters described in the claims.

### Embodiment 1

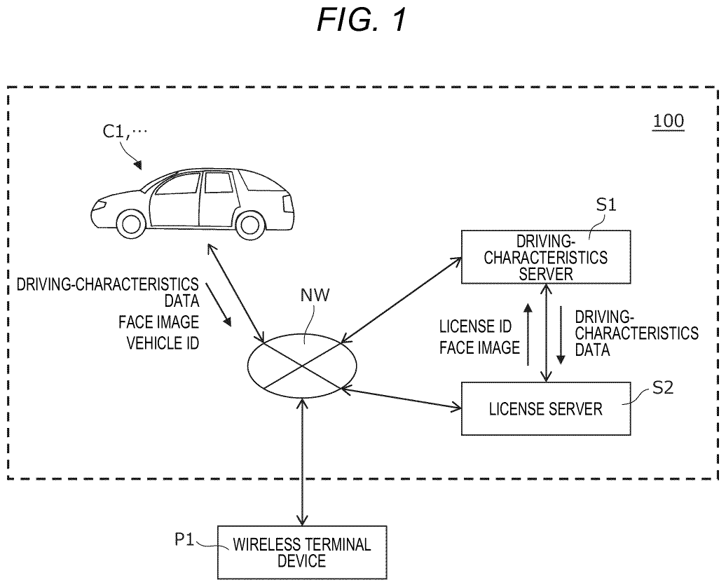

An example of a use case of a driving-characteristics management system 100 according to Embodiment 1 will be described with reference to FIG. 1. FIG. 1 is a diagram illustrating an example of a use case of a driving-characteristics management system 100 according to Embodiment 1. FIG. 1 illustrates an example of the driving-characteristics management system 100 transmitting a face image of a driver as an example of biological information.

The driving-characteristics management system 100 includes one or more vehicles C1, . . . , a driving-characteristics server S1, a license server S2, and a network NW. The driving-characteristics management system 100 may include a wireless terminal device P1.

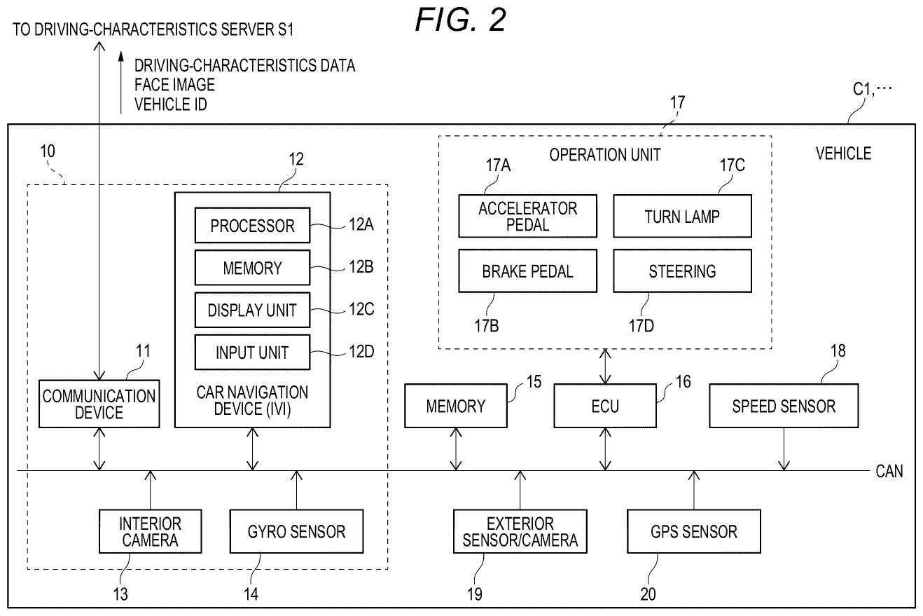

The driving-characteristics management system 100 acquires driving-characteristics data on a driver who drives each of the one or more vehicles C1, . . . . The driving-characteristics data is transmitted from a communication device 11 mounted on the vehicle (see FIG. 2). The acquired driving-characteristics data is accumulated in the driving-characteristics server S1 in association with a driver's license identification (ID) and managed by the driving-characteristics management system 100. The driving-characteristics management system 100 manages the license ID of each of the plurality of drivers registered in advance in the license server S2. The driving-characteristics management system 100 executes the driving evaluation for each driver by the driving-characteristics server S1 or the license server S2, and transmits and outputs the driving evaluation result to the wireless terminal device P1 or a car navigation device 12.

The driving-characteristics data referred to here is data indicating the driving-characteristics of the driver, and is acquired by various sensors mounted on each of the vehicles C1, . . . (for example, an interior camera 13, a gyro sensor 14, an accelerator pedal 17A, a brake pedal 17B, a turn lamp 17C, a speed sensor 18, an exterior sensor/camera 19, a GPS sensor 20, a steering wheel 17D, and the like (see FIG. 2)).

For example, the driving-characteristics data is data indicated by at least one of a driving-characteristics parameter or a driving-characteristics vector, and is one or more pieces of data such as the acceleration during traveling, the jerk, the lateral G (that is, the acceleration occurring at a right angle to the traveling direction), the steering angle, the type of the road during traveling, the speed exceeding the speed limit of the road during traveling, and the sight line direction of the driver. The driving-characteristics data is not limited to the above-described examples, and may be data indicating the driving-characteristics of the driver obtained by combining two or more pieces of such data.

The driving-characteristics parameter is the value (parameter) of each piece of data included in the driving-characteristics data. The driving-characteristics vector is an arithmetic average value calculated based on the number of pieces of data included in the driving-characteristics data and the value of each piece of data. For example, the driving-characteristics vector is represented by an Nth-order vector, where N (N: an integer of 1 or more) is the number of pieces of driving-characteristics data.

Each of the vehicles C1, . . . is wirelessly communicably connected to the driving-characteristics server S1 via the network NW. The wireless communication referred to here is, for example, a wireless LAN represented by Wi-Fi (registered trademark), and the type thereof is not particularly limited. When driven by the driver for the first time, each of the vehicles C1, . . . generates a control command for requesting initial registration of the driver, and transmits the license ID of the driver to be initially registered to the driving-characteristics server S1 in association with the biological information and the vehicle ID. While being driven by the driver, each of the vehicles C1, . . . transmits the driving-characteristics data on the driver to the driving-characteristics server S1 in association with the vehicle ID, and records the driving-characteristics data on the driver and the vehicle ID in association with the license ID of the initially registered driver.

In the initial registration, each of the vehicles C1, . . . receives an operation by the driver for requesting initial registration of the license ID in the driving-characteristics server S1 via an input unit 12D of the car navigation device 12 (see FIG. 2). Each of the vehicles C1, . . . acquires the license ID of the driver and the biological information on the driver, and transmits the acquired license ID and biological information on the driver to the driving-characteristics server S1 in association with a vehicle ID for identifying the host vehicle (for example, number plate information).

During the driving-characteristics data collection, each of the vehicles C1, . . . starts acquiring the driving-characteristics data by the various sensors from a timing of detecting the entry of the driver, and transmits the acquired driving-characteristics data to the driving-characteristics server S1 in association with the vehicle ID. In addition, each of the vehicles C1, . . . , starts acquiring the biological information on the driver from the timing of detecting the entry of the driver, transmits the acquired biological information on the driver to the driving-characteristics server S1 in association with the vehicle ID, and requests the driving-characteristics server S1 to perform driver authentication (that is, identification of the driver). Each of the vehicles C1, . . . may transmit the driving-characteristics data and the biological information on the driver to the driving-characteristics server S1 in association with the vehicle ID. Further, each of the vehicles C1, . . . ends acquiring and transmitting of the biological information on the driver when acquiring an electric signal transmitted from the driving-characteristics server S1 indicating the completion of the driver authentication (that is, the transmitted biological information on the driver matches the biological information registered in the driving-characteristics server S1).

Each of the vehicles C1, . . . ends acquiring the driving-characteristics data and the biological information by the various sensors at the timing of detecting the end of driving by the driver.

The license ID referred to here is an image of the driver's license of the driver who drives the vehicle, captured by the interior camera 13, or information related to the driver's license acquired by a license reader (not illustrated) capable of reading the license ID written on the driver's license (for example, a face image of the driver, information related to the driver, various numbers assigned for identifying the driver, or the like). The license reader may be capable of transmitting to a processor 12A a license ID read by near distance wireless communication such as near field communication (NFC) or Bluetooth (registered trademark), or may be capable of transmitting to the processor 12A a license ID read by wired communication with the car navigation device 12 such as universal serial bus (USB).

The license ID may be information related to the driver's license acquired by analyzing an image captured by the interior camera 13 or information related to the driver's license input by the driver through an input operation to the input unit 12D of the car navigation device 12 (see FIG. 2).

The biological information on the driver referred to here is one or more face images, iris, fingerprint, vein, voice, or the like of the driver. If the biological information on the driver is iris, fingerprint, vein, voice, or the like of the driver, each of the vehicles C1, . . . may include a device (not illustrated) or a sensor (not illustrated) capable of acquiring the iris, fingerprint, vein, voice, or the like of the driver.

The face image of the driver is captured by the interior camera 13. In addition, it is desirable that the number of face images of the driver captured at the time of initial registration be plural, and at least one face image captured when the driver faces the front (hereinafter, referred to as a “front face image”) is included. If the number of face images captured at the time of initial registration is two or more, the interior camera 13 analyzes the face orientation of the driver by image analysis, and captures a front face image and one or more face images captured when the driver is facing a direction other than the front (for example, left, right, or the like). In the following description, a face image captured when facing leftward is referred to as a “left face image”, and a face image captured when facing rightward is referred to as a “right face image”.

The iris may be acquired by image analysis performed by an ICM (intelligent control module; not illustrated) mounted on the vehicles C1, . . . , the car navigation device 12, or the driving-characteristics server S1 using the face image of the driver captured by the interior camera 13.

The fingerprint may be acquired by image analysis performed by the ICM mounted on the vehicles C1, . . . , the car navigation device 12, or the driving-characteristics server S1 using one or more fingertip images of the driver captured by the interior camera 13, or may be acquired by a fingerprint sensor (not illustrated) included in the vehicles C1, . . . , a steering wheel 17D having a fingerprint sensor function, or the like.

The vein may be acquired by image analysis performed by the ICM mounted on the vehicles C1, . . . , the car navigation device 12, or the driving-characteristics server S1 using the hand image of the driver captured by the interior camera 13, or may be acquired by a vein sensor (not illustrated) included in the vehicles C1, . . . .

The voice is the voice of the driver received by a microphone of the car navigation device 12 or another microphone (not illustrated). The voice received here may be a predetermined key word or the like.

The driving-characteristics server S1 is connected to each of the vehicles C1, . . . , the wireless terminal device P1, and the license server S2 via the network NW for data communication. The driving-characteristics server S1 executes the initial registration based on the control command for requesting the initial registration of the driver transmitted from each of the vehicles C1, . . . . The driving-characteristics server S1 collects the driving-characteristics data on the driver transmitted from each of the vehicles C1, . . . , and records the collected driving-characteristics data on the driver in association with the license ID of the initially registered driver.

In the initial registration, the driving-characteristics server S1 acquires the control command for requesting the initial registration of the driver transmitted from each of the vehicles C1, . . . , the biological information on the driver to be initially registered, the license ID, and the vehicle ID. The driving-characteristics server S1 compares the acquired biological information on the driver with the license ID, and executes a determination whether the driver indicated by the biological information and the driver indicated by the license ID are the same person (that is, identity confirmation). If it is determined that the drivers indicated by the acquired biological information and the license ID are the same person, the driving-characteristics server S1 registers (initially registers) the license ID of the driver in association with the face image of the driver and the vehicle ID. The face image of the driver registered here may be one front face image, or may be one front face image and one or more right face images or left face images.

When collecting the driving-characteristics data, the driving-characteristics server S1 acquires the biological information and the driving-characteristics data on the driver and the vehicle ID transmitted from each of the vehicles C1, . . . , and compares the acquired biological information on the driver with each piece of the biological information on the plurality of initially registered drivers. If it is determined that the compared driver exists among the biological information on the plurality of drivers, the driving-characteristics server S1 records the acquired driving-characteristics data and vehicle ID in association with the license ID of the driver.

The driving-characteristics server S1 executes the driving evaluation using the driving-characteristics data on the predetermined driver based on the control command for requesting the driving evaluation result of the predetermined driver transmitted from the license server S2. The driving-characteristics server S1 generates a driving evaluation result and transmits the driving evaluation result to the wireless terminal device P1. In such a case, the wireless terminal device P1 is possessed by, for example, a police clerk who determines the update of the driver's license, an insurance clerk who handles the insurance (commodity) related to automobile, or the like. Accordingly, the police clerk can determine whether to update the driver's license based on the driving evaluation result of the predetermined driver displayed by the wireless terminal device P1. Similarly, the insurance clerk can calculate the automobile insurance fee of the predetermined driver based on the driving evaluation result of the predetermined driver (that is, an index indicating the degree of safe driving) displayed by the wireless terminal device P1.

The driving-characteristics server S1 acquires a control command for requesting driving-characteristics data on a predetermined driver transmitted from the wireless terminal device P1 owned by the driver. The driving-characteristics server S1 compares the license ID or the biological information included in the control command transmitted from the wireless terminal device P1 with the license IDs or the biological information on the plurality of registered drivers. The driving-characteristics data on the driver corresponding to the license ID or the biological information included in the control command and the vehicle ID of the vehicle from which the driving-characteristics data is acquired are extracted based on the comparison result and transmitted to the wireless terminal device P1 or the car navigation device 12 by the driving-characteristics server S1.

If the driving evaluation of the driver is to be executed based on the driving-characteristics data accumulated by the driving-characteristics server S1, the driving evaluation result of the driver corresponding to the license ID or the biological information included in the control command may be generated and transmitted to the wireless terminal device P1 or the car navigation device 12 by the driving-characteristics server S1.

The license server S2 is connected to the driving-characteristics server S1 and the wireless terminal device P1 via the network NW for data communication. The license server S2 records and manages the license IDs of a plurality of drivers. The information recorded and managed by the license server S2 is not limited to the license IDs, and may be, for example, information related to the update of the driver's license, the driving evaluation result using driving-characteristics data, or the like.

The license server S2 acquires a control command for requesting driving-characteristics data on a predetermined driver transmitted from the wireless terminal device P1. The license server S2 compares the license ID or the biological information included in the control command transmitted from the wireless terminal device P1 with the license IDs or the biological information on the plurality of registered drivers, and transmits the comparison result to the driving-characteristics server S1. The driving-characteristics data on the driver corresponding to the license ID or the biological information included in the control command and the vehicle ID of the vehicle from which the driving-characteristics data is acquired are extracted based on the comparison result and transmitted to the license server S2 by the driving-characteristics server S1.

If the driving evaluation of the driver is to be executed based on the driving-characteristics data accumulated by the driving-characteristics server S1, the driving evaluation result of the driver corresponding to the license ID or the biological information included in the control command may be generated and transmitted to the license server S2 by the driving-characteristics server S1.

The wireless terminal device P1 is communicably connected to the driving-characteristics server S1 via the network NW. The wireless terminal device P1 is, for example, a personal computer (PC), a notebook PC, a tablet terminal, or a smart phone owned by the driver, a relative of the driver, a police officer, an insurance clerk, or the like. The wireless terminal device P1 is not limited to the above-described example, and may be the car navigation device 12 mounted on the vehicles C1, . . . .

The wireless terminal device P1 can receive an input operation by the driver, a relative of the driver, or the like, and generates a control command for requesting the driving evaluation result of the driver based on the input operation. The wireless terminal device P1 acquires the driver's license ID or biological information, and transmits the acquired driver's license ID or biological information to the driving-characteristics server S1 in association with the control command. If the driving evaluation result of the driver transmitted from the driving-characteristics server S1 is acquired, the wireless terminal device P1 outputs the acquired driving evaluation result of the driver to a monitor (not illustrated) of the wireless terminal device P1. If the wireless terminal device P1 is implemented with the car navigation device 12, the wireless terminal device P1 (that is, the car navigation device 12) outputs the acquired driving evaluation result of the driver to a display unit 12C of the car navigation device 12.

The network NW wirelessly communicably connects each of the plurality of vehicles C1, . . . to the driving-characteristics server S1 and the license server S2 and connects the driving-characteristics server S1 to the wireless terminal device P1.

Next, an example of the internal configuration of the vehicles C1, . . . in Embodiment 1 will be described with reference to FIG. 2. FIG. 2 is a block diagram illustrating an example of the internal configuration of vehicles C1, . . . according to Embodiment 1. The internal configuration of the vehicles C1, . . . illustrated in FIG. 2 illustrates an example of the internal configuration in a case where a face image of the driver is used as biological information, and the illustration of the sensors for acquiring the other biological information, the license reader, and the like is omitted. Since the vehicles C1, . . . have the same internal configuration, the internal configuration of the vehicle C1 will be described below.

The vehicle C1 includes at least a communication device 11, a car navigation device 12, an interior camera 13, a gyro sensor 14, a memory 15, and an electronic control unit (ECU) 16. Each unit inside the vehicle C1 is connected to a controller area network (CAN) or the like to transmit and receive data.

The communication device 11, the car navigation device 12, the interior camera 13, and the gyro sensor 14 may be integrated into one car navigation device 10. The sensor mounted on the vehicle C1 illustrated in FIG. 2 is an example and is not limited thereto.

The communication device 11 transmits and receives data between the vehicle C1 and the driving-characteristics server S1 via the network NW by wireless communication. The communication device 11 transmits the driver's license ID, the biological information (here, one or more face images), the vehicle ID, the driving-characteristics data, and the like to the driving-characteristics server S1. The communication device 11 receives, and outputs to the processor 12A, an electric signal for notifying the completion of the initial registration transmitted from the driving-characteristics server S1, an electric signal for notifying the completion of the identification of the driver, and the like.

The car navigation device 12 is a device capable of receiving an operation of the driver. The car navigation device 12 may be an in-vehicle infotainment (IVI) device capable of providing, for example, a car navigation function, a position information providing service function, an Internet connection function, and a multimedia play function. The car navigation device 12 includes the processor 12A, a memory 12B, the display unit 12C, and the input unit 12D.

The processor 12A is implemented using, for example, a central processing unit (CPU), a digital signal processor (DSP), or a field programmable gate array (FPGA), and controls the operation of each unit. The processor 12A performs the overall processing and control in cooperation with the memory 12B. Specifically, the processor 12A implements functions of each unit by referring to a program and data stored in the memory 12B and executing the program.

The processor 12A starts the initial registration based on a control command for starting the initial registration of the driver in the driving-characteristics server S1 output from the input unit 12D. The processor 12A transmits one or more face images of the driver captured by the interior camera 13, an image capturing the driver's license (license ID), the vehicle ID, and a control command for requesting the initial registration of the driver to the driving-characteristics server S1 in association. The license ID may be license information input to the input unit 12D by an operation of the driver. Similarly, the license ID may be number plate information input to the input unit 12D by an operation of the driver.

The processor 12A starts acquiring the driving-characteristics data on the driver from a timing of acquiring a control command indicating the detection of the entry of the driver from the ECU 16 or the communication device 11. The processor 12A acquires the angular speed of the vehicle C1 as the driving-characteristics data based on the electric signal output from the gyro sensor 14, and acquires various driving-characteristics data acquired by the various sensors (for example, the interior camera 13, the gyro sensor 14, the accelerator pedal 17A, the brake pedal 17B, the turn lamp 17C, the speed sensor 18, the exterior sensor/camera 19, the GPS sensor 20, the steering wheel 17D, or the like) via the ECU 16. The driving-characteristics data acquired by the various sensors will be described later. The processor 12A transmits the acquired driving-characteristics data to the driving-characteristics server S1 in association with the vehicle ID. In addition, the processor 12A causes the interior camera 13 to capture a face image of the driver as the biological information on the driver used for registering or identifying the driver by the driving-characteristics server S1. The processor 12A transmits the face image of the driver output from the interior camera 13 to the driving-characteristics server S1 in association with the vehicle ID.

The processor 12A ends acquiring the driving-characteristics data on the driver and the transmission of the driving-characteristics data to the driving-characteristics server S1 at a timing of acquiring a control command indicating the detection of the exit of the driver from the ECU 16 or the communication device 11. The processor 12A may end the imaging by the interior camera 13 based on a control command indicating the completion of the initial registration or the face comparison of the driver transmitted from the driving-characteristics server S1.

The processor 12A may perform image analysis on the face image of the driver output from the interior camera 13 to perform line-of-sight detection, drowsiness detection, emotion detection, and the like on the driver. The processor 12A transmits the detection result as driving-characteristics data to the driving-characteristics server S1 in association with the vehicle ID.

The memory 12B includes, for example, a random access memory (RAM) as a work memory used when each processing of the processor 12A is executed, and a read only memory (ROM) storing a program and data defining an operation of the processor 12A. The RAM temporarily stores data or information generated or acquired by the processor 12A. The program that defines the operation of the processor 12A is written into the ROM. The memory 12B stores the vehicle ID of the vehicle C1.

The display unit 12C is implemented using, for example, a liquid crystal display (LCD) or an organic electroluminescence (EL).

The input unit 12D is a user interface integrated with the display unit 12C. The received operation of the driver is converted into an electric signal (control command) and output to the processor 12A by the input unit 12D. The input unit 12D receives an input operation for starting initial registration by the driver, and receives an input operation of the license ID or the vehicle ID.

The interior camera 13 includes at least a lens (not illustrated) and an image sensor (not illustrated). The image sensor is, for example, a solid-state imaging element such as a charged-coupled device (CCD) or a complementary metal-oxide-semiconductor (CMOS), and converts an optical image formed on an imaging surface into an electric signal.

The interior camera 13 images the face of the driver sitting in the driver seat based on an input operation by the driver through the input unit 12D or the detection of the entry of the driver, and outputs the image to the processor 12A. The processor 12A analyzes the captured face image of the driver and detects the face orientation of the driver. If it is determined that the detected face orientation of the driver is a face orientation set in advance, the processor 12A transmits the face image from the communication device 11 to the driving-characteristics server S1 in association with the vehicle ID. The detection of the face orientation of the driver from the face image may be executed by the driving-characteristics server S1.

For example, if a front face image is necessary in the driver authentication at the time of initial registration or in the identification of the driver at the time of recording the driving-characteristics data, the processor 12A transmits a front face image, in which the detected face orientation of the driver is determined as the front, to the driving-characteristics server S1 in association with the vehicle ID.

For example, if face images in which the driver faces a plurality of different directions are required in the driver authentication of the initial registration or in the identification of the driver at the time of recording the driving-characteristics data, the processor 12A selects one or more face images from among each of the front face images in which the detected face orientation of the driver is determined as the front, and the right face images determined as the right and the left face images determined as the left. The processor 12A transmits the selected two or more face images to the driving-characteristics server S1 in association with the vehicle ID. Accordingly, the vehicle C1 can more effectively prevent the spoofing on the driver using a front face image of the driver captured in advance.

The interior camera 13 may image the driver's license based on an input operation by the driver via the input unit 12D. In such a case, the processor 12A may output the image captured by the interior camera 13 to cause the display unit 12C to display the captured image, and may superimpose a frame line indicating the area capturing the driver's license on the captured image displayed by the display unit 12C. As a result, the car navigation device 10 can assist in capturing a face image of the driver's license used for identifying the driver, or in imaging the driver's license to allow the reading of various information written on the driver's license.

The gyro sensor 14 is a so-called angular velocity sensor, and may be of any type among mechanical, optical, vibratory, and the like. The change in rotation and orientation of the vehicle C1 is detected as the angular speed, converted into an electric signal, and output to the processor 12A by the gyro sensor 14.

The memory 15 includes, for example, a random access memory (RAM) as a work memory used when each processing of the ECU 16 is executed, and a read only memory (ROM) storing a program and data defining an operation of the ECU 16. The RAM temporarily stores data or information generated or acquired by the ECU 16. The program that defines the operation of the ECU 16 is written into the ROM. The memory 15 may store the vehicle ID of the vehicle C1.

The ECU 16 collectively executes the processing and control of each unit. The ECU 16 is implemented with a so-called electronic circuit control device, and implements the function of each unit by referring to a program and data stored in the memory 15 and executing the program. The ECU 16 acquires various operation information on the accelerator pedal 17A, the brake pedal 17B, the turn lamp 17C, the steering 17D, and the like by the driver (for example, rapid acceleration, rapid deceleration, lighting information, steering (torque) information, and the like) as the driving-characteristics data based on an electric signal output from the operation unit 17. The ECU 16 outputs the driving-characteristics data based on the acquired operation information on the operation unit 17 to the processor 12A.

The ECU 16 executes, for example, the closing of the door of the driver seat, the wearing of the seat belt of the driver seat, the release of the side brake after the ignition is turned on, the seating detection of the driver by a load sensor (not illustrated) provided at the driver seat, the torque detection of the steering 17D, or the like as the detection condition of the entry of the driver. The ECU 16 detects the entry of the driver based on whether one or more or two or more detection conditions of the entry of the driver are satisfied. The ECU 16 generates a control command indicating the detection of the entry of the driver, and outputs the control command to the processor 12A of the car navigation device 12 or the communication device 11.

The ECU 16 executes, for example, the opening of the door of the driver seat, the release of the seat belt of the driver seat, the detection of the ignition being turned OFF, the detection of the driver leaving the driver seat by a load sensor (not illustrated) provided at the driver seat, or the like as the detection condition of the exit of the driver. The ECU 16 detects the exit of the driver based on whether at least one or at least two detection conditions of the exit of the driver are satisfied. The ECU 16 generates a control command indicating the detection of the exit of the driver, and outputs the control command to the processor 12A of the car navigation device 12 or the communication device 11.

The speed sensor 18 measures the speed of the vehicle C1 based on a vehicle speed pulse generated based on the rotation speed of the drive shaft inside the vehicle C1. The speed sensor 18 outputs the measured speed of the vehicle C1 to the processor 12A.

The exterior sensor/camera 19 is one or more sensors such as a radar and a sonar provided in the vehicle C1, and one or more cameras capable of imaging the surroundings of the vehicle C1 (outside the vehicle). The camera referred to here may be a drive recorder. The exterior sensor/camera 19 detects the position and the direction of an object present around the vehicle C1 (for example, a wall, an obstacle, another vehicle, a person, or the like), detects a sign, and detects a white line or the like on the road. The exterior sensor/camera 19 outputs the detection information to the processor 12A. The processor 12A transmits the detection information and the driving-characteristics data output from the exterior sensor/camera 19 to the driving-characteristics server S1.

The GPS sensor 20 receives a satellite positioning signal transmitted from an artificial satellite (not illustrated) or a quasi-zenith satellite (not illustrated) capable of providing a satellite positioning service, such as a signal of Global Positioning System (GPS) of the United States, and also Global Navigation Satellite System (GLONASS) of Russia and Galileo of Europe. By an operation based on the received satellite positioning signal, the information on the traveling speed and the traveling position of the vehicle C1 is calculated and output to the processor 12A by the GPS sensor 20. The operation on the information on the traveling speed and traveling position of the vehicle C1 based on the satellite positioning signal or quasi-zenith satellite may be executed by the GPS sensor 20.

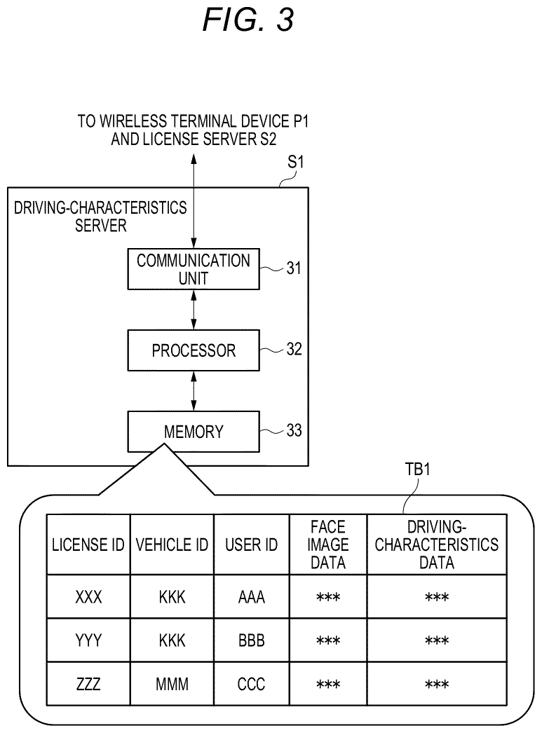

Next, the internal configuration of the driving-characteristics server S1 according to Embodiment 1 will be described with reference to FIG. 3. FIG. 3 is a block diagram illustrating an example of the internal configuration of the driving-characteristics server S1 according to Embodiment 1. In the following description, for ease of understanding, various data or information collected (recorded) and managed by the driving-characteristics server S1 using a driving-characteristics table TB1 will be described as an example, but the driving-characteristics table TB1 is not essential and may be omitted.

The driving-characteristics server S1 includes a communication unit 31, a processor 32, and a memory 33.

The communication unit 31 is connected to each of the vehicles C1, . . . , the wireless terminal device P1, and the license server S2 via the network NW to transmit and receive data.

The processor 32 is implemented with, for example, a CPU, a DSP, or an FPGA, and controls the operation of each unit. The processor 32 performs the overall processing and control in cooperation with the memory 33. Specifically, the processor 32 implements functions of each unit by referring to a program and data stored in the memory 33 and executing the program. The driving-characteristics table TB1 is generated and stored in the memory 33 by the processor 32.

The driving-characteristics table TB1 records and manages the vehicle ID, the driving-characteristics data, and the biological information (the face image of the driver in the example illustrated in FIG. 3) in association with the license ID. As an example, the driving-characteristics table TB1 illustrated in FIG. 3 is assigned to each driver, and further records a user ID for identifying the driver in association with the license ID. The biological information recorded in the driving-characteristics table TB1 is the biological information registered (stored) at the time of initial registration.

For example, the driving-characteristics table TB1 illustrated in FIG. 3 records the vehicle ID “KKK”, the user ID “AAA”, the data on the face image, and the driving-characteristics data in association with the license ID “XXX”, records the vehicle ID “KKK”, the user ID “BBB”, the data on the face image, and the driving-characteristics data in association with the license ID “YYY”, and the vehicle ID “MMM”, the user ID “CCC”, the data on the face image, and the driving-characteristics data in association with the license ID “ZZZ”. Accordingly, since the driving-characteristics data can be recorded for each license ID, the driving-characteristics table TB1 can manage the driving-characteristics data for each driver even if a vehicle having the same vehicle ID “KKK” is driven by a plurality of different drivers (for example, two users “AAA” and “BBB”).

The processor 32 starts the initial registration based on the control command for requesting the initial registration transmitted from each of the vehicles C1, . . . . The processor 32 registers (stores) the license ID transmitted from each of the vehicles C1, . . . in association with the biological information on the driver in the driving-characteristics table TB1 and the vehicle ID. If it is determined that the acquired license ID is registered in the driving-characteristics table TB1, the processor 32 compares the biological information on the driver associated with the registered license ID with the acquired biological information. If it is determined that the biological information on the driver associated with the registered license ID does not match the acquired biological information, the processor 32 further records the registered license ID in the driving-characteristics table TB1 in association with the acquired vehicle ID.

When acquiring the vehicle ID and the driving-characteristics data transmitted from each of the vehicles C1, . . . , the processor 32 temporarily stores the acquired driving-characteristics data for each vehicle ID in the memory 33. When acquiring the vehicle ID transmitted from each of the vehicles C1, . . . and the biological information on the driver, the processor 32 compares the acquired biological information on the driver with the biological information registered (stored) in the driving-characteristics table TB1, and determines whether the driver corresponding to the acquired biological information is registered.

If it is determined that the driver corresponding to the acquired biological information is registered (that is, the acquired biological information on the driver matches the biological information registered (stored) in the driving-characteristics table TB1), the processor 32 identifies the license ID associated with the biological information. The processor 32 records the acquired vehicle ID and the driving-characteristics data in the driving-characteristics table TB1 in association with the identified license ID. Accordingly, the processor 32 can record and manage the driving-characteristics data for each license ID (that is, driver).

The processor 32 acquires the control command for requesting the driving evaluation for the predetermined driver transmitted from the wireless terminal device P1 and the license ID or biological information corresponding to the predetermined driver. The processor 32 compares the acquired license ID or biological information with the license IDs or biological information on the plurality of drivers registered in the driving-characteristics table TB1. The processor 32 executes the driving evaluation of the driver using the driving-characteristics data on the driver corresponding to the license ID or the biological information included in the control command based on the comparison result. The processor 32 generates a driving evaluation result and transmits the driving evaluation result to the wireless terminal device P1.

Similarly, the processor 32 acquires the control command for requesting the driving evaluation for the predetermined driver transmitted from the license server S2 and the license ID or biological information corresponding to the predetermined driver. The processor 32 compares the acquired license ID or biological information with the license IDs or biological information on the plurality of drivers registered in the memory 33. The processor 32 executes the driving evaluation of the driver using the driving-characteristics data on the driver corresponding to the license ID or the biological information included in the control command based on the comparison result. The processor 32 generates a driving evaluation result and transmits the driving evaluation result to the license server S2.

The memory 33 includes, for example, a RAM as a work memory used when each process of the processor 32 is executed, and a ROM that stores a program and data that define an operation of the processor 32. The memory 33 may include a storage device including any storage device such as an SSD or an HDD. The RAM temporarily stores data or information generated or acquired by the processor 32. The program that defines the operation of the processor 32 is written into the ROM. The memory 33 stores the driving-characteristics table TB1 generated by the processor 32.

The memory 33 may accumulate the driving-characteristics data on driving for a predetermined period or a predetermined number of times for each driver. The predetermined period referred to here is, for example, the latest 6 months or the latest 50 times. In addition, driving for one time is driving performed during a period from the timing of detecting the entry of the driver to the timing of detecting the exit of the driver by the vehicles C1, . . . .

In such a case, if it is determined that driving-characteristics data accumulated for the predetermined period or more exists among the plurality of pieces of driving-characteristics data accumulated in association with the same license ID, the processor 32 deletes the driving-characteristics data accumulated for the predetermined period or more. Alternatively, if it is determined that driving-characteristics data on driving for the latest predetermined number of times or more exists among driving-characteristics data accumulated in association with the same license ID, the processor 32 deletes the driving-characteristics data on driving for the latest predetermined number of times or more. Accordingly, the driving-characteristics server S1 can preferentially accumulate driving-characteristics data that allows the evaluation of the latest change in driving skill of the driver.

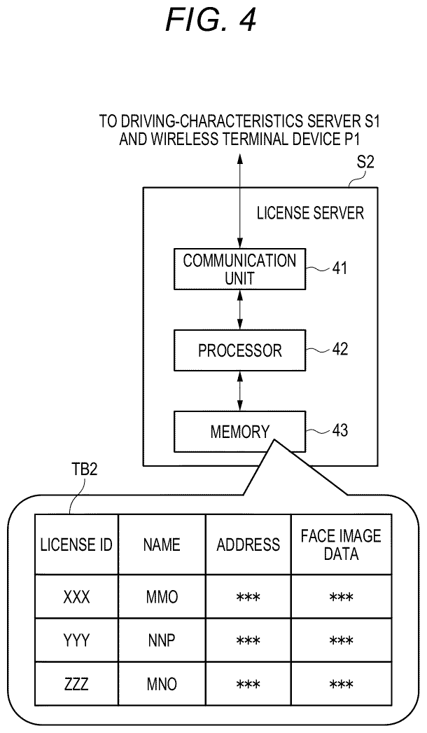

Next, the internal configuration of the license server S2 according to Embodiment 1 will be described with reference to FIG. 4. FIG. 4 is a block diagram illustrating an example of the internal configuration of the license server S2 according to Embodiment 1. In the following description, for ease of understanding, various data or information collected (recorded) and managed by the license server S2 using a license table TB2 will be described as an example, but the license table TB2 is not essential and may be omitted.

The license server S2 includes a communication unit 41, a processor 42, and a memory 43.

The communication unit 41 is connected to the driving-characteristics server S1 and the wireless terminal device P1 via the network NW to transmit and receive data. If the wireless terminal device P1 is implemented with the car navigation device 12, the communication unit 41 may be connected to the car navigation device 12 mounted on each of the vehicles C1, . . . via the network NW to transmit and receive data.

The processor 42 is implemented with, for example, a CPU, a DSP, or an FPGA, and controls the operation of each unit. The processor 42 performs the overall processing and control in cooperation with the memory 43. Specifically, the processor 42 implements functions of each unit by referring to a program and data stored in the memory 43 and executing the program.

The processor 42 acquires, for example, the license ID of each of the plurality of drivers transmitted from each of the wireless terminal devices P1 owned by the driver, police officer, insurance clerk, or the like, and the information related to the driver (for example, the name, the address, and the face image data as an example of the biological information on the driver). The processor 42 generates the license table TB2 with the information related to the driver corresponding to the license ID in association with the acquired license ID. The processor 42 stores the generated license table TB2 in the memory 43.

The license table TB2 records and manages information related to the driver (the name and address of the driver in FIG. 4) and the biological information on the driver (the face image of the driver in the example illustrated in FIG. 4) in association with the license ID. The information associated with the license ID in the license table TB2 is not limited to the example illustrated in FIG. 4, and, for example, information such as the expiration date and update date of the driver's license may be further associated.

For example, the license table TB2 illustrated in FIG. 4 records the name of the driver “MMO”, the address “***”, and the data on the face image in association with the license ID “AAA”, the name of the driver “NNP”, the address “***”, and the data on the face image in association with the license ID “BBB”, and the name of the driver “MNO”, the address “***”, and the data on the face image in association with the license ID “CCC”.

The processor 42 acquires the control command for requesting the driving evaluation of the predetermined driver transmitted from the wireless terminal device P1 and the license ID corresponding to the predetermined driver. The processor 42 generates a control command for requesting the driving evaluation for the predetermined driver, and transmits the generated control command to the driving-characteristics server S1 in association with the acquired license ID. When acquiring the driving evaluation result of the predetermined driver transmitted from the driving-characteristics server S1 via the communication unit 41, the processor 42 transmits the acquired driving evaluation result to the wireless terminal device P1.

The memory 43 includes, for example, a RAM as a work memory used when each process of the processor 42 is executed, and a ROM that stores a program and data that define an operation of the processor 42. The memory 43 may include a storage device including any storage device such as an SSD or an HDD. The RAM temporarily stores data or information generated or acquired by the processor 42. The program that defines the operation of the processor 42 is written into the ROM. The memory 43 stores the license table TB2 generated by the processor 42.

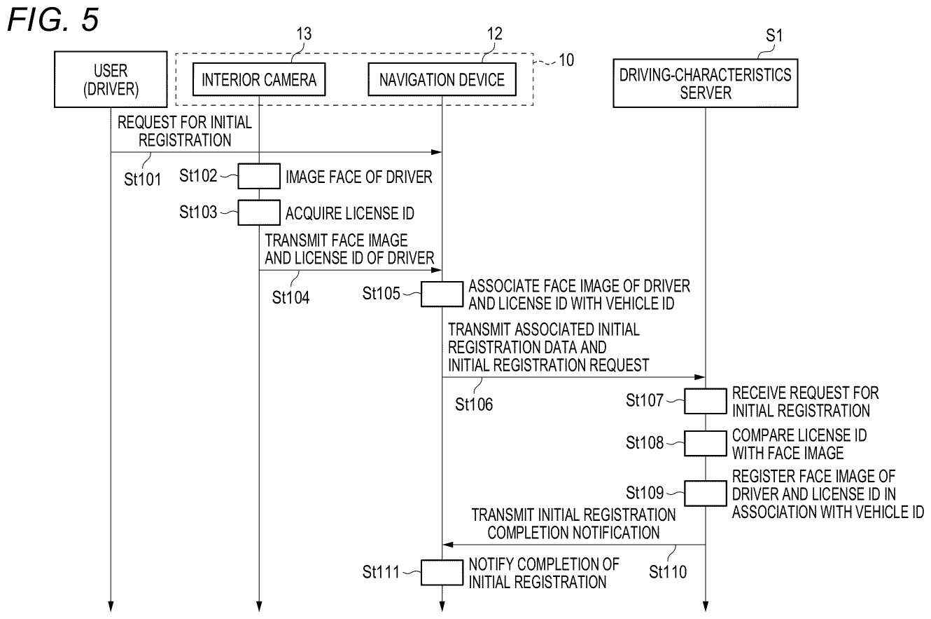

Next, an initial registration procedure of the driver executed by the driving-characteristics management system 100 will be described with reference to FIG. 5. FIG. 5 is a sequence diagram illustrating an example of a driver initial registration procedure of the driving-characteristics management system 100 according to Embodiment 1. In the following description, the biological information on the driver is exemplified by a front face image, a left face image, and a right face image of the driver, but are not limited thereto as a matter of course.

The driver as an example of the user who uses the driving-characteristics management system 100 operates the car navigation device 12 and selects (presses) an initial registration button (not illustrated) displayed by the display unit 12C to perform an operation for requesting initial registration via the input unit 12D (St101).

The car navigation device 12 causes the interior camera 13 to capture a face image of the driver (an example of the biological information) based on the operation of the driver received by the input unit 12D. The interior camera 13 is controlled by the car navigation device 12 to image the face of the driver (St102). In addition, the interior camera 13 images the driver's license (an example of the license ID) held by the driver within the angle of view of the interior camera 13 (St103). The interior camera 13 transmits the captured face image of the driver and the license ID to the car navigation device 12 in association (St104).

The car navigation device 12 associates the face image of the driver and the license ID with the vehicle ID of the host vehicle (St105). The associated vehicle ID may be the number plate information on the vehicle, information for identifying the host vehicle, or the like, which is input to the input unit 12D by the driver or stored in the car navigation device 12. The car navigation device 12 transmits the associated face image of the driver, license ID and vehicle ID of the host vehicle (initial registration data), and a control command for requesting the initial registration (initial registration request) to the driving-characteristics server S1 via the communication device 11 (St106).

The driving-characteristics server S1 receives the initial registration data transmitted from the car navigation device 12 and the control command for requesting the initial registration (St107).

The driving-characteristics server S1 compares the front face image of the driver appearing in the acquired license ID with the registered face image based on the control command for requesting the initial registration (St108). If it is determined that the front face image of the driver appearing in the license ID matches the registered face image (that is, the same driver), the driving-characteristics server S1 registers (stores) the face image of the driver and the license ID in the memory 33 in association with the vehicle ID, and completes the initial registration of the driver (St109). After the initial registration is completed, the driving-characteristics server S1 generates an initial registration completion notification indicating the completion of the initial registration, and transmits the initial registration completion notification to the communication device 11 via the network NW (St110).

The car navigation device 12 outputs the initial registration completion notification transmitted from the driving-characteristics server S1 to the display unit 12C via the communication device 11 to notify the driver of the completion of the initial registration (St111).

The driving-characteristics server S1 may compare the license IDs of the plurality of registered drivers with the acquired license ID or face image, and may execute the process of step St108 to execute the initial registration only if it is determined that the license IDs of the plurality of registered drivers do not match the acquired license ID or face image (that is, the same driver is not registered) as the result of the comparison. If it is determined that the license IDs of the plurality of registered drivers match the acquired license ID or face image (that is, the same driver is registered), the driving-characteristics server S1 may complete the initial registration by recording the acquired vehicle ID in association with the registered license ID.

As described above, the driving-characteristics management system 100 according to Embodiment 1 can manage the license ID of the driver in association with the vehicle ID.

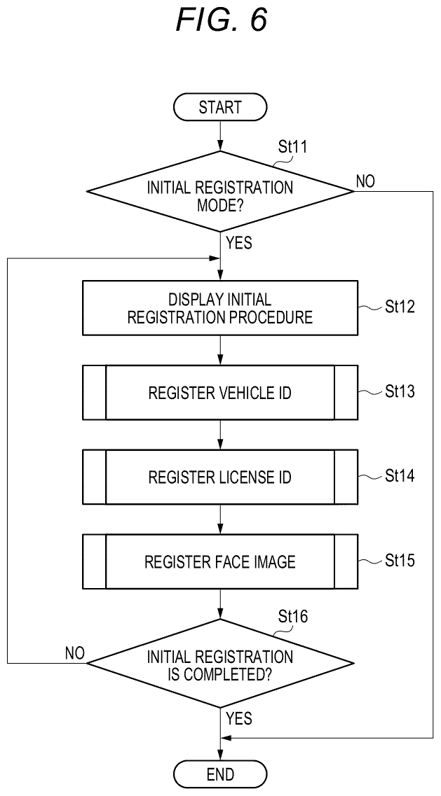

Next, an initial registration procedure of the driver executed in each of the vehicles C1, . . . will be described with reference to FIG. 6. FIG. 6 is a flowchart illustrating an example of the driver initial registration procedure in the vehicles C1, . . . .

Each of the vehicles C1, . . . determines whether there is an operation for requesting initial registration of the driver on the input unit 12D of the car navigation device 12 (St11).

If it is determined in the process of step St11 that there is an operation for requesting initial registration of the driver (St11, YES), each of the vehicles C1, . . . generates a screen indicating the initial registration procedure, and outputs and causes the display unit 12C of the car navigation device 12 to display screen (St12). The screen illustrating the initial registration procedure referred to here is one or more screens illustrating a procedure for acquiring: the vehicle ID driven by the driver as an example of the initial registration data; the license ID of the driver; and the biological information on the driver.

On the other hand, if it is determined in the process of step St11 that there is no operation for requesting the initial registration of the driver (St11, NO), each of the vehicles C1, . . . ends the initial registration procedure illustrated in FIG. 6.

Each of the vehicles C1, . . . registers the vehicle ID (St13), registers the license ID (St14), and registers the face image (St15). Each of the vehicles C1, . . . determines whether all the processes of step St13 to step St15 (that is, the initial registration) are completed (St16).

If it is determined in the process of step St16 that all of the processes of step St13 to step St15 (that is, the initial registration) are completed (St16, YES), each of the vehicles C1, . . . ends the initial registration procedure illustrated in FIG. 6.

On the other hand, if it is determined in the process of step St16 that not all the processes of step St13 to step St15 (that is, the initial registration) are completed (St16, NO), each of the vehicles C1, . . . proceeds to the process of step St12, displays the initial registration procedure corresponding to the processes of step St13 to step St15 that are not completed, and executes only the processes corresponding to step St13 to step St15 that are not completed again. For example, if the process of step St13 is not completed, each of the vehicles C1, . . . displays the initial registration procedure corresponding to the process of step St13 (the registration process of the vehicle ID), and executes the process of step St13 (the registration process of the vehicle ID) again.

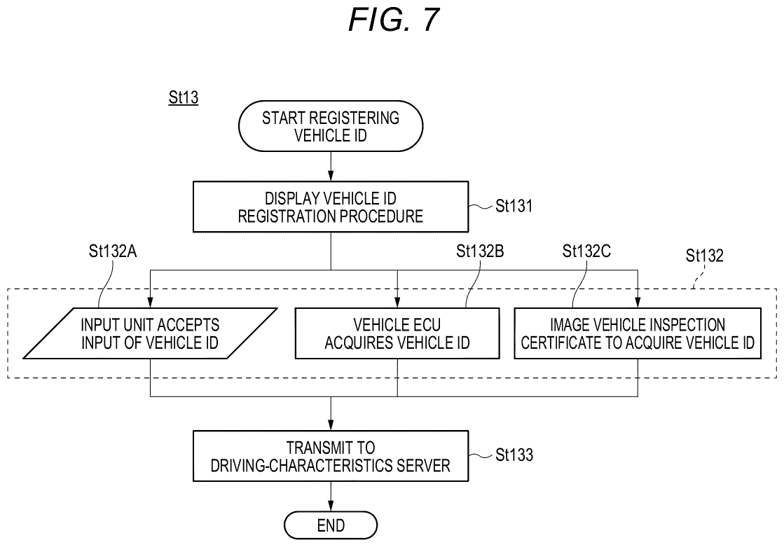

Next, the initial registration procedure of the driver executed in each of the vehicles C1, . . . will be described with reference to FIG. 7. FIG. 7 is a flowchart illustrating an example of a vehicle ID registration procedure in the vehicles C1, . . . . Specifically, FIG. 7 is a flowchart illustrating the process of step St13 illustrated in FIG. 6.

The car navigation device 12 outputs to the display unit 12C an image, video, voice, or the like corresponding to the registration procedure of the vehicle ID recorded in the memory 12B (St131).

Each of the vehicles C1, . . . acquires the vehicle ID of the host vehicle by any of the following processes of Step St132A, Step St132B, and Step St132C (St132).

The car navigation device 12 receives input of the vehicle ID (for example, the number plate information on the vehicle) to the input unit 12D through an operation of the driver (St132A).

The ECU 16 acquires the vehicle ID of the host vehicle recorded in the memory 15 (St132B).

The interior camera 13 images the vehicle inspection certificate of the host vehicle held by the driver within the angle of view, and outputs the captured image of the vehicle inspection certificate to the processor 12A of the car navigation device 12. The car navigation device 12 performs image analysis on the output captured image of the vehicle inspection certificate, and acquires the vehicle ID appearing in the captured image (St132C).

The acquired vehicle ID is output to the communication device 11. The communication device 11 transmits the output vehicle ID to the driving-characteristics server S1 via the network NW (St133).

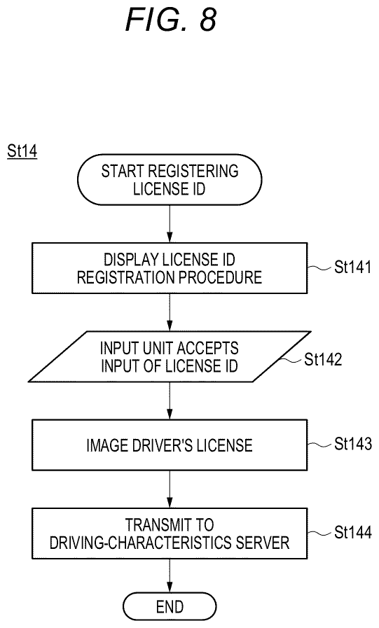

Next, an initial registration procedure of the driver executed in each of the vehicles C1, . . . will be described with reference to FIG. 8. FIG. 8 is a flowchart illustrating an example of the driver license ID registration procedure in the vehicles C1, . . . . Specifically, FIG. 8 is a flowchart illustrating the process of step St14 illustrated in FIG. 6.

The car navigation device 12 outputs to the display unit 12C an image, video, voice, or the like corresponding to the registration procedure of the license ID recorded in the memory 12B (St141).

The car navigation device 12 receives input of the license ID (for example, the number plate information on the vehicle) to the input unit 12D through an operation of the driver (St142). It should be noted that the process of step St142 is not essential and may be omitted. In such a case, the processor 12A of the car navigation device 12 or the driving-characteristics server S1 acquires the license ID by analyzing the image of the driver's license captured in the process of step St143.

The interior camera 13 images the driver's license held by the driver within the angle of view (St143). The interior camera 13 outputs the captured image of the driver's license to the processor 12A of the car navigation device 12. The car navigation device 12 outputs the output captured image of the driver's license to the communication device 11 in association with the input license ID. The communication device 11 transmits the captured image of the driver's license output from the car navigation device 12 and the license ID to the driving-characteristics server S1 (St144). If the process of step St142 is omitted, the communication device 11 transmits the captured image of the driver's license output from the car navigation device 12 to the driving-characteristics server S1.

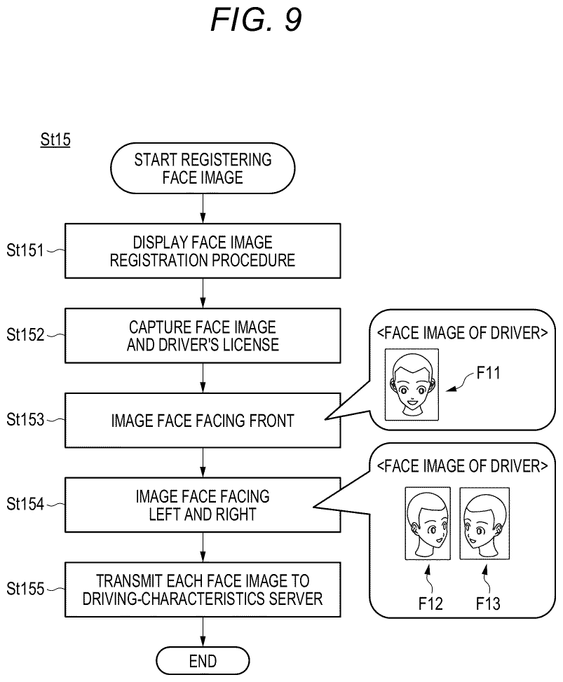

Next, an initial registration procedure of the driver executed in each of the vehicles C1, . . . will be described with reference to FIG. 9. FIG. 9 is a flowchart illustrating an example of the driver face image registration procedure in the vehicles C1, . . . . Specifically, FIG. 9 is a flowchart illustrating the process of step St15 illustrated in FIG. 6.

The car navigation device 12 outputs to the display unit 12C an image, video, voice, or the like corresponding to the registration procedure of the face image recorded in the memory 12B (St151). The car navigation device 12 controls the interior camera 13 to start imaging.

The interior camera 13 images the driver's license presented by the driver within the angle of view of the interior camera 13. Here, the interior camera 13 captures the face image of the driver written on the driver's license and various information written on the driver's license (for example, name information, address information, nationality information, valid year and month information, number information, type information, and the like of the driver) in the entire area of the driver's license to appear within the angle of view (St152). The interior camera 13 outputs the captured image of the driver's license to the processor 12A.

If the driver inputs the license ID in step St142, the face image of the driver appearing in the driver's license may be captured alone. Alternatively, if the face image of the driver and various information described in the driver's license are captured in the process of step St143, the process of step St152 may be omitted. The determination as to whether the face image of the driver and the various information described on the driver's license are appearing in the captured image of the driver's license may be executed by the driving-characteristics server S1 or may be executed by the processor 12A of the car navigation device 12.

The interior camera 13 captures an image in a state where the face of the driver faces the front (St153), and outputs a captured front face image F11 to the processor 12A. The interior camera 13 captures an image in a state where the face of the driver faces rightward with respect to the interior camera 13 positioned in front of the driver (St154), and outputs a captured right face image F12 to the processor 12A. The interior camera 13 captures an image in a state where the face of the driver faces leftward with respect to the interior camera 13 positioned in front of the driver (St154), and outputs a captured left face image F13 to the processor 12A.

The car navigation device 12 outputs to the communication device 11 and transmits to the driving-characteristics server S1 each of the captured image of the driver's license, the front face image F11, the right face image F12, and the left face image F13 output from the interior camera 13 (St155).

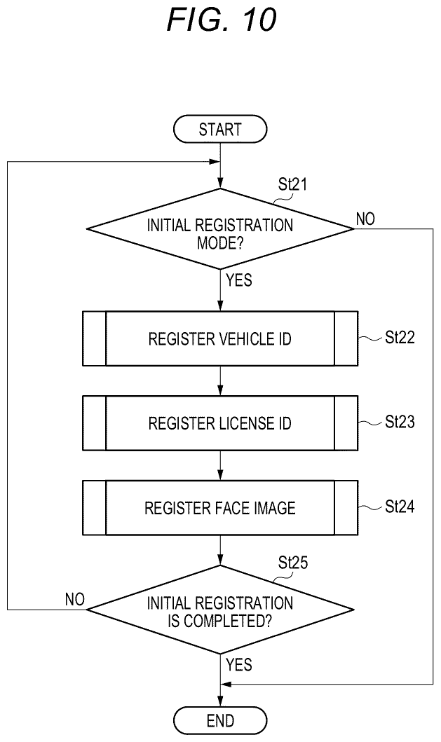

Next, the initial registration procedure of the driver executed by the driving-characteristics server S1 will be described with reference to FIG. 10. [FIG. 10 is a flowchart illustrating an example of the driver initial registration procedure in the driving-characteristics server S1.

The driving-characteristics server S1 in the driving-characteristics management system 100 determines whether a control command for requesting the initial registration is acquired from each of the vehicles C1, . . . (St21).

If it is determined in the process of step St21 that a control command for requesting the initial registration is acquired from each of the vehicles C1, . . . (St21, YES), the driving-characteristics server S1 executes the registration process of the initial registration data associated with the control command. The initial registration data referred to here is, for example, data including the vehicle ID of the vehicle, the license ID of the driver, and the biological information on the driver (here, a plurality of face images of the driver, and three face images captured from three different directions, respectively), but is not limited thereto as a matter of course.

On the other hand, if it is determined in the process of step St21 that no control commands for requesting the initial registration are acquired from each of the vehicles C1, . . . (St21, NO), the driving-characteristics server S1 ends the initial registration procedure illustrated in FIG. 10.

The driving-characteristics server S1 registers the vehicle ID (St22), registers the license ID (St23), and registers the face image (St24). The driving-characteristics server S1 determines whether all the processes of step St22 to step St24 (that is, initial registration) are completed (St25).

If it is determined in the process of step St25 that all of the processes of step St22 to step St24 (that is, the initial registration) are completed (St25, YES), the driving-characteristics server S1 ends the initial registration procedure illustrated in FIG. 10.

On the other hand, if it is determined in the process of step St25 that not all the processes of step St22 to step St24 (that is, the initial registration) are completed (St25, NO), the driving-characteristics server S1 proceeds to the process of step St21, displays the initial registration procedure corresponding to the processes of step St22 to step St24 that are not completed, and executes only the processes corresponding to step St22 to step St24 that are not completed again. For example, if the process of step St22 is not completed, each of the vehicles C1, . . . displays the initial registration procedure corresponding to the process of step St22, and executes the registration process of the vehicle ID, which is the process of step St22, again.

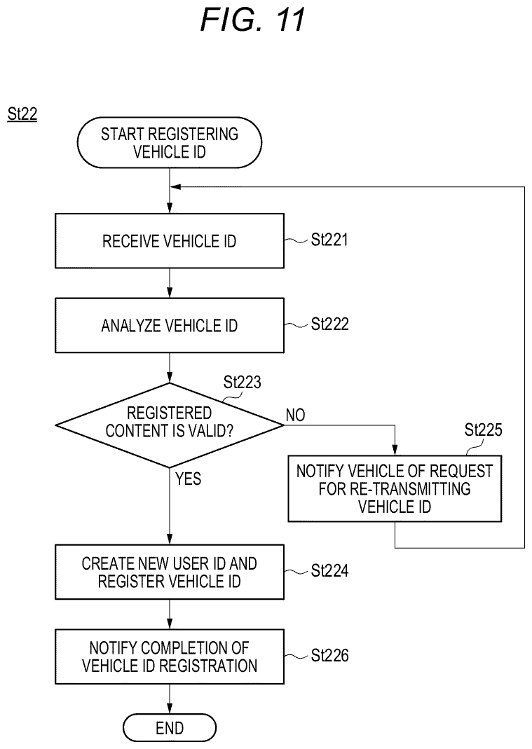

Next, the initial registration procedure of the driver executed by the driving-characteristics server S1 will be described with reference to FIG. 11. FIG. 11 is a flowchart illustrating an example of the vehicle ID registration procedure in the driving-characteristics server S1. Specifically, FIG. 11 is a flowchart illustrating the process of step St22 illustrated in FIG. 10.

The driving-characteristics server S1 receives and acquires the vehicle ID transmitted from each of the vehicles C1, . . . (St221).

The driving-characteristics server S1 analyzes the acquired vehicle ID (St222) and determines whether the analyzed vehicle ID is valid as the initially registered vehicle ID (St223). For example, if the acquired vehicle ID is a captured image, the driving-characteristics server S1 executes image analysis, analyzes whether the vehicle ID is based on the vehicle inspection certificate or the license plate. If the acquired vehicle ID is character information input by the operation of the driver, the driving-characteristics server S1 analyzes whether the character information is the information included in the vehicle inspection certificate or the license plate. If it is determined that the analysis result is information available as the vehicle ID, the driving-characteristics server S1 determines that the vehicle ID is valid.

If it is determined in the process of step St223 that the analyzed vehicle ID is valid as the initially registered vehicle ID (St223, YES), the driving-characteristics server S1 generates a new user ID, and registers or temporarily stores the generated user ID in association with the vehicle ID (St224). In the process of step St224, the generation of the user ID is not essential and may be omitted.

On the other hand, if it is determined in the process of step St223 that the analyzed vehicle ID is not valid as the initially registered vehicle ID (St223, NO), the driving-characteristics server S1 generates a control command for requesting retransmission of the vehicle ID and transmits (notifies) the control command to the vehicle via the network NW (St225).

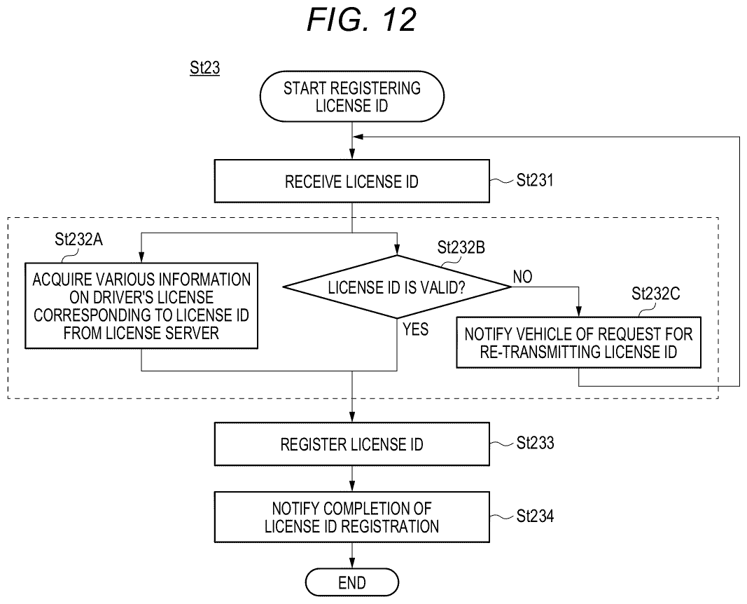

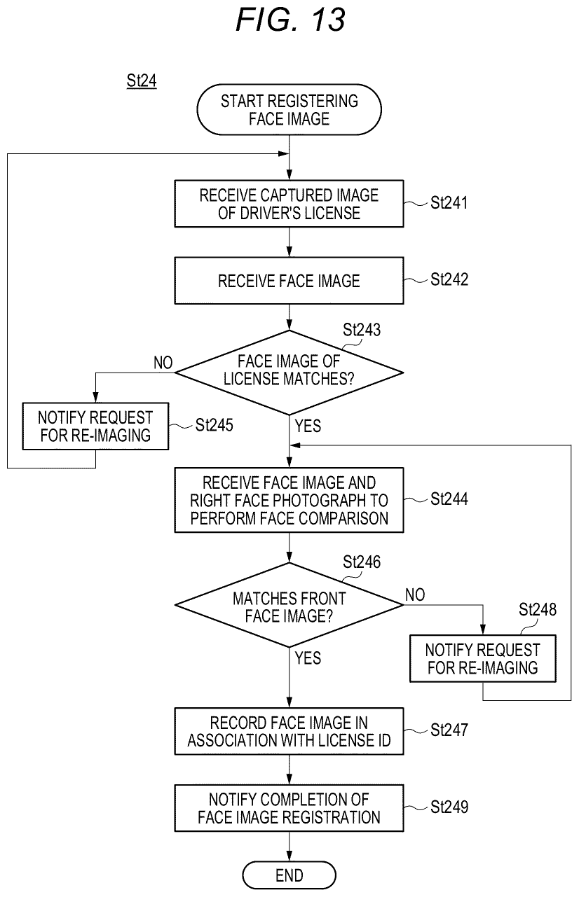

After registering the vehicle ID, the driving-characteristics server S1 generates a control command for notifying the completion of the registration of the vehicle ID, and transmits the control command to the vehicle via the network NW (St226). The process in step St226 may be executed simultaneously with the process in step St234 (see FIG. 12) and the process in step St249 (see FIG. 13).

Next, the initial registration procedure of the driver executed by the driving-characteristics server S1 will be described with reference to FIG. 12. FIG. 12 is a flowchart illustrating an example of the license ID registration procedure in the driving-characteristics server S1. Specifically, FIG. 12 is a flowchart illustrating the process of step St23 illustrated in FIG. 10.

The driving-characteristics server S1 receives and acquires the driver's license ID transmitted from each of the vehicles C1, . . . (St231).

The driving-characteristics server S1 generates a control command for requesting various information on the driver's license corresponding to the acquired license ID (for example, a face image, name information, address information, nationality information, expiration date information, number information, and type information on the driver written on the driver's license), and transmits the control command to the license server S2. The driving-characteristics server S1 acquires various information on the driver's license corresponding to the license ID transmitted from the license server S2 (St232A). The process of step St232A may be executed if the face image described in the driver's license cannot be acquired from each of the vehicles C1, . . . , or if the acquired face image does not match the face images of the drivers registered in the driving-characteristics table TB1.

The driving-characteristics server S1 determines whether the acquired license ID is valid (St232B). Specifically, if the acquired license ID is a captured image of the driver's license, the driving-characteristics server S1 determines whether various information can be read from the captured image, or whether the driver's license is within the expiration date by character recognition, and determines whether the driver can be identified by comparing the face image of the driver included in the acquired license ID with the face images of the drivers registered in the driving-characteristics table TB1.

After the process of step St232A or if it is determined in the process of step St232B that the acquired license ID is valid (St232B, YES), the driving-characteristics server S1 registers the acquired license ID (St233). If it is determined that the license ID is registered in the driving-characteristics table TB1, the driving-characteristics server S1 may omit the registration process of the license ID in step St233.

On the other hand, if it is determined in the process of step St232B that the acquired license ID is not valid (St232B, NO), the driving-characteristics server S1 generates a control command for requesting retransmission of the license ID, and transmits (notifies) the control command to the vehicle via the network NW (St232C). In the process of step St232A, the driving-characteristics server S1 may similarly execute the process of step St232C if various information on the driver's license cannot be acquired from the license server S2.

After registering the license ID, the driving-characteristics server S1 generates a control command for notifying the completion of the registration of the license ID, and transmits (notifies) the control command to the vehicle via the network NW (St234). The process in step St234 may be executed simultaneously with the process in step St226 (see FIG. 11) and the process in step St249 (see FIG. 13).

Next, the initial registration procedure of the driver executed by the driving-characteristics server S1 will be described with reference to FIG. 13. FIG. 13 is a flowchart illustrating an example of the driver face image registration procedure in the driving-characteristics server S1. Specifically, FIG. 13 is a flowchart illustrating the process of step St24 illustrated in FIG. 10.

The driving-characteristics server S1 receives and acquires the captured image of the driver's license transmitted from each of the vehicles C1, . . . (St241). The driving-characteristics server S1 receives and acquires each of the front face image, the left face image, and the right face image (an example of the biological information) transmitted from each of the vehicles C1, . . . (St242).

The driving-characteristics server S1 executes face comparison between the face image of the driver appearing in the acquired captured image of the driver's license and the front face image, and determines whether the face image of the driver appearing in the captured image of the driver's license and the acquired front face image are the same or similar (that is, whether the same person) (St243).

If it is determined in the process of step St243 that the face image of the driver appearing in the captured image of the driver's license and the acquired front face image are the same or similar (that is, the same person) (St243, YES), the driving-characteristics server S1 executes face comparison using the front face image and each of the left face image and the right face image (St244).

On the other hand, if it is determined in the process of step St243 that the face image of the driver appearing in the captured image of the driver's license is the same as or similar to the front face image (that is, not the same person) (St243, NO), the driving-characteristics server S1 generates a control command for requesting to image the driver's license or the front face image again (that is, re-imaging), and transmits (notifies) the control command to the vehicle via the network NW (St245).

The driving-characteristics server S1 determines whether the face appearing in the front face image and the faces appearing in the left face image and the right face image are the same or similar (that is, the same person) (St246).

If it is determined in the process of Step St246 that the face appearing in the front face image is the same as or similar to the face appearing in each of the left face image and the right face image (that is, the same person) (St246, YES), the driving-characteristics server S1 records the captured image of the driver's license and each of the front face image, the left face image, and the right face image in association with the license ID determined as valid in the process of Step St232B (St247).

On the other hand, if it is determined in the process of step St246 that the face appearing in the front face image and the face appearing in each of the left face image and the right face image are not the same or similar (that is, not the same person) (St246, NO), the driving-characteristics server S1 generates a control command for requesting to image the driver's license, the front face image, the left face image, and the right face image again (that is, re-imaging), and transmits (notifies) the control command to the vehicle via the network NW (St248).

After registering each of the plurality of face images as an example of the biological information in association with the license ID, the driving-characteristics server S1 generates a control command for notifying the completion of the registration of the face images, and transmits (notifies) the control command to the vehicle via the network NW (St249). The process in step St249 may be executed simultaneously with the process in step St226 (see FIG. 11) and the process in step St234 (see FIG. 12).

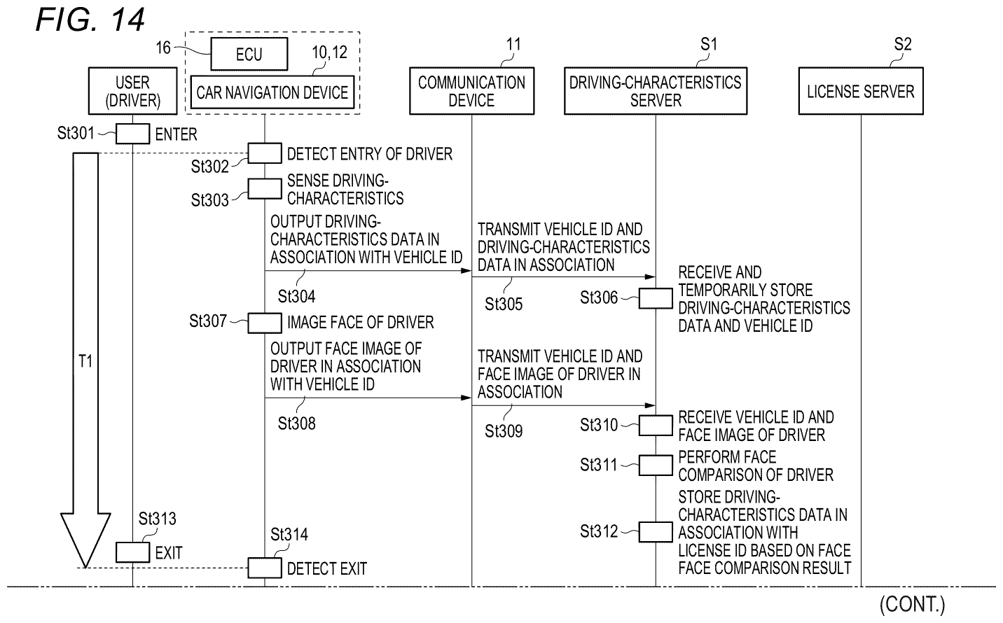

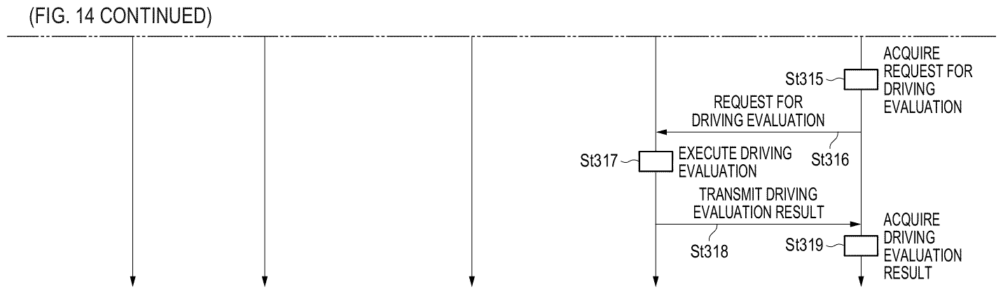

Next, a driver driving-characteristics data collection procedure executed by the driving-characteristics management system 100 will be described with reference to FIG. 14. FIG. 14 is a sequence diagram illustrating an example of the driver driving-characteristics data collection procedure of the driving-characteristics management system 100 according to Embodiment 1. In the following description, the biological information on the driver is exemplified by a front face image, a left face image, and a right face image of the driver, but are not limited thereto as a matter of course.

The driving-characteristics data collection procedure described with reference to each of FIGS. 14 to 16 is a process executed after the completion of the initial registration or when the driver drives the vehicle C1 initially registered in advance. The driving-characteristics data collection procedure is the same for the other vehicles.

The driver enters the vehicle C1 (St301). The ECU 16 of the vehicle C1 detects the entry of the driver based on whether one or more or two or more detection conditions of the entry of the driver are satisfied (St302). The ECU 16 generates a control command indicating the detection of the entry of the driver, outputs the control command to the processor 12A of the car navigation device 12, and starts sensing (acquiring) the driving-characteristics data on the driver. The car navigation device 12 starts sensing (acquiring) the driving-characteristics data on the driver based on the control command output from the ECU 16.

The driving-characteristics data is acquired by the various sensors (for example, the interior camera 13, the gyro sensor 14, the accelerator pedal 17A, the brake pedal 17B, the turn lamp 17C, the steering wheel 17D, the speed sensor 18, the exterior sensor/camera 19, and the GPS sensor 20 (see FIG. 2)), and is output to the car navigation device 12 or the ECU 16.

The ECU 16 outputs the acquired driving-characteristics data on the driver to the car navigation device 12. The car navigation device 12 outputs the acquired one or more pieces of driving-characteristics data to the communication device 11 in association with the vehicle IDs (St304). The communication device 11 transmits the associated one or more pieces of driving-characteristics data and vehicle IDs to the driving-characteristics server S1 via the network NW (St305).

The driving-characteristics server S1 receives and temporarily stores the driving-characteristics data and the vehicle IDs transmitted from the communication device 11 (St306).

The vehicle C1 images the face of the driver with the interior camera 13 (St307). The interior camera 13 outputs the captured face image to the car navigation device 12. The car navigation device 12 outputs one or more face images captured by the interior camera 13 to the communication device 11 in association with the vehicle ID (St308). The communication device 11 transmits the associated one or more face images of the driver and the vehicle ID to the driving-characteristics server S1 via the network NW (St309).

The face image captured in the process of step St307 is preferably a plurality of face images obtained by imaging the face of the driver facing two or more different directions (for example, any two or more face images among the front face image, the left face image, and the right face image of the driver), but is only required to be at least one front face image. The determination of the face orientation of the driver appearing in the face image may be executed by the driving-characteristics server S1.

The driving-characteristics server S1 receives and acquires the vehicle ID and the face image of the driver transmitted from the communication device 11 (St310). The driving-characteristics server S1 executes face comparison of the acquired face image of the driver, and determines whether any face image is the same as or similar to the acquired face image of the driver among the face images of the plurality of drivers registered in the driving-characteristics table TB1 (for example, the face image appearing in the captured image of the driver's license) (St311).

The driving-characteristics server S1 identifies the driver corresponding to the face image the same as or similar to the acquired face image of the driver among the face images of the plurality of driver registered in the driving-characteristics table TB1 as the driver corresponding to the acquired face image. The driving-characteristics server S1 extracts the driving-characteristics data associated with the same vehicle ID as the vehicle ID associated with the face image of the driver from among the temporarily stored driving-characteristics data. The driving-characteristics server S1 records (saves) the extracted driving-characteristics data in association with the license ID of the identified driver (St312).

The driver exits the vehicle after the end of driving (St313). The ECU 16 of the vehicle C1 detects the exit of the driver based on whether one or more or two or more detection conditions of the exit of the driver are satisfied (St314). The ECU 16 generates a control command indicating the detection of the exit of the driver, outputs the control command to the processor 12A of the car navigation device 12, and ends sensing (acquiring) the driving-characteristics data on the driver. The car navigation device 12 ends sensing (acquiring) the driving-characteristics data on the driver based on the control command output from the ECU 16.

The communication device 11 continues transmitting the driving-characteristics data acquired by the car navigation device 12 or the ECU 16 to the driving-characteristics server S1 over a period T1 from step St302 to step St314. The driving-characteristics server S1 continues recording the driving-characteristics data acquired from the communication device 11 in the driving-characteristics table TB1 in association with the license ID of the driver during the period T1.

When acquiring the control command for requesting the driving evaluation of the predetermined driver transmitted from the wireless terminal device P1 (St315), the license server S2 transmits a control command for requesting the driving evaluation of the predetermined driver to the driving-characteristics server S1 in association with the license ID

### (St316).

The driving-characteristics server S1 acquires the control command and the license ID transmitted from the license server S2. The driving-characteristics server S1 compares the license IDs of the plurality of drivers registered in the driving-characteristics table TB1 with the acquired license ID of the predetermined driver based on the acquired control command. The driving-characteristics server S1 executes the driving evaluation of the predetermined driver using the driving-characteristics data associated with the matching license ID (St317). The driving-characteristics server S1 transmits the driving evaluation result to the license server S2 (St318).

The license server S2 acquires the driving evaluation result transmitted from the driving-characteristics server S1 (St319). The license server S2 records the driving evaluation result in association with the license ID registered in the license table TB2, and transmits the license ID to the wireless terminal device P1. The wireless terminal device P1 may be implemented with the car navigation device 12. The driving evaluation process of the predetermined driver may be executed by the license server S2. In such a case, the license server S2 acquires the driving-characteristics data used for driving evaluation from the driving-characteristics server S1.

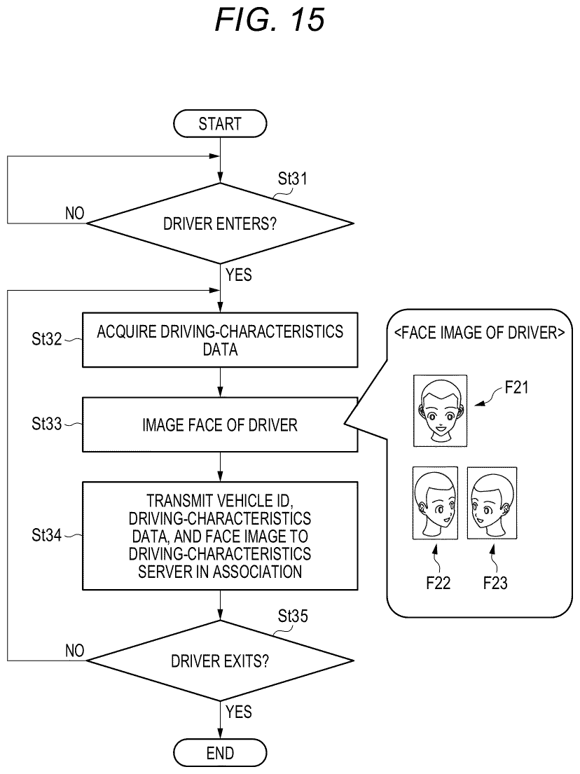

Next, a driver driving-characteristics data acquisition procedure executed in each of the vehicles C1, . . . will be described with reference to FIG. 15. FIG. 15 is a flowchart illustrating an example of the driver driving-characteristics data acquisition procedure in the vehicles C1, . . . .

Each of the vehicles C1, . . . determines whether the entry of the driver to the driver seat is detected (St31). If it is determined in the process of step St31 that the entry of the driver is detected (St31, YES), each of the vehicles C1, . . . starts acquiring the driving-characteristics data on the driver by the various sensors (St32).

On the other hand, if it is determined in the process of step St31 that the entry of the driver is not detected (St31, NO), each of the vehicles C1, . . . returns to the process of step St31 and continues to detect the entry of the driver to the driver seat.

Each of the vehicles C1, . . . images the face of the driver by the interior camera 13 (St33). The face images captured here are preferably the front face image F21, the right face image F22, and the left face image F23, but are not limited thereto.

Each of the vehicles C1, . . . transmits the vehicle ID of the host vehicle, one or more pieces of driving-characteristics data acquired by the various sensors, and each of the front face image F21, the right face image F22, and the left face image F23 to the driving-characteristics server S1 in association (St34).

Each of the vehicles C1, . . . determines whether the exit of the driver from the driver seat is detected (St35). If it is determined in the process of step St35 that the exit of the driver is detected (St35, YES), each of the vehicles C1, . . . ends acquiring the driving-characteristics data on the driver by the various sensors, and ends the driver driving-characteristics data acquisition procedure illustrated in FIG. 15. If the exit of the driver is detected, each of the vehicles C1, . . . may generate a control command for notifying the end of the driving by the driver, and transmit the generated control command to the driving-characteristics server S1 in association with the vehicle ID.

On the other hand, if it is determined in the process of step St35 that the exit of the driver is not detected (St35, NO), each of the vehicles C1, . . . returns to the process of step St32 and continues to acquire the driving-characteristics data on the driver by the various sensors. The process of step St33 may be omitted after the completion of the driver identification process (step St44) by the driving-characteristics server S1.

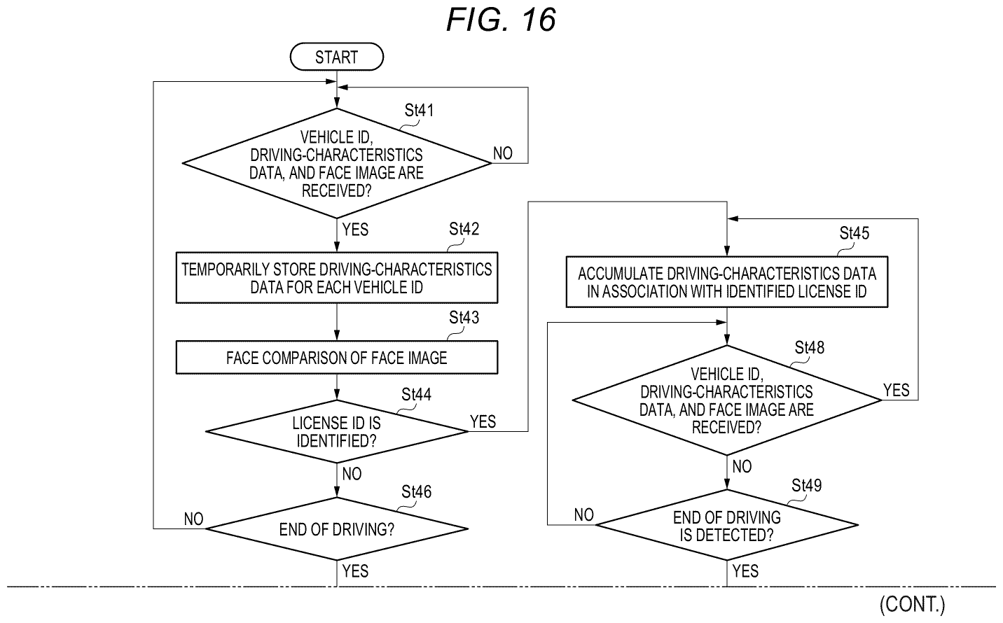

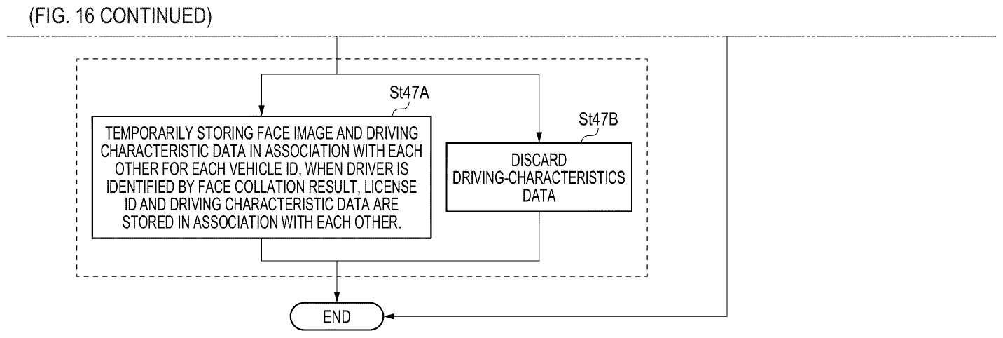

Next, a driver driving-characteristics data collection procedure executed by the driving-characteristics server S1 will be described with reference to FIG. 16. FIG. 16 is a flowchart illustrating an example of the driver driving-characteristics data collection procedure in the driving-characteristics server S1.

The driving-characteristics server S1 determines whether the vehicle ID transmitted from each of the vehicles C1, . . . , one or more pieces of driving-characteristics data, and one or more face images are received (St41).

If it is determined in the process of step St41 that the vehicle ID transmitted from each of the vehicles C1, . . . , one or more pieces of driving-characteristics data, and one or more face images are received (St41, YES), the driving-characteristics server S1 temporarily stores the driving-characteristics data in the memory 43 for each vehicle ID (St42).

On the other hand, if it is determined in the process of step St41 that the vehicle ID transmitted from each of the vehicles C1, . . . , one or more pieces of driving-characteristics data, and one or more face images are not received (St41, NO), the driving-characteristics server S1 returns to the process of step St41.

The driving-characteristics server S1 executes face comparison of the acquired face image of the driver (St43). Based on whether any face image is the same as or similar to the acquired face image of the driver among the face images of the plurality of drivers registered in the driving-characteristics table TB1 (for example, the face image appearing in the captured image of the driver's license), the driving-characteristics server S1 identifies the license ID of the driver associated with the face image the same as or similar to the acquired face image of the driver (St44).

Here, before the process of step St43, the driving-characteristics server S1 may compare the vehicle ID transmitted from the vehicles C1, . . . with each of the plurality of vehicle IDs registered in the driving-characteristics table TB1, and extract the license IDs of one or more drivers associated with the matching vehicle ID. Accordingly, in the process of step St44, the driving-characteristics server S1 can reduce the number of face images of the drivers registered in the driving-characteristics table TB1 matching with the acquired face image of the driver, and improve the comparison accuracy of face comparison.

If it is determined in the process of step St44 that a face image is the same as or similar to the acquired face image of the driver, the driving-characteristics server S1 determines that the driver corresponding to the acquired face image is identified based on the license ID of the driver associated with this face image (St44, YES). The driving-characteristics server S1 records (accumulates) the acquired driving-characteristics data in the driving-characteristics table TB1 in association with the identified license ID (St45).

On the other hand, if it is determined in the process of step St44 that no face images are the same as or similar to the acquired face image of the driver, the driving-characteristics server S1 determines that the driver corresponding to the acquired face image cannot be identified based on the license ID of the driver associated with this face image (St44, NO). The driving-characteristics server S1 determines whether a control command for notifying the end of driving is received from each of the vehicles C1, . . . (St46).

If it is determined in the process of step St46 that a control command for notifying the end of driving is received from each of the vehicles C1, . . . (St46, YES), the driving-characteristics server S1 temporarily stores the acquired face image and one or more pieces of driving-characteristics data in association for each vehicle ID (St47A). The driving-characteristics server S1 performs the process of step St44 again using a face image newly acquired on the same day or later. If it is determined that the driver's license ID is identified, the driving-characteristics server S1 records (accumulates) the temporarily stored driving-characteristics data associated with the same vehicle ID in association with the identified license ID (St47A). Accordingly, the driving-characteristics server S1 can accumulate the temporarily stored driving-characteristics data even if the initial registration of the license ID is not completed.

If it is determined in the process of step St46 that a control command for notifying the end of driving is received from each of the vehicles C1, . . . (St46, YES), the driving-characteristics server S1 discards (deletes) the driving-characteristics data associated with the same vehicle ID (St47B).

The driving-characteristics server S1 determines whether one or more pieces of driving-characteristics data associated with the vehicle ID for which the license ID is identified and one or more face images have been received from each of the vehicles C1, . . . (St48).

If it is determined in the process of step St48 that one or more pieces of driving-characteristics data associated with the vehicle ID for which the license ID is identified and one or more face images have been received (St48, YES), the driving-characteristics server S1 records (accumulates) the acquired driving-characteristics data in the driving-characteristics table TB1 in association with the identified license ID (St45).

On the other hand, if the driving-characteristics server S1 determines in the process of step St48 that one or more pieces of driving-characteristics data associated with the vehicle ID for which the license ID is identified and one or more face images are not received (St48, NO), the driving-characteristics server S1 determines whether a control command for notifying the end of driving is received from each of the vehicles C1, . . . (St49).

If it is determined in the process of step St49 that a control command for notifying the end of driving is received from each of the vehicles C1, . . . (St49, YES), the driving-characteristics server S1 ends the driver driving-characteristics data collection procedure illustrated in FIG. 16.

On the other hand, if it is determined in the process of step St49 that no control commands for notifying the end of driving are received from each of the vehicles C1, . . . (St49, NO), the driving-characteristics server S1 returns to the process of step St48.

As described above, the management method for driving-characteristics data executed by the driving-characteristics server S1 according to Embodiment 1, which is an example of one or more computers, includes: registering the biological information on a plurality of drivers (an example of the biological information, and is the biological information registered in the driving-characteristics table TB1) in association with the license IDs of the drivers; acquiring the biological information on the drivers who drives the vehicles C1, . . . and the driving-characteristics data indicating the driving-characteristics of the drivers; and, if it is determined some biological information is the same as or similar to the biological information among the registered biological information on the plurality of drivers (the biological information transmitted from each of the vehicles C1, . . . ), recording the license ID associated with the same or similar biological information in association with the driving-characteristics data.

Accordingly, since the driving-characteristics server S1 according to Embodiment 1 can record the driving-characteristics data on the driver transmitted from each of the vehicles C1, . . . in association with the identified license ID, the driving-characteristics data on a driver can be managed more efficiently even if the driver drives a plurality of different vehicles. Accordingly, in the collection and management (recording) of the driving-characteristics data used for the driving evaluation for determining whether an elderly driver needs to give up the driver's license, the driving-characteristics server S1 can more effectively collect and manage (record) the driving-characteristics data for objectively evaluating the driving operation of the elderly driver corresponding to the license ID.

In addition, the driving-characteristics server S1 according to Embodiment 1: further acquires the biological information, the driving-characteristics data, and the vehicle ID for identifying each of the vehicles C1, . . . (an example of the vehicle identification information); and, if it is determined that some biological information is the same as or similar to the biological information (the biological information transmitted from each of the vehicles C1, . . . ) among the registered biological information on the plurality of drivers, records the license ID associated with the same or similar biological information in association with the driving-characteristics data and the vehicle ID. Accordingly, the driving-characteristics server S1 according to Embodiment 1 can identify the vehicle from which the driving-characteristics data is acquired, and can more effectively collect and manage (record) the driving-characteristics data for objectively evaluating the driving operation for each vehicle of the elderly driver corresponding to the license ID.

If it is determined that no biological information is the same as or similar to the biological information (biological information transmitted from each of the vehicles C1, . . . ) among the registered biological information on the plurality of drivers, the driving-characteristics server S1 according to Embodiment 1 temporarily stores the driving-characteristics data in association with the vehicle ID. Accordingly, even if the driver cannot be identified using the biological information, the driving-characteristics server S1 according to Embodiment 1 can temporarily store the driving-characteristics data until the driver is identified by associating the driving-characteristics data transmitted from each of the vehicles C1, . . . with the vehicle ID.

The driving-characteristics server S1 according to Embodiment 1 further acquires the end-of-driving information on the vehicles C1, . . . , and temporarily stores the driving-characteristics data in association with the vehicle ID if it is determined that no biological information is the same as or similar to the biological information (biological information transmitted from each of the vehicles C1, . . . ) among the registered biological information on the plurality of drivers at the timing of acquiring the end-of-driving information. Accordingly, even if the identification of the driver using the biological information is not completed at the timing of the end of the driving by the driver, the driving-characteristics server S1 according to Embodiment 1 can temporarily store the driving-characteristics data until the driver is identified by associating the driving-characteristics data transmitted from each of the vehicles C1, . . . with the vehicle ID.

In addition, if it is determined that no biological information is the same as or similar to the biological information (biological information transmitted from each of the vehicles C1, . . . ) among the registered biological information on the plurality of drivers, the driving-characteristics server S1 according to Embodiment 1 acquires new biological information on the driver who drives the vehicle (new biological information transmitted from each of the vehicles C1, . . . ). If it is determined that some biological information is the same as or similar to the new biological information among the registered biological information on the plurality of drivers, the driving-characteristics server S1 records the license ID associated with the same or similar biological information in association with the temporarily stored driving-characteristics data and the vehicle ID. Accordingly, the driving-characteristics server S1 according to Embodiment 1 can acquire new biological information on the driver from each of the vehicles C1, . . . until the driver is identified, and repeatedly execute the identifying process of the driver based on the acquired new biological information. Accordingly, the driving-characteristics server S1 can record the license ID of the identified driver in association with the driving-characteristics server for temporary storage and the vehicle ID at the timing of identifying the driver corresponding to the driving-characteristics data transmitted from each of the vehicles C1, . . . .

If it is determined that no biological information is the same as or similar to the biological information (biological information transmitted from each of the vehicles C1, . . . ) among the registered biological information on the plurality of drivers, the driving-characteristics server S1 according to Embodiment 1 deletes the driving-characteristics data. Accordingly, the driving-characteristics server S1 according to Embodiment 1 does not record in the memory 33 the driving-characteristics data corresponding to a driver determined as unidentifiable, which can more effectively prevent the occurrence of the memory shortage of the memory 33.

The driving-characteristics server S1 according to Embodiment 1 further acquires the end-of-driving information on the vehicles C1, . . . , and deletes the driving-characteristics data if it is determined that no biological information is the same as or similar to the biological information (biological information transmitted from each of the vehicles C1, . . . ) among the biological information on the plurality of registered drivers at the timing if the end-of-driving information is acquired. Accordingly, the driving-characteristics server S1 according to Embodiment 1 does not record in the memory 33 the driving-characteristics data corresponding to a driver determined as unidentifiable at the timing of the end of driving by the driver, which can more effectively prevent the occurrence of the memory shortage of the memory 33.

The driving-characteristics server S1 according to Embodiment 1 acquires the biological information on the driver and the license ID of the driver corresponding to the biological information, and registers the biological information and the license ID in association if it is determined that the biological information matches the face image of the driver included in the license ID. As a result, the driving-characteristics server S1 according to Embodiment 1 registers the license ID of the new driver based on the comparison result between the biological information (for example, the face image, iris, or the like) on the driver transmitted from each of the vehicles C1, . . . and the face image of the driver included in the license ID, thereby more effectively preventing the spoofing by another person.

The biological information registered in the driving-characteristics server S1 (registered biological information) according to Embodiment 1 is face images of a plurality of drivers. The biological information (biological information transmitted from each of the vehicles C1, . . . ) is the face image of the driver who drives the vehicle. Accordingly, the driving-characteristics server S1 according to Embodiment 1 can identify the driver by performing face comparison between the face image of the driver captured and transmitted by each of the vehicles C1, . . . and the face images of the plurality of drivers registered in the driving-characteristics table TB1 in advance. In addition, by using the face image as the biological information, each of the vehicles C1, . . . can image the driver who is driving using the interior camera 13 without an operation of the driver and transmit the captured face image of the driver to the driving-characteristics server S1. Accordingly, the driving-characteristics server S1 can repeatedly request each of the vehicles C1, . . . to transmit the face image of the driver and perform face comparison using the transmitted face image until the driver is identified.

The driving-characteristics server S1 according to Embodiment 1: registers the front face image (an example of a first registered face image) in which the face of the driver faces the front face (an example of a first direction) and the right face image or the left face image (an example of a second registered face image) in which the face of the driver faces the right or the left (an example of a second direction) different from the front, in association with the license ID; acquires the front face image (an example of a first face image) in which the face of the driver who drives the vehicles C1, . . . faces the front and the right face image (an example of a second face image) or the left face image (an example of the second face image) in which the face of the driver faces the right or the left, and the driving-characteristics data; compares whether a front face image is the same as or similar to the front face image transmitted from the vehicles C1, . . . among the front face images of the plurality of registered drivers (an example of a first registered face image), and whether a right face image or left face image is the same as or similar to the right face image or left face image transmitted from the vehicles C1, . . . among the right face images or left face images of the plurality of registered drivers (an example of a second registered face image); and, if it is determined that a front face image is the same as or similar to the front face image transmitted from the vehicles C1, . . . and a right face image or left face image is the same as or similar to the right face image or similar to the right face image or left face image transmitted from the vehicles C1, . . . , records the license ID associated with the registered same or similar front face image and right face image or left face image in association with the driving-characteristics data. Accordingly, the driving-characteristics server S1 according to Embodiment 1 can identify the driver by performing face comparison between the front face image of the driver captured and transmitted by each of the vehicles C1, . . . and the front face images of the plurality of drivers registered in the driving-characteristics table TB1 in advance. In addition, the driving-characteristics server S1 can repeatedly request each of the vehicles C1, . . . to transmit the front face image of the driver and perform face comparison using the transmitted front face image until the driver is identified.

If it is determined that no front face images are the same as or similar to the front face images transmitted from the vehicles C1, . . . , the driving-characteristics server S1 according to Embodiment 1 acquires a new front face image from the vehicles C1, . . . , and determines again whether any front face image is the same as or similar to the new front face image among the registered front face images of the plurality of drivers. If it is determined that no right face images or left face images are the same as or similar to the right face image or left face image transmitted from the vehicle C1, . . . , the driving-characteristics server S1 acquires a new right face image or left face image transmitted from the vehicle C1, . . . , and determines again whether any right face image or left face image is the same as or similar to the new right face image or left face image among the right face images or left face images of the plurality of registered drivers. Accordingly, the driving-characteristics server S1 according to Embodiment 1 can identify the driver by performing face comparison between the right face image or left face image of the driver captured and transmitted by each of the vehicles C1, . . . and the right face images or left face images of the plurality of drivers registered in the driving-characteristics table TB1 in advance. In addition, the driving-characteristics server S1 can repeatedly request each of the vehicles C1, . . . to transmit the right face image or the left face image of the driver and perform face comparison using the transmitted right face image or left face image until the driver is identified. Furthermore, the driving-characteristics server S1 according to Embodiment 1 can by further execute not only the face comparison using the front face image but also the face comparison using the right face image or left face image, thereby more effectively preventing the spoofing on the driver by another person.

As described above, the car navigation device 10 according to Embodiment 1 is an on-vehicle device mounted on the vehicle C1, . . . , and includes the communication device 11 (an example of a communication unit) that performs data communication with the driving-characteristics server S1 (an example of an external device), the interior camera 13 (an example of a first acquiring unit) that acquires the biological information on the driver who drives the vehicle C1, . . . , the gyro sensor 14 or various sensors (an example of a second acquiring unit) that acquires the driving-characteristics data indicating the driving-characteristics of the driver, and the processor 12A (an example of a control unit) that outputs the biological information in association with the driving-characteristics data. The processor 12A outputs to the communication device 11 and transmits to the driving-characteristics server S1 the associated biological information and driving-characteristics data. The various sensors referred to here include, for example, the interior camera 13, the accelerator pedal 17A, the brake pedal 17B, the turn lamp 17C, the steering wheel 17D, the speed sensor 18, the exterior sensor/camera 19, and the GPS sensor 20 (see FIG. 2).

Accordingly, the car navigation device 10 according to Embodiment 1 acquires the biological information for identifying the driver and the driving-characteristics data used for the driving evaluation, and transmits the acquired biological information to the driving-characteristics server S1 in association with the driving-characteristics data. Therefore, the management of the driving-characteristics data for each driver performed by the driving-characteristics server S1 can be assisted in a manner that can be collected and managed (recorded) effectively.

The car navigation device 10 according to Embodiment 1 further includes the memory 12B (an example of a recording unit) that records the vehicle ID for identifying the vehicles C1, . . . (an example of vehicle identification information). The processor 12A outputs to the communication device 11 and transmits to the driving-characteristics server S1 the acquired biological information, driving-characteristics data and vehicle ID in association. Accordingly, the car navigation device 10 according to Embodiment 1 acquires the biological information for identifying the driver, the driving-characteristics data used for the driving evaluation, and the vehicle ID, and transmits the acquired biological information, driving-characteristics data and vehicle ID to the driving-characteristics server S1 in association. Therefore, the management of the driving-characteristics data for each driver performed by the driving-characteristics server S1 can be assisted in a manner that can be collected and managed (recorded) effectively, even if one vehicle C1, . . . is driven by a plurality of drivers.

The car navigation device 10 according to Embodiment 1 further includes the processor 12A (an example of a third acquiring unit) that acquires entry information or exit information on the driver to/from the vehicles C1, . . . . The processor 12A causes the interior camera 13 to start acquiring the biological information and causes the gyro sensor 14 or various sensors to start acquiring the driving-characteristics data from the timing of acquiring the entry information on the driver. Accordingly, the car navigation device 10 according to Embodiment 1 can automatically start acquiring the biological information and acquiring the driving-characteristics data from the timing of acquiring the entry information on the driver (that is, the timing of detecting the entry of the driver). Accordingly, since the car navigation device 10 can start acquiring the driving-characteristics data without the operation of the driver, it is possible to prevent the omission of the acquisition of the driving-characteristics data due to the driver forgetting to start acquiring the driving-characteristics data.

In addition, the processor 12A included in the car navigation device 10 according to Embodiment 1 causes the interior camera 13 to end acquiring the biological information and causes the gyro sensor 14 or various sensors to end acquiring the driving-characteristics data at the timing of acquiring the exit information on the driver. Accordingly, the car navigation device 10 according to Embodiment 1 can automatically end acquiring the biological information and acquiring the driving-characteristics data at the timing of acquiring the exit information on the driver (that is, the timing of detecting the exit of the driver).

The interior camera 13 in the car navigation device 10 according to Embodiment 1 is a camera that images the face of the driver. The biological information is a face image of the driver captured by the interior camera 13. Accordingly, the car navigation device 10 according to Embodiment 1 can image the face of the driver with the interior camera 13 even when the driver is driving, and can acquire the captured image as the biological information.

If it is determined that the face orientation of the driver appearing in the face image captured by the interior camera 13 is a predetermined direction (for example, front, right, or left), the processor 12A included in the car navigation device 10 according to Embodiment 1 outputs to the communication device 11 and transmits to the driving-characteristics server S1 the face image in association with the driving-characteristics data. Accordingly, the car navigation device 10 according to Embodiment 1 can select the face image, and can more effectively prevent an increase in the amount of data communication required for transmitting the face image to the driving-characteristics server S1.

The communication device 11 in the car navigation device 10 according to Embodiment 1 receives the designation of the face orientation of the driver appearing in the face image from the driving-characteristics server S1. If it is determined that the face orientation of the driver appearing in the face image is the face orientation of the designated driver, the processor 12A outputs to the communication device 11 and transmits to the driving-characteristics server S1 the face image in association with the driving-characteristics data. Accordingly, the car navigation device 10 according to Embodiment 1 can select the face image used for face comparison, and can more effectively prevent an increase in the amount of data communication required for transmitting the face image to the driving-characteristics server S1.

The car navigation device 10 according to Embodiment 1 further includes the input unit 12D or the interior camera 13 (an example of a fourth acquiring unit) for acquiring the driver's license ID. The processor 12A outputs to the communication device 11 and transmits to the driving-characteristics server S1 the acquired biological information, vehicle ID and license ID in association. Accordingly, the car navigation device 10 according to Embodiment 1 can transmit the biological information on the driver, the vehicle ID and the license ID, which are the initial registration data necessary for the initial registration of the driver, to the driving-characteristics server S1 in association. Therefore, the driving-characteristics server S1 can execute the face comparison of the driver based on the biological information on the driver and the license ID transmitted from the car navigation device 10 in the vehicle C1, . . . , and can complete the initial registration by registering (storing) the biological information on the driver, the vehicle ID, and the license ID in the driving-characteristics table TB1 in association if it is determined that the face comparison is successful. After the initial registration, if it is determined that the biological information transmitted from the same or another vehicle is the same as or similar to the initially registered biological information, the driving-characteristics server S1 can identify the driver corresponding to the biological information transmitted from the same or another vehicle as the driver corresponding to the license ID associated with the biological information determined as the same or similar, and can collect and manage (record) the driving-characteristics data for each driver by recording the driving-characteristics data transmitted from the same or another vehicle in association with the license ID of the driver.

### (Background of Embodiment 2)

In recent years, it has been found that driving a vehicle is effective in reducing the risk of dementia, extending the healthy life, and the like of elderly people. and can prevent a decline in the action range and the action frequency and prevent a decline in the mental and physical functions, thereby aiding the elderly people to continue healthy social participation. Therefore, there is a demand for a technique for preventing an increase in accidents caused due to driving operation errors, forgetting to confirm the safety, or the like due to the aging of elderly drivers and extending the driving life of elderly drivers.

In the related art, as a technique for performing driving assistance, Patent Literature 2 discloses a vehicle warning device that determines whether the driver needs to confirm the safety based on the correlation between a predetermined road parameter of the road on which the vehicle travels and the steering angle, and issues a warning to the driver if it is determined that safety confirmation is not performed. In Patent Literature 3, a driving assistance device for performing driving assistance on a driver learns the driving proficiency level of the driver based on the history of driving operations of the driver and performs driving assistance according to a driving assistance level based on the driving proficiency level. However, it is desirable that such a driving assistance device performs dynamic driving assistance corresponding to the driving situation and corresponding to the state of the driver.

A driving assistance device for performing driving assistance on a driver by autonomous driving disclosed in Patent Literature 4 estimates the driver state of the driver with respect to the external environment from an environmental difficulty level required for a driving operation of the driver by the external environment of the vehicle and a driving skill based on the driving operation of the driver, and selectively executes driving assistance contents (for example, automatic steering, automatic braking, or the like) based on the driving skill and the driver state (for example, emotion, psychology, or the like). However, the driving assistance by autonomous driving cannot perform improving assistance of the driving-characteristics (driving skills, safety confirmation, and the like) of the driver.

The following Embodiment 2 describes an example of a management method for driving-characteristics improving assistance data that can more efficiently collect the driving-characteristics data for each driver and assist the management of the collected driving-characteristics data. In the following description, the same components as those in Embodiment 1 are denoted by the same reference numerals, and thus the description thereof will be omitted.

The driving-characteristics data according to Embodiment 2 is described with an example including data indicating driving-characteristics and data indicating behavior-characteristics of the driver (for example, movement information on the body, face, line of sight, and the like of the driver). The driving-characteristics evaluation result in Embodiment 2 indicates the driving skills of the driver including a safety confirmation behavior executed by the driver.

### Embodiment 2

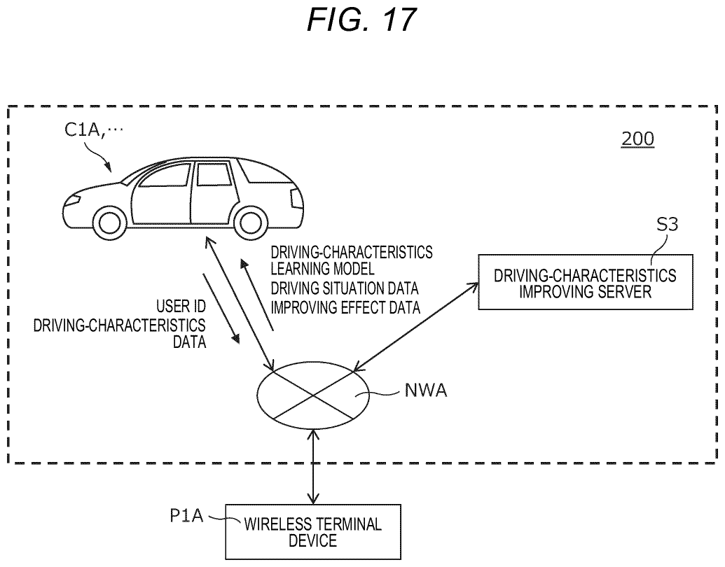

An example of a use case of a driving-characteristics improving assistance system 200 according to Embodiment 2 will be described with reference to FIG. 17. FIG. 17 is a diagram illustrating an example of a use case of the driving-characteristics improving assistance system 200 according to Embodiment 2.

The driving-characteristics improving assistance system 200 includes one or more vehicles C1A, . . . , a driving-characteristics improving server S3, and a network NWA. The driving-characteristics improving assistance system 200 may include a wireless terminal device P1A.

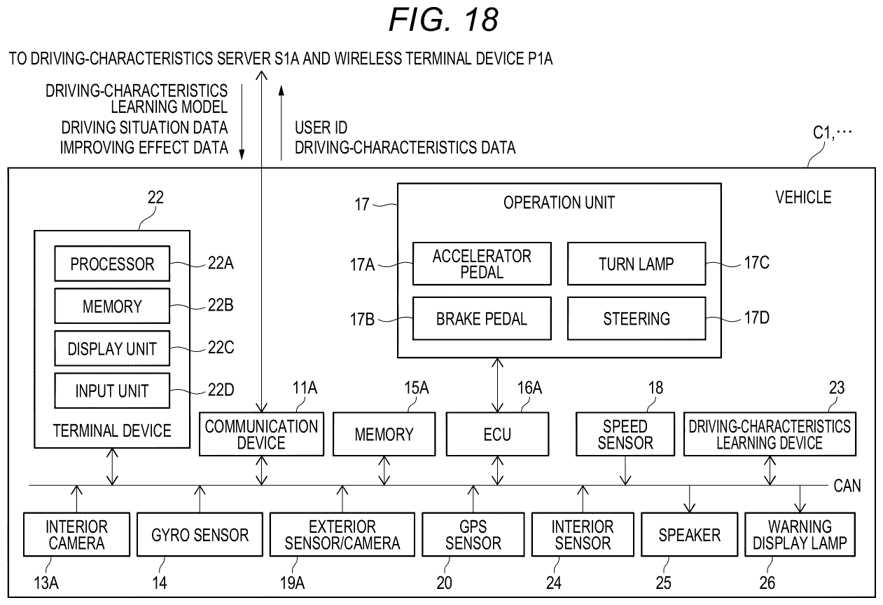

The driving-characteristics improving assistance system 200 acquires driving-characteristics data and safety confirmation behavior data on a driver who drives each of the one or more vehicles C1A, . . . . The driving-characteristics data and the safety confirmation behavior data are transmitted from a communication device 11A (see FIG. 18) mounted on the vehicle. The driving-characteristics improving assistance system 200 transmits the acquired driving-characteristics data and safety confirmation behavior data to the driving-characteristics improving server S3. The driving-characteristics improving assistance system 200 determines whether the driving-characteristics of the driver based on the driving skills of the driver indicated by the driving-characteristics data and the safety confirmation behavior of the driver during driving indicated by the safety confirmation behavior data are improved, and transmits the driving-characteristics improving evaluation result to the vehicles C1A, . . . . The driving-characteristics improving assistance system 200 updates the improving effect data indicating the driving assistance content for the driver (an example of new improving effect data) in each of the vehicles C1A, . . . based on the driving-characteristics improving evaluation result, and executes the driving-characteristics improving assistance based on the updated improving effect data.

The driving-characteristics data in Embodiment 2 is data indicating driving-characteristics of the driver, and may be acquired by various sensors mounted on each of the vehicles C1A, . . . (for example, an interior camera 13A, a gyro sensor 14, an accelerator pedal 17A, a brake pedal 17B, a turn lamp 17C, a steering wheel 17D, a speed sensor 18, an exterior sensor/camera 19A, an interior sensor 24, and the like (see FIG. 18)).

The improving effect data referred to here is data generated by the driving-characteristics improving server S3, and is data for determining the assistance method for improving the driving-characteristics based on the driving-characteristics data on the driver of each of the vehicles C1A, . . . , data indicating a reaction of the driver (for example, emotion, facial expression, heartbeat, or the like of the driver) in a time period before and after the driving-characteristics improving assistance (hereinafter, referred to as “emotion data”), and driving situation information indicating a driving situation in which the driving-characteristics are acquired.

The driving situation referred to here includes not only any situation during driving (for example, lane change, right and left turn, forward movement, backward movement, or the like), but also a situation before and after driving, such as a situation in which the driver enters the vehicle before driving, or a situation in which the driver or a passenger exits the vehicle after driving or during a temporary stop, which requires safety confirmation. In the driving situation, a degree of risk (score) based on the likelihood of occurrence of accidents, the importance of safety confirmation, or the like may be set in advance based on the road environment (for example, T-shaped road, cross road, downhill road, or the like) during traveling, the road situation (for example, traffic jam or the like), environment information (for example, time zone, weather, or the like) on the road during traveling, the number of times or frequency of occurrence of accidents on the road during traveling, or the like.

In the driving situation, a threshold related to the frequency of executing the safety confirmation behavior may be set corresponding to the degree of risk (score). In such a case, each of the vehicles C1A, . . . may determine whether to execute the driving-characteristics improving assistance based on the comparison result obtained by comparing the frequency of the driver executing the safety confirmation behavior with the threshold.

Each of the vehicles C1A, . . . is wirelessly communicably connected to the driving-characteristics improving server S3 and the wireless terminal device P1A via the network NWA. The wireless communication referred to here is, for example, a wireless LAN represented by Wi-Fi (registered trademark), a cellular communication system (mobile communication system), or the like, and the type thereof is not particularly limited.

Each of the vehicles C1A, . . . starts acquiring driving-characteristics data indicating the driving-characteristics of the driver and the behavior-characteristics of the driver (for example, movement of a body, a face, an eye, or the like of the driver) and determining (identifying) a driving situation from a timing of detecting the driver approaching the host vehicle. Based on the improving assistance data corresponding to the driving situation information on the identified driving situation, each of the vehicles C1A, . . . executes the driving-characteristics improving assistance (that is, assistance of the safety confirmation behavior) for the driver and acquires the emotion data on the driver for the driving-characteristics improving assistance.

Each of the vehicles C1A, . . . determines whether the driver has performed the safety confirmation behavior corresponding to the current driving situation information based on the acquired driving-characteristics data (specifically, the behavior-characteristics). In addition, each of the vehicles C1A, . . . transmits a safety confirmation behavior result as to whether the driver performs a safety confirmation behavior or the driving-characteristics data including the driving-characteristics and the behavior-characteristics of the driver, and the driving situation information, the emotion data to the driving-characteristics improving server S3 in association with the user ID for identifying the driver.

Each of the vehicles C1A, . . . stores, in the driving-characteristics learning device 23, the driving situation of the host vehicle determined based on the data on the surrounding environment of the host vehicle acquired by the various sensors, and a driving-characteristics learning model for determining whether the driving-characteristics of the driver are improved by using the driving-characteristics data acquired by the various sensors. Each of the vehicles C1A, . . . acquires the driving-characteristics learning model or the update data on the driving situation data transmitted from the driving-characteristics improving server S3, and updates the data stored in the driving-characteristics learning device 23 such as the driving-characteristics learning model and the driving situation data. Each of the vehicles C1A, . . . sets a driving-characteristics improving assistance method for assisting safety confirmation behavior of the driver in a predetermined driving situation based on the improving effect data transmitted from the driving-characteristics improving server S3. Each of the vehicles C1A, . . . ends acquiring the driving-characteristics data at a timing of detecting the end of driving of the host vehicle by the driver.

Each of the vehicles C1A, . . . extracts and transmits to the wireless terminal device P1A the driving-characteristics data on the driver stored in the memory 15A (see FIG. 18), or generates and transmits to the wireless terminal device P1A the driving-characteristics evaluation result obtained by evaluating the driving-characteristics using the extracted driving-characteristics data, based on the driving-characteristics data on the driver or the control command requesting the driving-characteristics evaluation result transmitted from the wireless terminal device P1A.

The driving-characteristics improving server S3 is connected to each of the vehicles C1A, . . . and the wireless terminal device P1A via the network NWA for data communication. The driving-characteristics improving server S3 acquires the user ID of the driver, the driving-characteristics data, the emotion data, and the driving situation information transmitted from each of the vehicles C1A, . . . .

The driving-characteristics improving server S3 compares the acquired user ID with the user ID of each of the plurality of drivers registered (stored) in a user database DB1, and identifies the driver of the acquired user ID. The driving-characteristics improving server S3 determines whether the driving-characteristics of the driver are improved by comparing the acquired driving-characteristics data with the driving-characteristics data on the user ID of the identified driver associated with the same driving situation information as the acquired driving situation information, and determines whether the current driving-characteristics improving assistance method (improving effect data) executed by each of the vehicles C1A, . . . is an assistance method suitable for the driver based on the acquired emotion data. The user ID referred to here may be a license ID, biological information, or the like used for identifying the driver in Embodiment 1.

The driving-characteristics improving server S3 generates, updates, and transmits to each of the vehicles C1A, . . . the new improving effect data based on the determination result as to whether the driving-characteristics of the driver are improved and the emotion data on the driver for the driving-characteristics improving assistance method indicated by the current improving effect data.

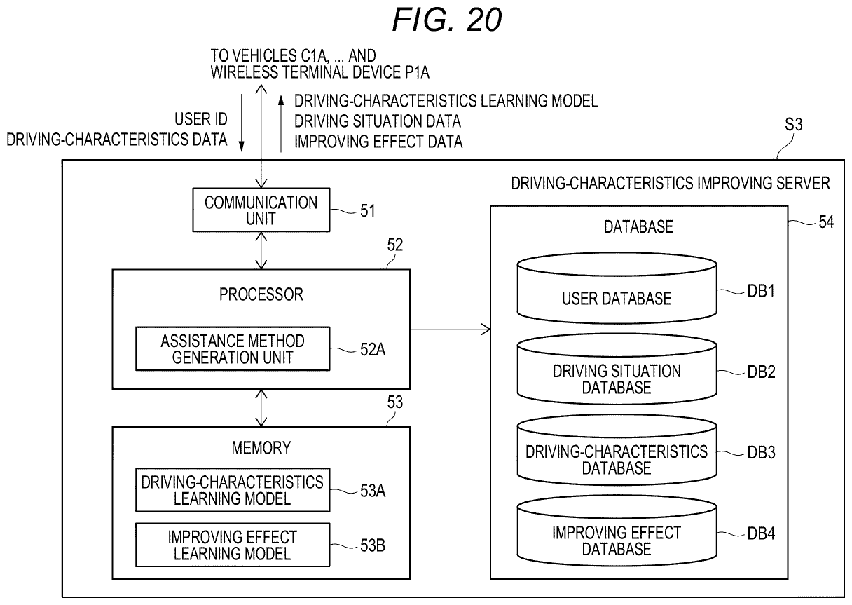

The driving-characteristics improving server S3 extracts and transmits to the wireless terminal device P1A the driving-characteristics data on the driver stored in the database 54 (see FIG. 20), or generates and transmits to the wireless terminal device P1A the driving-characteristics evaluation result obtained by evaluating the driving-characteristics using the extracted driving-characteristics data, based on the driving-characteristics data on the driver or the control command requesting the driving-characteristics evaluation result transmitted from the wireless terminal device P1A.

The network NWA is connected to each of the plurality of vehicles C1A, . . . , the driving-characteristics improving server S3, and the wireless terminal device P1A for wireless communication or wired communication.

Next, an example of the internal configuration of the vehicles C1A, . . . in Embodiment 2 will be described with reference to FIG. 18. FIG. 18 is a block diagram illustrating an example of the internal configuration of vehicles C1A, . . . according to Embodiment 2. The internal configuration of the vehicles C1A, . . . illustrated in FIG. 18 illustrates an example of the internal configuration in a case where a face image of the driver is used as biological information, and the illustration of the sensors for acquiring the other biological information, the license reader, and the like is omitted. Since the vehicles C1A, . . . have the same internal configuration, the internal configuration of the vehicle C1A will be described below.

The vehicle C1A includes at least the communication device 11A, the terminal device 22, the interior camera 13A, the gyro sensor 14, the memory 15A, and the ECU 16A. Each unit inside the vehicle C1A is connected to a CAN or the like to transmit and receive data.

The communication device 11A, the terminal device 22, the interior camera 13A, and the gyro sensor 14 may be integrated into one terminal device 22. The sensor mounted on the vehicle C1A illustrated in FIG. 2 is an example and is not limited thereto.

The communication device 11A transmits and receives data between the vehicle C1A and the driving-characteristics improving server S3 via the network NW by wireless communication.

The terminal device 22 is, for example, a car navigation device or a smart phone a tablet terminal owned by the driver, or the like, and is a device capable of receiving an operation of the driver. The terminal device 22 may be an IVI device capable of providing, for example, a car navigation function, a position information providing service function, an Internet connection function, and a multimedia play function. The terminal device 22 includes a processor 22A, a memory 22B, a display unit 22C, and an input unit 22D.

The processor 22A is implemented with, for example, a CPU, a DSP, or an FPGA, and controls the operation of each unit. The processor 22A performs the overall processing and control in cooperation with the memory 22B. Specifically, the processor 22A implements functions of each unit by referring to a program and data stored in the memory 22B and executing the program.

The processor 22A starts acquiring the driving-characteristics and the behavior-characteristics (driving-characteristics data) and to determine the driving situation from a timing of acquiring a control command indicating the detection of the driver approaching from the interior sensor 24 or the communication device 11A. After identifying the driving situation, the processor 22A executes the driving-characteristics improving assistance based on the improving effect data corresponding to the driving situation information on the driving-characteristics. The processor 22A starts various processes such as acquiring the driving-characteristics, the behavior-characteristics, and the emotion data on the driver for the executed driving-characteristics improving assistance.

The processor 22A acquires various driving-characteristics data acquired by the various sensors (for example, the interior camera 13A, the gyro sensor 14, the accelerator pedal 17A, the brake pedal 17B, the turn lamp 17C, the steering wheel 17D, the speed sensor 18, the exterior sensor/camera 19A, the interior sensor 24, and the like) via the ECU 16A.

The processor 22A identifies the driver based on the user ID output from the input unit 22D. The processor 22A determines the driving situation based on a captured image or information acquired by the interior camera 13A, the exterior sensor/camera 19A, the GPS sensor 20, the interior sensor 24, or the like.

The processor 22A controls speakers 25 or warning display lamps 26 to execute the driving-characteristics improving assistance (safety confirmation behavior assistance) for the driver based on the driving situation information on the determined driving situation and the improving effect data corresponding to the driving situation information.

The processor 22A acquires the image captured by the interior camera 13A, detects the face of the driver appearing in the acquired captured image, and analyzes the emotion of the driver before and after the driving-characteristics improving assistance to generate the emotion data based on the detected facial expression of the driver.

The processor 22A acquires the image captured by the interior camera 13A or the exterior sensor/camera 19A, and analyzes the movement of the body and eyes of the driver appearing in the acquired captured image to generate driving-characteristics data including the behavior-characteristics of the driver based on the analysis result and the driving-characteristics acquired by the various sensors.

The processor 22A stores in the memory 15A, outputs to the communication device 11A and transmits to the driving-characteristics improving server S3 the driving situation information after executing the driving-characteristics improving assistance, the emotion data on the driver for the driving-characteristics improving assistance, and the driving-characteristics data acquired by the various sensors, in association with the user ID of the driver. The processor 22A may further transmit the determination result as to whether the driver executes the safety confirmation behavior to the driving-characteristics improving server S3 in association with the acquired behavior data.

The processor 22A acquires the driving situation information and the improving effect data transmitted from the driving-characteristics improving server S3. The processor 22A updates the improving effect data corresponding to the acquired driving situation information to the newly acquired improving effect data.

The processor 22A ends the various processes such as acquiring the driver driving-characteristics data, determining the driving situation, the driving-characteristics improving assistance, or acquiring the emotion data at a timing of determining that the driver exits the vehicle or the driver leaves the host vehicle.

The memory 22B includes, for example, a RAM as a work memory used when each process of the processor 22A is executed, and a ROM that stores a program and data that define an operation of the processor 22A. The RAM temporarily stores data or information generated or acquired by the processor 22A. The program that defines the operation of the processor 22A is written into the ROM. The memory 22B stores one or more user IDs that drive the vehicle C1A and a driving-characteristics history table TB3.

The display unit 22C is implemented with, for example, an LCD or an organic EL. The display unit 22C displays a driving-characteristics evaluation result screen (not illustrated) or the like generated by the processor 22A.

The input unit 22D is a user interface integrated with the display unit 22C. The received operation of the driver is converted into an electric signal (control command) and output to the processor 22A by the input unit 22D. The input unit 22D receives an input operation of the user ID by the driver, an input operation of requesting to generate the driving-characteristics evaluation screen, setting of enabling/disabling the driving-characteristics improving assistance, and the like.

The interior camera 13A includes at least a lens (not illustrated) and an image sensor (not illustrated). The image sensor is, for example, a solid-state imaging device such as a CCD or a CMOS, and converts an optical image formed on an imaging surface into an electric signal.

The interior camera 13A is controlled by the processor 22A to image the driver sitting in the driver seat and output the captured image to the processor 22A. The processor 22A analyzes the captured image output from the interior camera 13A and generates behavior-characteristics data indicating the movement of the face, eyes, or body of the driver. The processor 22A compares the generated behavior-characteristics data with one or more safe driving behaviors corresponding to the driving situation, and determines whether the safety confirmation behavior to be executed in the current driving situation is executed by the driver. The analysis on the behavior-characteristics data on the driver and the determination as to whether the safety confirmation behavior to be executed in the current driving situation is executed by the driver may be executed by the processor 52 of the driving-characteristics improving server S3.

The interior camera 13A is controlled by the processor 22A to image the driver sitting in the driver seat and output the captured image to the processor 22A. The processor 22A analyzes the captured image output from the interior camera 13A to analyze the emotion of the driver and generate the emotion data. The emotion data may be generated by the processor 52 of the driving-characteristics improving server S3.

The memory 15A includes, for example, a RAM as a work memory used when each process of the ECU 16A is executed, and a ROM that stores a program and data that define an operation of the ECU 16A. The RAM temporarily stores data or information generated or acquired by the ECU 16A. The program that defines the operation of the ECU 16A is written into the ROM. The memory 15A may store the one or more user IDs that drive the vehicle C1A and the driving-characteristics history table TB3.

The ECU 16A collectively executes the processing and control of each unit. The ECU 16A is implemented with a so-called electronic circuit control device, and implements the function of each unit by referring to a program and data stored in the memory 15A and executing the program. The ECU 16A acquires the information output the from various sensors as the driving-characteristics data. The ECU 16A outputs the driving-characteristics data to the processor 22A.

The ECU 16A detects the driver approaching the host vehicle or the driver leaving the host vehicle (that is, the end of driving) based on an electric signal output from the interior sensor 24, and outputs the detection information to the processor 22A. Although the description is omitted here, the ECU 16A may be capable of implementing the various functions executed by the processor 22A, such as the various processes necessary for the driving-characteristics improving assistance, and the driving-characteristics evaluation on the driver.

The exterior sensor/camera 19A is one or more sensors such as a radar and a sonar provided in the vehicle C1A, and one or more cameras capable of imaging the surroundings of the vehicle C1A (outside the vehicle). The camera referred to here may be a drive recorder. The exterior sensor/camera 19A detects or images the position and the direction of an object present around the vehicle C1A (for example, a wall, an obstacle, another vehicle, a person, or the like) or an approaching object (for example, another vehicle, a two-wheeler, a person, or the like) approaching the host vehicle, a sign, a white line on a road, the driver or a passenger exiting and leaving the host vehicle, the driver or a passenger approaching and entering the host vehicle, or the like. The exterior sensor/camera 19A outputs the detection information or the captured image to the processor 22A.

The driving-characteristics learning device 23 records the driving-characteristics learning model and the driving situation data transmitted from the driving-characteristics improving server S3. The processor 22A generates the driving-characteristics data using the driving-characteristics learning model recorded in the driving-characteristics learning device 23 and the information acquired by the various sensors. The processor 22A determines the driving situation using the driving situation data recorded in the driving-characteristics learning device 23 and the information acquired by the various sensors, and generates driving situation data indicating the driving situation of the vehicles C1A, . . . .

The interior sensor 24 is, for example, a sensor capable of receiving radio waves transmitted from a smart key of the host vehicle, an open/close sensor provided at a door corresponding to each seat, a weight sensor provided at each seat, a seat belt wearing sensor, or the like. When receiving radio waves emitted from the smart key, the interior sensor 24 generates an electric signal (control command) notifying the approach of the driver and outputs the electric signal to the ECU 16A. If radio waves emitted from the smart key cannot be received, the interior sensor 24 generates an electric signal (control command) notifying that the driver leaves the host vehicle, and outputs the electric signal to the ECU 16A. The interior sensor 24 also outputs, to the ECU 16A, detection information on the movement of the body (weight) of the driver obtained by the weight sensor provided at the driver seat, whether the seat belt is worn or released, whether the door of the driver seat is open or closed, and the like.

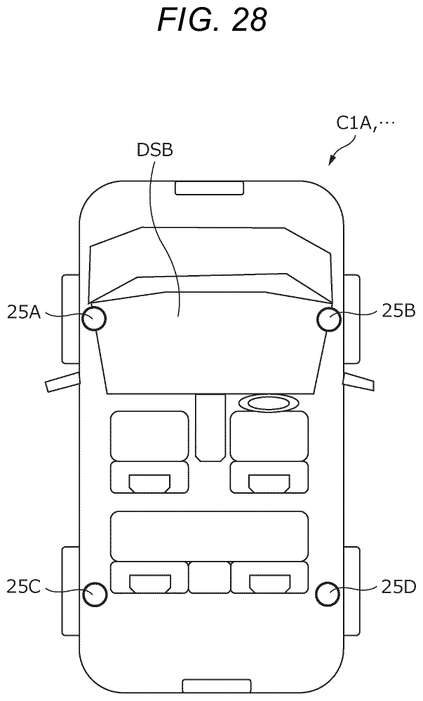

At least one speaker 25 as an example of the safe driving assistance device is provided in each of the vehicles C1A, . . . , and is controlled by the processor 22A or the ECU 16A to output an assistance voice corresponding to the driving situation and execute the driving-characteristics improving assistance of the driver. The positions and the number for installing the speakers 25 in each of the vehicles C1A, . . . according to Embodiment 2 will be described with an example in which two speakers 25 are installed in each of the front and the rear of the vehicle as illustrated in FIG. 28, which is an example and is not limited thereto as a matter of course. The speakers 25 may be installed not only inside the vehicle but also outside the vehicle.

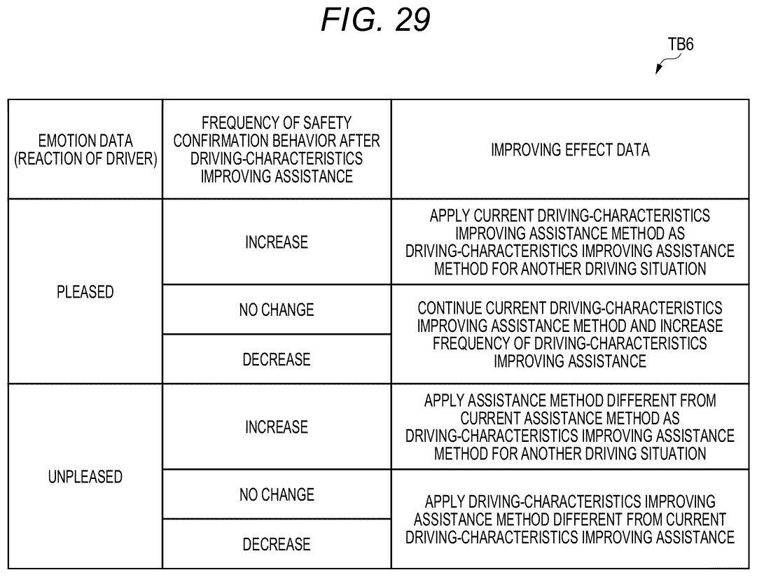

The warning display lamps 26 as an example of the safe driving assistance device are, for example, light emitting diodes (LEDs) provided in the pillars or the like in the vehicle, and are controlled by the processor 22A or the ECU 16A to be lighted in accordance with the driving situation to perform the driving-characteristics improving assistance of the driver. The positions and the number for installing the warning display lamps 26 in the vehicles C1A, . . . according to Embodiment 2 are not limited to the example illustrated in FIG. 29 as a matter of course. The warning display lamps 26 may be installed at a position other than a pillar (for example, a side mirror, a room mirror, or the like).

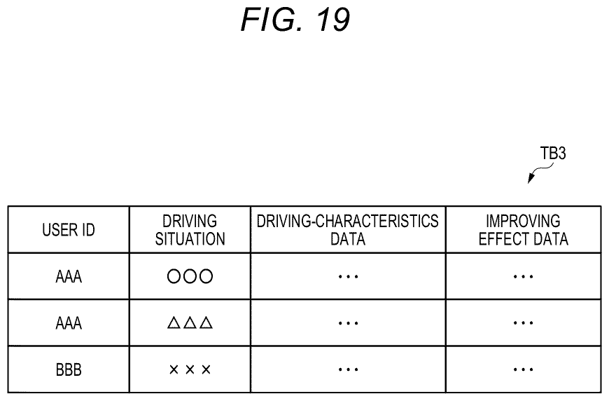

Next, the driving-characteristics history table TB3 recorded in each of the vehicles C1A, . . . will be described with reference to FIG. 19. FIG. 19 is a diagram illustrating an example of the driving-characteristics history table TB3. In the following description, for ease of understanding, the various data or information recorded in each of the vehicles C1A, . . . is described using the driving-characteristics history table TB3, but the driving-characteristics history table TB3 is not essential and may be omitted.

The driving-characteristics history table TB3 records and manages the driving situation information, the driving-characteristics data, and the improving effect data corresponding to the driving situation information in association with the user ID. The user ID may be a license ID.

For example, the driving-characteristics history table TB3 illustrated in FIG. 19 records the driving situation information “MMM”, the driving-characteristics data, and the improving effect data in association with the user ID “AAA”, records the driving situation information “NNN”, the driving-characteristics data, and the improving effect data in association with the user ID “AAA”, and records the driving situation information “OOO”, the driving-characteristics data, and the improving effect data in association with the user ID “BBB”. Accordingly, the driving-characteristics history table TB3 can more efficiently record (manage) the driving-characteristics data and the improving effect data for each user ID even if the same vehicle is driven by a plurality of different drivers (for example, each of the two users “AAA” and “BBB”).

Next, an example of the internal configuration of the driving-characteristics improving server S3 will be described with reference to FIG. 20. FIG. 20 is a block diagram illustrating an example of the internal configuration of the driving-characteristics improving server S3 according to Embodiment 2.

The driving-characteristics improving server S3 includes a communication unit 51, a processor 52, a memory 53, and a database 54. The database 54 may be configured as a separate body connected to the driving-characteristics improving server S3 for data communication.

The communication unit 51 is connected to each of the vehicles C1A, . . . and the wireless terminal device P1 via the network NW to transmit and receive data.

The processor 52 is implemented with, for example, a CPU, a DSP, or an FPGA, and controls the operation of each unit. The processor 52 performs the overall processing and control in cooperation with the memory 53. Specifically, the processor 52 implements functions of each unit of the assistance method generation unit 52A by referring to a program and data stored in the memory 53 and executing the program. When the driving-characteristics learning model or the driving situation data is updated, the processor 52 transmits the updated driving-characteristics learning model or driving situation data to each of the vehicles C1A, . . . .

The processor 52 may generate training data (learning data) used for generating the driving-characteristics learning model based on machine learning using the driving-characteristics data corresponding to the driving situation information transmitted from each of the vehicles C1A, . . . . The processor 52 may generate training data (learning data) used for generating the improving effect learning model based on machine learning using the emotion data on the driver for the driving-characteristics improving assistance based on the improving effect data transmitted from each of the vehicles C1A, . . . .

The learning for generating the training data may be executed using one or more statistical classification techniques. Examples of the statistical classification technique include, for example, multiple regression analysis, linear classifiers, support vector machines, quadratic classifiers, kernel estimation, decision trees, artificial neural networks, Bayesian techniques and/or networks, hidden Markov models, binary classifiers, multi-class classifiers, clustering technique, random forest technique, logistic regression technique, linear regression technique, and gradient boosting technique. However, the statistical classification technique to be used is not limited thereto.

The assistance method generation unit 52A acquires the driving-characteristics data, the driving situation information, the emotion data, and the user ID transmitted from each of the vehicles C1A, . . . . The assistance method generation unit 52A identifies the driver by comparing the acquired user ID with each of the plurality of user IDs registered (stored) in the user database DB1. If it is determined that the user ID the same as the acquired user ID is not registered in the user database DB1, the assistance method generation unit 52A may register (store) the acquired user ID as a new user in the user database DB1.

The assistance method generation unit 52A determines whether a degree of risk (score) corresponding to a driving situation that requires safe driving is a predetermined value or more based on the acquired driving situation information. The assistance method generation unit 52A determines whether the driver executes the safety confirmation behavior corresponding to the driving situation based on the behavior-characteristics data included in the acquired driving-characteristics data.

The assistance method generation unit 52A further determines whether the driving-characteristics improving method needs to be changed based on the determination result and the emotion data. If it is determined that the driving-characteristics improving method needs to be changed, the assistance method generation unit 52A registers (stores) the acquired driving situation information in a driving situation database DB2, the acquired driving-characteristics data in a driving-characteristics database DB3, and the acquired improving effect data in an improving effect database DB4, in association with the user ID. The assistance method generation unit 52A determines whether the driving-characteristics of the driver are improved based on the acquired driving-characteristics and the driving-characteristics of the driver registered in the driving-characteristics database DB3. The assistance method generation unit 52A determines the driving-characteristics improving method to change to based on the determination result as to whether the driving-characteristics are improved and the acquired emotion data. The assistance method generation unit 52A generates and transmits to the vehicles C1A, . . . the improving effect data indicating the changed driving-characteristics improving method.

On the other hand, if it is determined that the driving-characteristics improving method does not need to be changed, the assistance method generation unit 52A omits the generation and the update of the new improving effect data, and registers (stores) the acquired driving situation information in the driving situation database DB2 and the acquired driving-characteristics data in the driving-characteristics database DB3 in association with the user ID.

The memory 53 includes, for example, a RAM as a work memory used when each process of the processor 52 is executed, and a ROM that stores a program and data that define an operation of the processor 52. The RAM temporarily stores data or information generated or acquired by the processor 52. The program that defines the operation of the processor 52 is written into the ROM. The memory 53 stores a driving-characteristics learning model 53A and an improving effect learning model 53B.

The database 54 records the user database DB1, the driving situation database DB2, the driving-characteristics database DB3, and the improving effect database DB4. Each of the user database DB1, the driving situation database DB2, the driving-characteristics database DB3, and the improving effect database DB4 records a set of data transmitted from each of the vehicles C1A, . . . (each of the user ID, the driving situation information, the driving-characteristics data corresponding to the driving situation, and the improving effect data corresponding to the driving situation information) in association. Each of the user database DB1, the driving situation database DB2, the driving-characteristics database DB3, and the improving effect database DB4 may store the information on the date and time of acquisition from each of the vehicles C1A, . . . in association, thereby enabling the association of the sets of data transmitted from each of the vehicles C1A, . . . .

The user database DB1 registers (stores) the user IDs of a plurality of drivers. The user ID may be a license ID.

The driving situation database DB2 registers (stores) the driving situation information acquired from each of the plurality of vehicles C1A, . . . for each user ID.

The driving-characteristics database DB3 registers (stores) the driving-characteristics data acquired from each of the plurality of vehicles C1A, . . . for each driving situation of the user ID.

The improving effect database DB4 registers (stores) the improving effect data generated by the assistance method generation unit 52A for each driving situation information on the user ID. When the changed driving improvement data is generated, the improving effect database DB4 may register (store) the changed driving improvement data. When the new improving effect data is generated by the vehicles C1A, . . . , the improving effect database DB4 updates the improving effect data associated with the driving situation information to the new improving effect data acquired from each of the plurality of vehicles C1A, . . . .

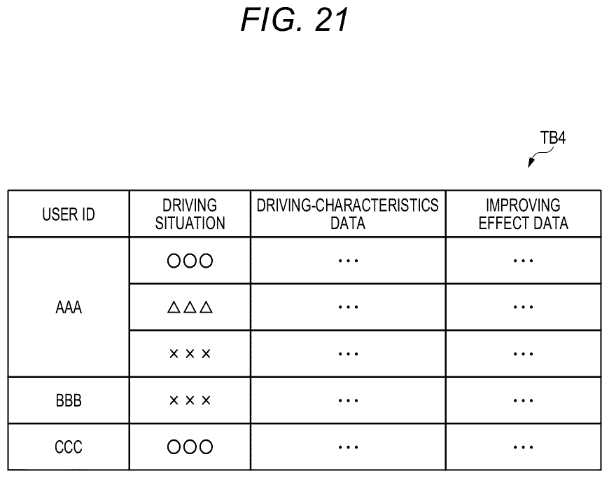

Next, a driving-characteristics improving management table TB4 recorded in each of the vehicles C1A, . . . will be described with reference to FIG. 21. FIG. 19 is a diagram illustrating an example of the driving-characteristics improving management table TB4. For ease of understanding, the following will describe the various data or information recorded in the database 54 (that is, each of the user database DB1, the driving situation database DB2, the driving-characteristics database DB3, and the improving effect database DB4) using the driving-characteristics improving management table TB4, but the driving-characteristics improving management table TB4 is not essential and may be omitted.

The driving-characteristics improving management table TB4 records and manages the driving-characteristics data corresponding to the driving situation and the improving effect data corresponding to the driving situation information for each user ID in association with the driving situation information. The user ID may be a license ID.

For example, the driving-characteristics improving management table TB4 illustrated in FIG. 21 records the driving-characteristics data and the improving effect data in association with the driving situation information “MMM”, the driving-characteristics data and the improving effect data in association with the driving situation information “NNN”, and the driving-characteristics data and the improving effect data in association with the driving situation information “OOO” of the user ID “AAA”. The driving-characteristics improving management table TB4 records the driving-characteristics data and the improving effect data in association with the driving situation information “OOO” of the user ID “BBB”, and the driving-characteristics data and the improving effect data in association with the driving situation information “NNN” of the user ID “CCC”.

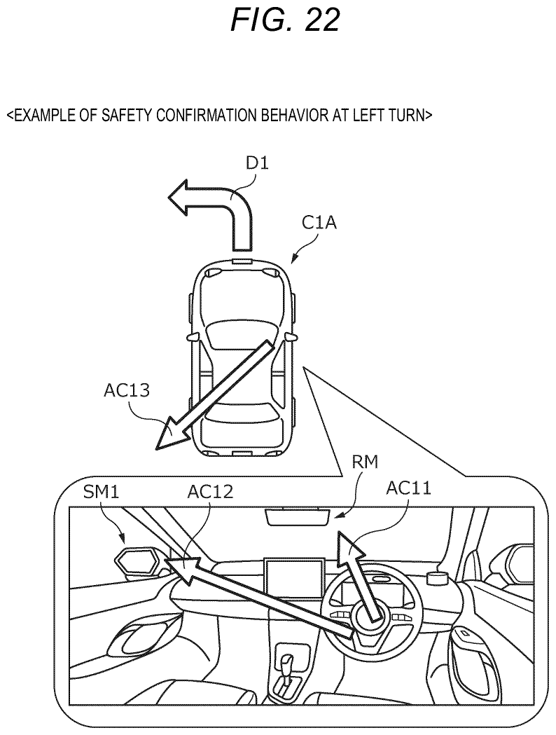

A specific example of the determination to be executed by the vehicles C1A, . . . or the driving-characteristics improving server S3 as to whether the safety confirmation behavior is executed will be described with reference to FIG. 22. FIG. 22 is a diagram illustrating an example of a safety confirmation behavior during left turn. The example of safety confirmation behavior illustrated in FIG. 22 is an example, and is not limited thereto as a matter of course. In addition, FIG. 22 describes an example in which the vehicle C1A executes the determination as to whether the safety confirmation behavior is executed, which is not limited thereto and may be executed by the processor 52 of the driving-characteristics improving server S3.

FIG. 22 is a diagram illustrating the vehicle C1A in the driving situation “left turn”, and is a diagram illustrating the vehicle C1A immediately before turning left in a traveling direction D1 and the state inside the vehicle C1A at that time. Each process executed by the terminal device 22 described below may be executed by the ECU 16A.

The terminal device 22 illustrated in FIG. 22 determines that the driving situation of the vehicle C1A is “left turn” using the driving situation data recorded in the driving-characteristics learning device 23 and the information acquired by the various sensors. For example, the terminal device 22 determines that the driving situation of the vehicle C1A is “left turn” using the driving situation data, the captured image obtained by imaging the surroundings of the vehicle C1A by the exterior sensor/camera 19A, the various information related to the driving operation of the driver acquired by the accelerator pedal 17A, the brake pedal 17B, the turn lamp 17C, or the steering wheel 17D, the destination information set in advance in the terminal device 22, the current position information on the vehicle C1A acquired by the GPS sensor 20 or the like, and the like.

The terminal device 22 refers to the improving effect data (that is, the driving-characteristics improving assistance method) associated with the user ID corresponding to the driver stored in the driving-characteristics history table TB3 and corresponding to the driving situation information “left turn” based on the determined driving situation information “left turn” on the vehicle C1A. The terminal device 22 generates a control command for controlling each of the speakers 25 and the warning display lamps 26 based on the referred improving effect data, and outputs the control command to each of the speakers 25 and the warning display lamps 26. If it is determined that the driving-characteristics improving assistance is unnecessary based on the referred improving effect data, the terminal device 22 omits the control of each of the speakers 25 and the warning display lamps 26 described above.

The terminal device 22 refers to information on one or more safety confirmation behaviors to be executed by the driver corresponding to the determined driving situation information “left turn” of the vehicle C1A. The terminal device 22 determines whether the driver executes the safety confirmation behavior corresponding to the driving situation information based on the information on the one or more safety confirmation behaviors and the behavior-characteristics data on the driver acquired by the various sensors. The example illustrated in FIG. 22 will be described with an example in which the vehicle C1A determines whether each of three safety confirmation behaviors corresponding to the driving situation information “left turn” is executed by the driver.

For example, the terminal device 22 controls the speakers 25 or the warning display lamps 26 to execute driving-characteristics improving assistance for prompting the driver to visually confirm the rear of the vehicle C1A through a room mirror RM, and determines whether the movement of the face or the line of sight of the driver faces a direction AC11 (that is, whether the driver visually confirms the rear of the vehicle C1A through the room mirror RM) based on the captured image output from the interior camera 13A (first determination).

The terminal device 22 controls the speakers 25 or the warning display lamps 26 to execute driving-characteristics improving assistance for prompting the driver to visually confirm the left side and the left rear of the vehicle C1A through the left side mirror SM1 corresponding to the traveling direction D1, and determines whether the movement of the face or the line of sight of the driver faces a direction AC12 (that is, whether the driver visually confirms the left side and the rear of the vehicle C1A through the left side mirror SM1 corresponding to the traveling direction D1) based on the captured image output from the interior camera 13A (second determination).

The terminal device 22 controls the speakers 25 or the warning display lamps 26 to execute driving-characteristics improving assistance for prompting the driver to visually confirm the rear of the vehicle C1A, and determines whether the movement of the body, the face, or the line of sight of the driver faces a direction AC13 (that is, whether the driver visually confirms the rear of the vehicle C1A) based on the captured image output from the interior camera 13A (third determination).

If the execution determination of each of two or more safety confirmation behaviors is to be performed and the determination order is set in advance for each of the safety confirmation behaviors, the terminal device 22 may perform the execution determination of each safety confirmation behavior and determine whether each safety confirmation behavior is executed in the set order.

The terminal device 22 analyzes the emotion of the driver based on the image captured by the interior camera 13A from the timing of starting the driving-characteristics improving assistance to the timing of ending the execution determination process of each of the three safety confirmation behaviors. The terminal device 22 generates the emotion data based on the analysis result. The terminal device 22 may generate the emotion data for each driving-characteristics improving assistance corresponding to each safety confirmation behavior, or may generate one piece of emotion data for the driving-characteristics improving assistance executed in the driving situation “left turn”.

The terminal device 22 generates, records in the memory 15A in association with the user ID, transmits to the driving-characteristics improving server S3, and records in the database 54: the driving-characteristics data, the driving situation information, the safety confirmation behavior data indicating the determination result of each of the three safety confirmation behaviors, and the emotion data corresponding to the driving-characteristics improving assistance, which are acquired from the timing of starting the determination of the driving situation to the timing of ending the execution determination of each of the three safety confirmation behaviors.

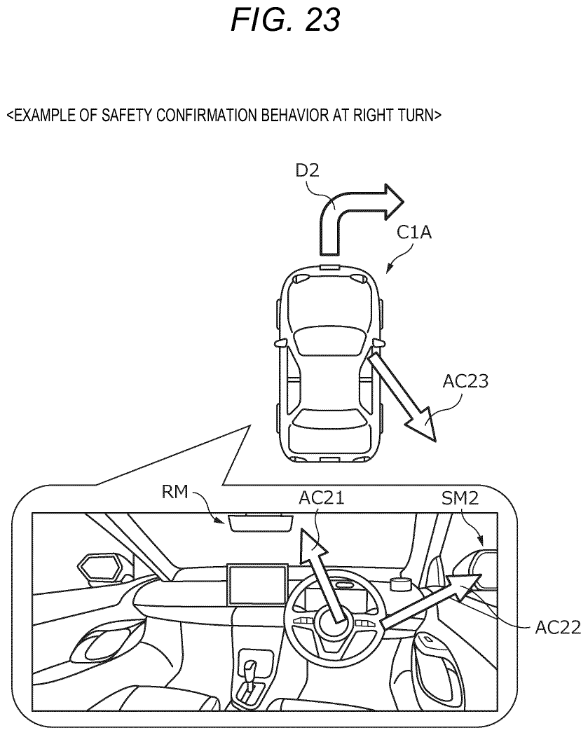

A specific example of the determination to be executed by the vehicles C1A, . . . or the driving-characteristics improving server S3 as to whether the safety confirmation behavior is executed will be described with reference to FIG. 23. FIG. 23 is a diagram for explaining an example of a safety confirmation behavior during right turn. The example of safety confirmation behavior illustrated in FIG. 23 is an example, and is not limited thereto as a matter of course. In addition, FIG. 23 describes an example in which the vehicle C1A executes the determination as to whether the safety confirmation behavior is executed, which is not limited thereto and may be executed by the processor 52 of the driving-characteristics improving server S3.

FIG. 23 is a diagram illustrating the vehicle C1A in the driving situation “right turn”, and is a diagram illustrating the vehicle C1A immediately before turning right in a traveling direction D2 and the state inside the vehicle C1A at that time.

The terminal device 22 illustrated in FIG. 23 determines that the driving situation of the vehicle C1A is “right turn” using the driving situation data recorded in the driving-characteristics learning device 23 and the information acquired by the various sensors.

The terminal device 22 refers to the improving effect data (that is, the driving-characteristics improving assistance method) associated with the user ID corresponding to the driver stored in the driving-characteristics history table TB3 and corresponding to the driving situation information “right turn” based on the determined driving situation information “right turn” on the vehicle C1A. The terminal device 22 generates a control command for controlling each of the speakers 25 and the warning display lamps 26 based on the referred improving effect data, and outputs the control command to each of the speakers 25 and the warning display lamps 26. If it is determined that the driving-characteristics improving assistance is unnecessary based on the referred improving effect data, the terminal device 22 omits the control of each of the speakers 25 and the warning display lamps 26 described above.

The terminal device 22 refers to information on one or more safety confirmation behaviors to be executed by the driver corresponding to the determined driving situation information “right turn” of the vehicle C1A. The terminal device 22 determines whether the driver executes the safety confirmation behavior corresponding to the driving situation information based on the information on the one or more safety confirmation behaviors and the behavior-characteristics data on the driver acquired by the various sensors. The example illustrated in FIG. 23 will be described with an example in which the vehicle C1A determines whether each of three safety confirmation behaviors corresponding to the driving situation information “right turn” is executed by the driver.

For example, the terminal device 22 controls the speakers 25 or the warning display lamps 26 to execute the driving-characteristics improving assistance for prompting the driver to visually confirm the rear of the vehicle C1A through the room mirror RM, and determines whether the movement of the face or the line of sight of the driver faces a direction AC21 (that is, whether the driver visually confirms the rear of the vehicle C1A through the room mirror RM) based on the captured image output from the interior camera 13A (first determination).

The terminal device 22 controls the speakers 25 or the warning display lamps 26 to execute driving-characteristics improving assistance for prompting the driver to visually confirm the right side and the right rear of the vehicle C1A through the right side mirror SM2 corresponding to the traveling direction D2, and determines whether the movement of the face or the line of sight of the driver faces a direction AC22 (that is, whether the driver visually confirms the right side and the rear of the vehicle C1A through the right side mirror SM2 corresponding to the traveling direction D2) based on the captured image output from the interior camera 13A (second determination).

The terminal device 22 controls the speakers 25 or the warning display lamps 26 to execute driving-characteristics improving assistance for prompting the driver to visually confirm the rear of the vehicle C1A, and determines whether the movement of the body, the face, or the line of sight of the driver faces a direction AC23 (that is, whether the driver visually confirms the rear of the vehicle C1A) based on the captured image output from the interior camera 13A (third determination). If the vehicle C1A is a vehicle having the driver seat on the right side (that is, right-hand steering vehicle) as illustrated in FIG. 23, the driver is shielded at the right side and the right rear of the vehicle C1A by the door of the driver seat. In such a case, the terminal device 22 may determine whether the driver visually confirms the rear of the vehicle C1A based on whether the head of the driver is directed 90° or more in a direction toward the right side of the vehicle C1A from the state of facing the traveling direction D2 based on the behavior-characteristics data on the driver.

The terminal device 22 analyzes the emotion of the driver based on the image captured by the interior camera 13A from the timing of starting the driving-characteristics improving assistance to the timing of ending the execution determination process of each of the three safety confirmation behaviors. The terminal device 22 generates the emotion data based on the analysis result. The terminal device 22 generates, records in the memory 15A in association with the user ID, transmits to the driving-characteristics improving server S3, and records in the database 54: the driving-characteristics data, the driving situation information, the safety confirmation behavior data indicating the determination result of each of the three safety confirmation behaviors, and the emotion data corresponding to the driving-characteristics improving assistance, which are acquired from the timing of starting the determination of the driving situation to the timing of ending the execution determination of each of the three safety confirmation behaviors.

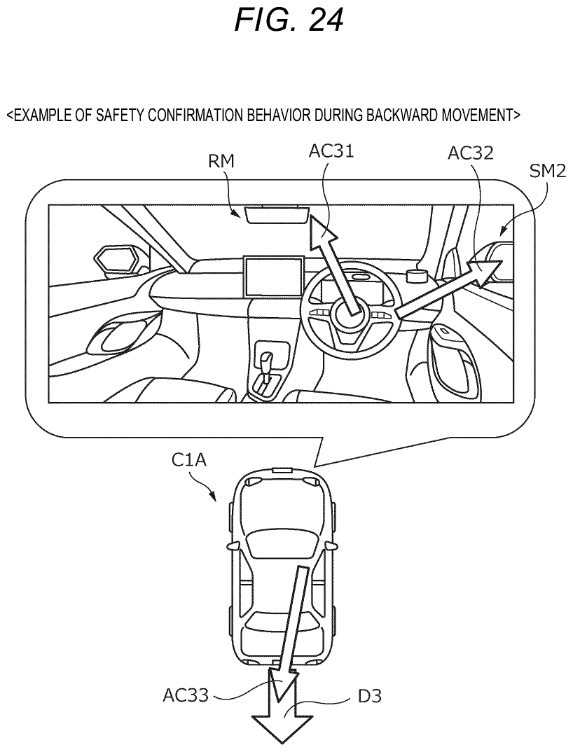

A specific example of the determination to be executed by the vehicles C1A, . . . or the driving-characteristics improving server S3 as to whether the safety confirmation behavior is executed will be described with reference to FIG. 24. FIG. 24 is a diagram illustrating an example of a safety confirmation behavior during backward movement. The example of safety confirmation behavior illustrated in FIG. 24 is an example, and is not limited thereto as a matter of course. In addition, FIG. 24 describes an example in which the vehicle C1A executes the determination as to whether the safety confirmation behavior is executed, which is not limited thereto and may be executed by the processor 52 of the driving-characteristics improving server S3.

FIG. 24 is a diagram illustrating the vehicle C1A in the driving situation “backward”, and is a diagram illustrating the vehicle C1A immediately before moving backward in a traveling direction D3 and the state inside the vehicle C1A at that time.

The terminal device 22 illustrated in FIG. 24 determines that the driving situation of the vehicle C1A is “backward” using the driving situation data recorded in the driving-characteristics learning device 23 and the information acquired by the various sensors.

The terminal device 22 refers to the improving effect data (that is, the driving-characteristics improving assistance method) associated with the user ID corresponding to the driver stored in the driving-characteristics history table TB3 and corresponding to the driving situation information “backward” based on the determined driving situation information “backward” on the vehicle C1A. The terminal device 22 generates a control command for controlling each of the speakers 25 and the warning display lamps 26 based on the referred improving effect data, and outputs the control command to each of the speakers 25 and the warning display lamps 26. If it is determined that the driving-characteristics improving assistance is unnecessary based on the referred improving effect data, the terminal device 22 omits the control of each of the speakers 25 and the warning display lamps 26 described above.

The terminal device 22 refers to information on one or more safety confirmation behaviors to be executed by the driver corresponding to the determined driving situation information “backward” on the vehicle C1A. The terminal device 22 determines whether the driver executes the safety confirmation behavior corresponding to the driving situation information based on the information on the one or more safety confirmation behaviors and the behavior-characteristics data on the driver acquired by the various sensors. The example illustrated in FIG. 24 will be described with an example in which the vehicle C1A determines whether each of three safety confirmation behaviors corresponding to the driving situation information “backward” is executed by the driver.

For example, the terminal device 22 controls the speakers 25 or the warning display lamps 26 to execute driving-characteristics improving assistance for prompting the driver to visually confirm the rear of the vehicle C1A through the room mirror RM, and determines whether the movement of the face or the line of sight of the driver faces a direction AC31 (that is, whether the driver visually confirms the rear of the vehicle C1A through the room mirror RM) based on the captured image output from the interior camera 13A (first determination).

The terminal device 22 controls the speakers 25 or the warning display lamps 26 to execute driving-characteristics improving assistance for prompting the driver to visually confirm the right side and the right rear of the vehicle C1A through the right side mirror SM2 corresponding to the traveling direction D3, and determines whether the movement of the face or the line of sight of the driver faces a direction AC32 (that is, whether the driver visually confirms the right side and the rear of the vehicle C1A through the right side mirror SM2 corresponding to the traveling direction D3) based on the captured image output from the interior camera 13A (second determination).

The terminal device 22 controls the speakers 25 or the warning display lamps 26 to execute driving-characteristics improving assistance for prompting the driver to visually confirm the rear of the vehicle C1A, and determines whether the movement of the body, the face, or the line of sight of the driver faces a direction AC33 (that is, whether the driver visually confirms the rear of the vehicle C1A) based on the captured image output from the interior camera 13A (third determination). If the seat belt wearing sensor, which is an example of the interior sensor 24, detects that the seat belt is released by the driver when confirming the rear, the terminal device 22 may determine whether the seat belt is worn again after confirming the rear, or may execute driving-characteristics improving assistance for prompting the driver to wear the seat belt again. The determination as to whether the driver has visually confirmed the rear may be performed based on an image captured by a back monitor for imaging the rear of the host vehicle (an example of the exterior sensor/camera 19A), or may be executed based on a surround view monitor (360° camera video, top view image, or the like), which is an image generated by viewing the host vehicle from above, based on a plurality of captured images acquired using the plurality of vehicle exterior sensors/cameras 19A.

The terminal device 22 analyzes the emotion of the driver based on the image captured by the interior camera 13A from the timing of starting the driving-characteristics improving assistance to the timing of ending the execution determination process of each of the three safety confirmation behaviors. The terminal device 22 generates the emotion data based on the analysis result. The terminal device 22 generates, records in the memory 15A in association with the user ID, transmits to the driving-characteristics improving server S3, and records in the database 54: the driving-characteristics data, the driving situation information, the safety confirmation behavior data indicating the determination result of each of the three safety confirmation behaviors, and the emotion data corresponding to the driving-characteristics improving assistance, which are acquired from the timing of starting the determination of the driving situation to the timing of ending the execution determination of each of the three safety confirmation behaviors.

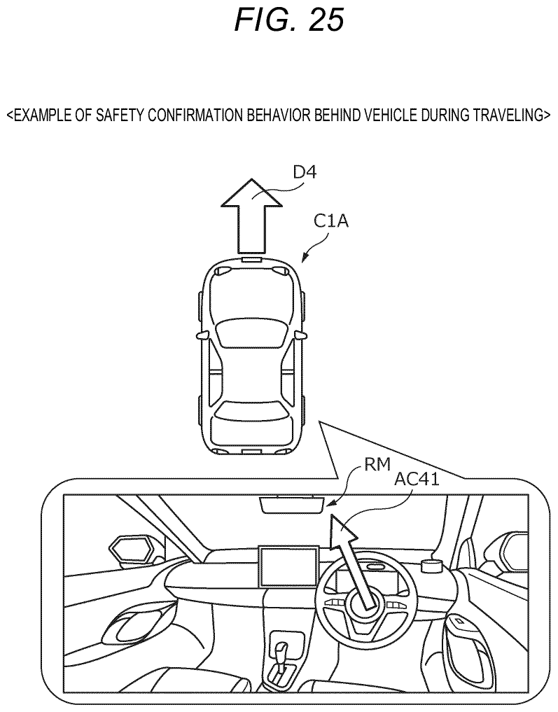

A specific example of the determination to be executed by the vehicles C1A, . . . or the driving-characteristics improving server S3 as to whether the safety confirmation behavior is executed will be described with reference to FIG. 25. FIG. 25 is a diagram illustrating an example of a safety confirmation behavior when moving forward on a straight long road. The example of safety confirmation behavior illustrated in FIG. 25 is an example, and is not limited thereto as a matter of course. In addition, FIG. 25 describes an example in which the vehicle C1A executes the determination as to whether the safety confirmation behavior is executed, which is not limited thereto and may be executed by the processor 52 of the driving-characteristics improving server S3.

FIG. 25 is a diagram illustrating the vehicle C1A in the driving situation “forward on straight long road”, and is a diagram illustrating the vehicle C1A moving forward in a traveling direction D4 and the state inside the vehicle C1A at that time.

The terminal device 22 illustrated in FIG. 25 determines that the driving situation of the vehicle C1A is “forward on straight long road” using the driving situation data recorded in the driving-characteristics learning device 23 and the information acquired by the various sensors.

The terminal device 22 refers to the improving effect data (that is, the driving-characteristics improving assistance method) associated with the user ID corresponding to the driver stored in the driving-characteristics history table TB3 and corresponding to the driving situation information “forward on straight long road” based on the determined driving situation information “forward on straight long road” on the vehicle C1A. The terminal device 22 generates a control command for controlling each of the speakers 25 and the warning display lamps 26 based on the referred improving effect data, and outputs the control command to each of the speakers 25 and the warning display lamps 26. If it is determined that the driving-characteristics improving assistance is unnecessary based on the referred improving effect data, the terminal device 22 omits the control of each of the speakers 25 and the warning display lamps 26 described above.

The terminal device 22 refers to information on one or more safety confirmation behaviors to be executed by the driver corresponding to the determined driving situation information “forward on straight long road” on the vehicle C1A. The terminal device 22 determines whether the driver executes the safety confirmation behavior corresponding to the driving situation information based on the information on the one or more safety confirmation behaviors and the behavior-characteristics data on the driver acquired by the various sensors. The example illustrated in FIG. 25 will be described with an example in which the vehicle C1A determines whether one safety confirmation behavior corresponding to the driving situation information “forward on straight long road” is executed by the driver.

For example, the terminal device 22 controls the speakers 25 or the warning display lamps 26 to execute driving-characteristics improving assistance for prompting the driver to visually confirm the rear of the vehicle C1A, and determines whether the movement of the body, the face, or the line of sight of the driver faces a direction AC41 (that is, whether the driver visually confirms the rear of the vehicle C1A) based on the captured image output from the interior camera 13A.

If one driving situation continues for a first predetermined time or a first travel distance or more as in the driving situation information “forward on straight long road” illustrated in FIG. 25, the determination of the safety confirmation behavior may be executed repeatedly and periodically (for example, every predetermined time or every predetermined distance).

The terminal device 22 analyzes the emotion of the driver based on the image captured by the interior camera 13A from the timing of starting the driving-characteristics improving assistance to the timing of ending the execution determination process of the safety confirmation behavior. The terminal device 22 generates the emotion data based on the analysis result. The terminal device 22 generates, records in the memory 15A in association with the user ID, transmits to the driving-characteristics improving server S3, and records in the database 54: the driving-characteristics data, the driving situation information, the safety confirmation behavior data indicating the determination result of each of the three safety confirmation behaviors, and the emotion data corresponding to the driving-characteristics improving assistance, which are acquired from the timing of starting the determination of the driving situation to the timing of ending the execution determination of the safety confirmation behavior.

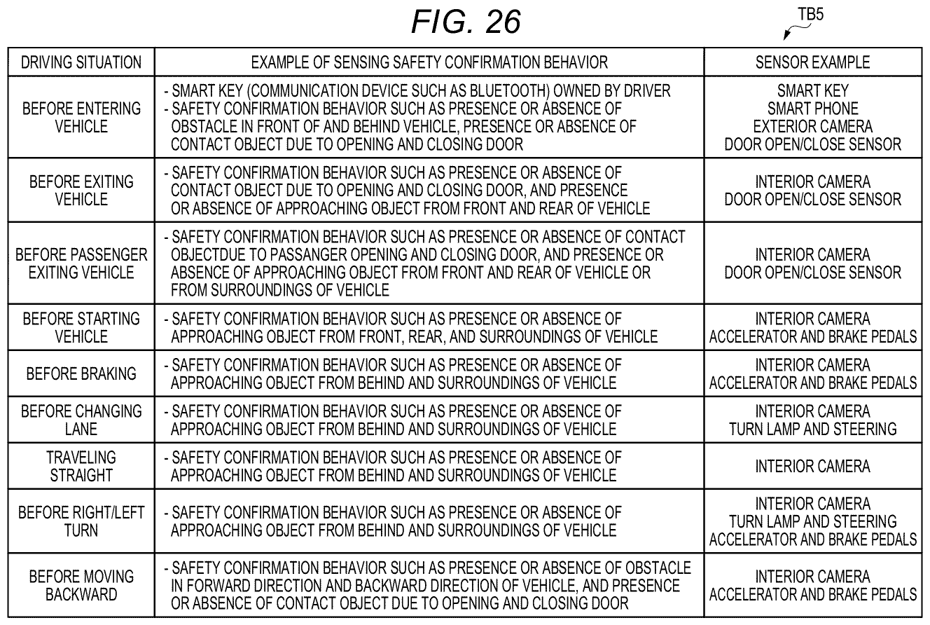

Next, an example of the safety confirmation behavior of the driver for each driving situation will be described with reference to FIG. 26. FIG. 26 is a diagram illustrating an example of sensing the safety confirmation behavior of the driver for each driving situation. The driving situation, the safety confirmation behavior, or the sensor example illustrated in FIG. 26 is merely an example, and is not limited thereto as a matter of course.

A safety confirmation behavior table TB5 illustrated in FIG. 26 is a table in which the driving situation information, the safety confirmation behavior that corresponds to the driving situation information and is to be executed by the driver, and a sensor example for sensing the safety confirmation behavior are associated with one another. The safety confirmation behavior table TB5 is a table for ease of understanding of an example the safety confirmation behavior of the driver sensed for each driving situation, and is not essential and may be omitted.

For example, in the safety confirmation behavior table TB5 illustrated in FIG. 26, if it is determined that radio waves transmitted from the smart key of the host vehicle or the smart phone carried by the driver are received by the interior sensor 24 through wireless communication such as Bluetooth (registered trademark) and the approach of the driver to the host vehicle is detected (sensed), the terminal device 22 determines that the driving situation is “before entering vehicle” based on the driving situation data recorded in the driving-characteristics learning device 23. If it is determined that the driving situation is “before entering vehicle”, the terminal device 22 determines whether the safety confirmation behavior is executed, such as visually confirming the presence or absence of an obstacle in the forward direction or the backward direction of the host vehicle (that is, in the front-rear direction of the host vehicle) by the exterior sensor/camera 19A and the presence or absence of a contact object depending on whether the door of at least one seat of the host vehicle is open or closed by the interior sensor 24 (for example, a door open/close sensor for detecting whether each door is open or closed).

If it is determined that the driving situation is “before exiting vehicle” based on the information acquired by the various sensors such as the interior camera 13A and the interior sensor 24 (door open/close sensor) and the driving situation data recorded in the driving-characteristics learning device 23, the terminal device 22 determines whether the safety confirmation behavior is executed, such as visually confirming the presence or absence of an obstacle in the forward direction or the backward direction of the host vehicle (that is, the front-rear direction of the host vehicle) by the interior camera 13A, the exterior sensor/camera 19A, the interior sensor 24 (door open/close sensor), or the like, the presence or absence of a contact object depending on whether the door of at least one seat of the host vehicle is open or closed by the interior sensor 24 (for example, the door open/close sensor for detecting whether each door is open or closed).

If it is determined that the driving situation is “before passenger exiting vehicle” based on the information acquired by the various sensors such as the interior camera 13A and the interior sensor 24 (door open/close sensor) and the driving situation data recorded in the driving-characteristics learning device 23, the terminal device 22 determines whether the safety confirmation behavior is executed, such as visually confirming the presence or absence of an obstacle in the forward direction or the backward direction of the host vehicle (that is, the front-rear direction of the host vehicle) by the interior camera 13A, the exterior sensor/camera 19A, the interior sensor 24 (door open/close sensor), or the like, the presence or absence of a contact object depending on whether the door of at least one seat of the host vehicle (for example, the seat of the passenger exiting the host vehicle) is open or closed by the interior sensor 24 (for example, the door open/close sensor for detecting whether each door is open or closed).

If it is determined that the driving situation is “before starting vehicle” based on the information acquired by the various sensors such as the interior camera 13A, the accelerator pedal 17A, and the brake pedal 17B and the driving situation data recorded in the driving-characteristics learning device 23, the terminal device 22 determines whether the safety confirmation behavior is executed, such as visually confirming the presence or absence of an approaching object (for example, a pedestrian, another vehicle, or a two-wheeler) in the forward direction or backward direction of the host vehicle (that is, the front-rear direction of the host vehicle) or from the surroundings of the host vehicle by the interior camera 13A, the exterior sensor/camera 19A, or the like.

If it is determined that the driving situation is “before braking” based on the information acquired by the various sensors such as the interior camera 13A, the accelerator pedal 17A, and the brake pedal 17B and the driving situation data recorded in the driving-characteristics learning device 23, the terminal device 22 determines whether the safety confirmation behavior is executed, such as visually confirming the presence or absence of an approaching object (for example, a pedestrian, another vehicle, or a two-wheeler) behind the host vehicle or from the surroundings of the host vehicle by the interior camera 13A, the exterior sensor/camera 19A, or the like.

If it is determined that the driving situation is “before changing lane” based on the information acquired by the various sensors such as the interior camera 13A, the turn lamp 17C, and the steering 17D and the driving situation data recorded in the driving-characteristics learning device 23, the terminal device 22 determines whether the safety confirmation behavior is executed, such as visually confirming the presence or absence of an approaching object (for example, a pedestrian, another vehicle, a two-wheeler, or the like) from the left rear or right rear of the host vehicle or from the surroundings of the host vehicle by the interior camera 13A, the exterior sensor/camera 19A, or the like.

If it is determined that the driving situation is “traveling straight” based on the information acquired by the various sensors such as the interior camera 13A and the driving situation data recorded in the driving-characteristics learning device 23, the terminal device 22 determines whether the safety confirmation behavior is executed, such as visually confirming the presence or absence of an approaching object (for example, a pedestrian, another vehicle, or a two-wheeler) behind the host vehicle or from the surroundings of the host vehicle by the interior camera 13A, the exterior sensor/camera 19A, or the like.

If it is determined that the driving situation is “before right/left turn” based on the information acquired by the various sensors such as the interior camera 13A, the accelerator pedal 17A, the brake pedal 17B, the turn lamp 17C and the steering 17D and the driving situation data recorded in the driving-characteristics learning device 23, the terminal device 22 determines whether the safety confirmation behavior is executed, such as visually confirming the presence or absence of an approaching object (for example, a pedestrian, another vehicle, or a two-wheeler) behind the host vehicle or from the surroundings of the host vehicle by the interior camera 13A, the exterior sensor/camera 19A, or the like.

If it is determined that the driving situation is “before moving backward” based on the information acquired by the various sensors such as the interior camera 13A, the accelerator pedal 17A, and the brake pedal 17B and the driving situation data recorded in the driving-characteristics learning device 23, the terminal device 22 determines whether the safety confirmation behavior is executed, such as visually confirming the presence or absence of an obstacle in the forward direction or backward direction of the host vehicle (that is, the front-rear direction of the host vehicle) and the presence or absence of a contact object depending on whether the door of at least one seat of the host vehicle (for example, a seat of a passenger who exits the host vehicle) is open or closed by the interior camera 13A, the exterior sensor/camera 19A, the interior sensor 24 (door open/close sensor), or the like.

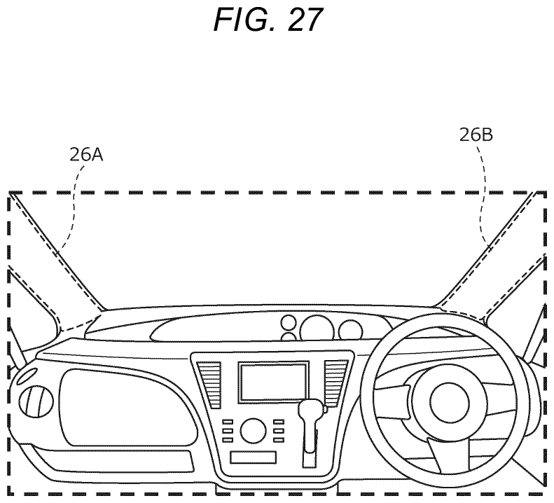

Next, the warning display lamps 26 mounted on the vehicles C1A, . . . will be described with reference to FIG. 27. FIG. 27 is a diagram illustrating an arrangement example of warning display lamps 26A and 26B.

The arrangement positions of the two warning display lamps 26A and 26B illustrated in FIG. 27 are merely an example, and are not limited thereto as a matter of course. In the example illustrated in FIG. 27, the two warning display lamps 26A and 26B are mounted, but the number of warning display lamps mounted in each of the vehicles C1A, . . . may be three or more.

For example, the warning display lamps 26 may be provided in any one of B pillars, C pillars, D pillars, or the like of the vehicles C1A, . . . . The B pillars referred to here are a pair of pillars provided at the vehicle body central portion of the vehicle C1A between the driver seat, the front passenger seat and the second seat. The C pillars are a pair of pillars provided between the second seat and the third seat at the vehicle body central portion provided at the vehicle body rear portion of the vehicles C1A, . . . . The D pillars are a pair of pillars provided behind the second seat or the third seat and at the vehicle body rear portion of the vehicle C1A.

Each of the warning display lamps 26A, 26B illustrated in FIG. 27 is an LED provided on each of the pair of front pillars (A pillars) provided on both sides of the windshield of each of the vehicles C1A, . . . . Each of the warning display lamps 26A and 26B is lighted, blinked, or turned off in a predetermined color (for example, yellow, orange, red, or the like) based on a control command from the terminal device 22 or the ECU 16A.

The terminal device 22 may light or blink the warning display lamps 26 in different colors based on the degree of risk (score) of the driving situation or the driving-characteristics (driving skill, frequency of safety confirmation behavior, and the like) of the driver. For example, the terminal device 22 may blink the warning display lamps 26 in red if it is determined that the degree of risk of the driving situation is high, or may blink the warning display lamps 26 in orange at a longer interval if it is determined that the degree of risk of the driving situation is not high.

For example, to assist the visual confirmation of the rear of the vehicles C1A, . . . reflected on the left side mirror SM1 of the driver, the terminal device 22 executes the driving-characteristics improving assistance for lighting or blinking the warning display lamp 26B positioned on the left. To assist the visual confirmation of the rear of the vehicles C1A, . . . reflected on the right side mirror SM2 of the driver, the terminal device 22 executes the driving-characteristics improving assistance for lighting or blinking the warning display lamp 26B positioned on the right. Accordingly, the terminal device 22 can guide the line of sight of the driver to the left side mirror SM1 (that is, the left) or the right side mirror SM2 (that is, the right) corresponding to the driving situation by lighting or blinking the warning display lamp 26B.

For example, if a pedestrian, another vehicle, a two-wheeler, or the like is detected on the left or right of the vehicle C1A, the terminal device 22 executes the driving-characteristics improving assistance for prompting the driver to visually confirm the right of the vehicle C1A. Specifically, the terminal device 22 executes the driving-characteristics improving assistance for lighting or blinking the warning display lamp 26A or 26B arranged on the left or right where a pedestrian, another vehicle, a two-wheeler, or the like is detected in a predetermined color.

For example, the terminal device 22 calculates the distance between the host vehicle and the detected pedestrian, other vehicle, two-wheeler, or the like, the approaching speed between the host vehicle and the pedestrian, other vehicle, two-wheeler, or the like approaching the host vehicle, or the like. The terminal device 22 determines the degree of risk of the driving situation based on the calculated distance, approaching speed, or the like, and determines the color, blinking pattern, blinking speed, and the like of the warning display lamp 26A or the warning display lamp 26B according to the degree of risk of the driving situation.

Specifically, based on the calculated distance or distance and approaching speed, the terminal device 22 blinks the warning display lamp 26A or the warning display lamp 26B in orange if it is determined that a driving operation such as deceleration or stop of the host vehicle is unnecessary, and blinks the warning display lamp 26A or the warning display lamp 26B in red at a shorter interval if it is determined that a driving operation such as deceleration or stop of the host vehicle is not unnecessary. Accordingly, the driver can intuitively grasp the importance of the safety confirmation behavior at a glance based on the color, blinking pattern, blinking speed, and the like of the warning display lamp 26A or the warning display lamp 26B.

Next, the speakers 25 mounted on the vehicles C1A, . . . will be described with reference to FIG. 28. FIG. 28 is a diagram illustrating an arrangement example of the speakers 25.

In the example illustrated in FIG. 28, regarding the speakers 25, four speakers 25A, 25B, 25C, and 25D are mounted inside the vehicles C1A, . . . . The speaker 25A is mounted on a dashboard DSB of each of the vehicles C1A, . . . and near the left A pillar or the left side mirror SM1. The speaker 25B is mounted on the dashboard DSB of each of the vehicles C1A, . . . and near the right A pillar or the right side mirror SM2. The speaker 25C is mounted near the left rear seat or the left C pillar (not illustrated) of the vehicles C1A, . . . . The speaker 25D is mounted near the right rear seat or the right C pillar (not illustrated) of the vehicles C1A, . . . . The arrangement positions of the four speakers 25A, 25B, 25C, and 25D illustrated in FIG. 28 are merely an example, and are not limited thereto as a matter of course.

If the various sensors detect an approaching object (for example, a pedestrian, another vehicle, a two-wheeler, or the like) approaching the host vehicle, an obstacle around the host vehicle, or the like, the terminal device 22 outputs a voice indicating the detection of the approaching object or obstacle to a speaker at a position corresponding to the detected approaching object or obstacle among the four speakers 25A to 25D.

For example, in a driving situation “lane change” in which the host vehicle changes from the currently traveling lane to the lane on the right of the traveling direction, the terminal device 22 detects another vehicle approaching from the right rear of the host vehicle by the various sensors such as the interior camera 13A and the exterior sensor/camera 19A. In such a case, the terminal device 22 executes the driving-characteristics improving assistance by outputting a voice from the speaker 25D arranged in the direction in which the other vehicle is detected (here, the right rear), and prompts the driver to confirm the safety on the right rear.

For example, in the driving situation “left turn”, the terminal device 22 detects the approach of a pedestrian from the front in the traveling direction of the host vehicle by the various sensors such as the interior camera 13A and the exterior sensor/camera 19A. In such a case, the terminal device 22 executes the driving-characteristics improving assistance by outputting a voice from the speaker 25B arranged in the direction in which the pedestrian is detected (here, the front left), and prompts the driver to confirm the safety on the front left.

For example, if it is determined that it is necessary to visually confirm the rear of the host vehicle by the various sensors such as the interior camera 13A and the exterior sensor/camera 19A, the terminal device 22 executes the driving-characteristics improving assistance by outputting a voice from each of the two speakers 25C and 25D arranged on the rear of the host vehicle, and prompts the driver to confirm the safety on the rear.

The terminal device 22 may analyze the approaching object or obstacle detected by the various sensors such as the interior camera 13A and the exterior sensor/camera 19A, and output a voice corresponding to the type of the detected approaching object or obstacle (for example, a pedestrian, another vehicle, a two-wheeler, or the like) to each of the speakers 25A to 25D. For example, the terminal device 22 executes the driving-characteristics improving assistance by causing each of the speakers 25A to 25D to output a voice such as “a pedestrian is approaching from the sidewalk” if the approach of a pedestrian from the sidewalk is detected, or “a bicycle is approaching from the rear” if the approach of a bicycle (two-wheeler) from the rear is detected.

Next, a modification of the driving-characteristics improving assistance method indicated by the improving effect data will be described with reference to FIG. 29. FIG. 29 is a diagram illustrating a modification of driving-characteristics improving assistance. The example of the driving-characteristics improving assistance method and the modification of the driving-characteristics improving assistance illustrated in FIG. 29 are merely examples and are not limited thereto.

The driving-characteristics improving server S3 calculates the previous frequency of the safety confirmation behavior of the driver based on the driving-characteristics data (specifically, the behavior-characteristics data) in the driving situation associated with the user ID of the driver and the latest frequency of the safety confirmation behavior of the driver based on the driving-characteristics data (specifically, the behavior-characteristics data) in the driving situation acquired from the vehicles C1A, . . . , and determines the change in the frequency of the safety confirmation behavior of the driver before and after the driving-characteristics improving assistance executed based on the improving effect data corresponding to the driving situation information.

Specifically, the driving-characteristics improving server S3 determines whether the safety confirmation behavior of the driver in this driving situation increases (that is, whether the driving-characteristics are improved) based on the previous frequency of the safety confirmation behavior and the latest frequency of the safety confirmation behavior. The driving-characteristics improving server S3 generates and updates the new improving effect data corresponding to the driving situation information based on the acquired emotion data and the determination result as to whether the frequency of the safety confirmation behavior increases (that is, whether the driving-characteristics are improved). The driving-characteristics improving server S3 transmits the generated improving effect data to the vehicles C1A, . . . . The driving-characteristics improving server S3 may generate the improving effect data periodically (for example, every one day, one week, one month, or the like).

If it is determined that the acquired emotion data on the driver indicates “pleased”, which is a positive emotion, and the frequency of the safety confirmation behavior after the driving-characteristics improving assistance increases (that is, the driving-characteristics are improved), the driving-characteristics improving server S3 determines that the driving-characteristics of the driver are improved and the driving-characteristics improving assistance method (that is, the control method of the speakers 25 or the warning display lamps 26) indicated by the improving effect data corresponding to the driving-characteristics information is more effective. In such a case, the driving-characteristics improving server S3 generates the improving effect data corresponding to the driving situation information as new improving effect data on another driving situation information, and registers (updates) the improving effect data in the improving effect database DB4 in association with the other driving situation information.

On the other hand, if it is determined that the acquired emotion data on the driver indicates “pleased”, which is a positive emotion, and the frequency of the safety confirmation behavior after the driving-characteristics improving assistance does not increase (that is, the driving-characteristics are not improved), the driving-characteristics improving server S3 determines that although the driving-characteristics of the driver are not improved, the driving-characteristics improving assistance method (that is, the control method of the speakers 25 or the warning display lamps 26) indicated by the improving effect data corresponding to the driving-characteristics information is effective. In such a case, the driving-characteristics improving server S3 generates new improving effect data by increasing the frequency of the driving-characteristics improving assistance indicated by the improving effect data corresponding to the driving situation information, and registers (updates) the new improving effect data in the improving effect database DB4.

In addition, if it is determined that the acquired emotion data on the driver indicates “unpleased”, which is a negative emotion, and the frequency of the safety confirmation behavior after the driving-characteristics improving assistance increases (that is, the driving-characteristics are improved), the driving-characteristics improving server S3 determines that the driving-characteristics of the driver are improved, but it is necessary to change the currently set driving-characteristics improving assistance method (that is, the control method of the speakers 25 or the warning display lamps 26). In such a case, the driving-characteristics improving server S3 generates effect improvement data different from the improving effect data corresponding to the driving situation information, registers (updates) the effect improvement data as new improving effect data on the driving situation information in the improving effect database DB4, and as new improving effect data on another driving situation information in the improving effect database DB4.

On the other hand, if it is determined that the acquired emotion data on the driver indicates “pleased”, which is a positive emotion, and the frequency of the safety confirmation behavior after the driving-characteristics improving assistance does not increase (that is, the driving-characteristics are not improved), the driving-characteristics improving server S3 determines that the driving-characteristics of the driver are not improved and the currently set driving-characteristics improving assistance method (that is, the control method of the speakers 25 or the warning display lamps 26) is not effective. In such a case, the driving-characteristics improving server S3 generates effect improvement data different from the improving effect data corresponding to the driving situation information, and registers (updates) the effect improvement data as new improving effect data on the driving situation information in the improving effect database DB4.

For example, the driving-characteristics improving server S3 generates new improving effect data for executing the safety confirmation behavior using either the speakers 25 or the warning display lamps 26 if the current improving effect data is an assistance method for executing the safety confirmation behavior using the speakers 25 and the warning display lamps 26, or generates new improving effect data for executing the safety confirmation behavior using the speakers 25 if the current improving effect data is an assistance method for executing the safety confirmation behavior using the warning display lamps 26.

As described above, the driving-characteristics improving server S3 according to Embodiment 2 can set a driving-characteristics improving assistance method more suitable for the driver based on the improvement state of the driving-characteristics corresponding to the frequency of the safety confirmation behavior of the driver and the reaction of the driver (emotion data) for the driving-characteristics improving assistance.

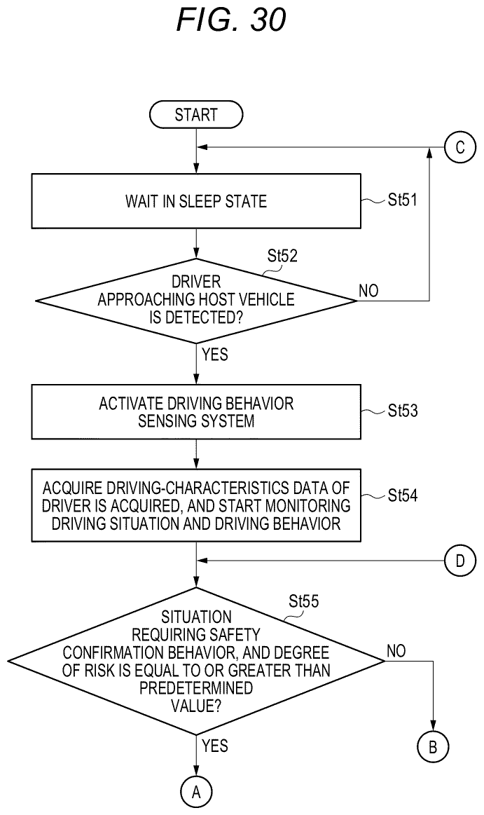

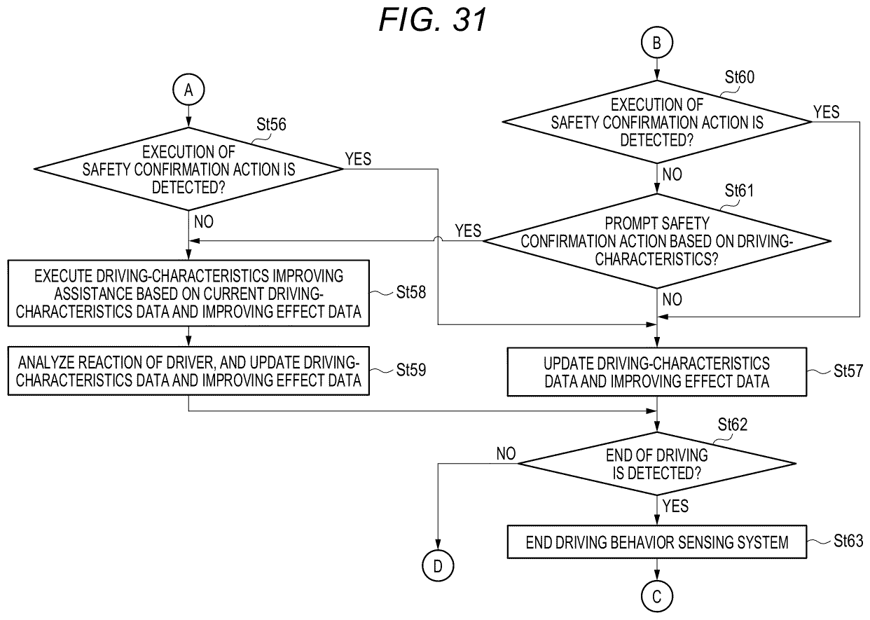

Next, the operation procedure of the driving-characteristics improving assistance system 200 according to Embodiment 2 will be described with reference to FIGS. 30 and 31. FIG. 30 is a flowchart illustrating an example of the operation procedure of the driving-characteristics improving assistance system 200 according to Embodiment 2. FIG. 31 is a flowchart illustrating an example of the operation procedure of the driving-characteristics improving assistance system 200 according to Embodiment 2.

Each of the vehicles C1A, . . . in the driving-characteristics improving assistance system 200 waits in a sleep state (St51). Each of the vehicles C1A, . . . determines whether the interior sensor 24 detects the driver approaching the host vehicle (St52). For example, if it is determined that radio waves transmitted by the smart key, smart phone, or the like carried by the driver are detected, each of the vehicles C1A, . . . determines that the driver approaching the host vehicle is detected.

If it is determined in the process of step St52 that the interior sensor 24 detects the driver approaching the host vehicle (St52, YES), each of the vehicles C1A, . . . starts a sensing system for the driving behavior of the driver (for example, the various sensors) to start sensing the driving-characteristics and the behavior-characteristics (that is, driving-characteristics data) of the driver (St53).

On the other hand, if it is determined in the process of step St52 that the interior sensor 24 does not detected the driver approaching the host vehicle (St52, NO), each of the vehicles C1A, . . . proceeds to the process of step St51 and waits in the sleep state (St51).

Each of the vehicles C1A, . . . acquires driving-characteristics data on the driver by the various sensors, and starts monitoring the driving behavior in the current driving situation (St54). Each of the vehicles C1A, . . . determines whether the current driving situation is a driving situation that requires the safety confirmation behavior is necessary and the degree of risk (score) of the current driving situation is equal to or greater than a predetermined value (St55).

If it is determined in the process of step St55 that the current driving situation is a driving situation that requires the safety confirmation behavior and the degree of risk (score) of the current driving situation is equal to or greater than the predetermined value (St55, YES), each of the vehicles C1A, . . . determines whether the execution of the safety confirmation behavior by the driver is detected based on the acquired driving-characteristics data (specifically, the behavior-characteristics data) (St56). Here, a plurality of safety confirmation behaviors may correspond to the driving situation. If a plurality of safety confirmation behaviors correspond to the driving situation and the order of execution is determined, each of the vehicles C1A, . . . may determine whether the safety confirmation behaviors are executed in the determined order.

If it is determined in the process of step St56 that the execution of the safety confirmation behavior by the driver is detected based on the acquired driving-characteristics data (specifically, the behavior-characteristics data) (St56, YES), each of the vehicles C1A, . . . transmits to the driving-characteristics improving server S3 and stores in the memory 15A the acquired driving-characteristics data in association with the driving situation information, the emotion data for the driving-characteristics improving assistance corresponding to the driving situation information, and the user ID. Each of the vehicles C1A, . . . acquires the new improving effect data transmitted from the driving-characteristics improving server S3, and updates (changes) the current improving effect data on the driving situation information to the acquired new improving effect data (St57).

On the other hand, if it is determined in the process of step St56 that the execution of the safety confirmation behavior by the driver is not detected based on the acquired driving-characteristics data (specifically, the behavior-characteristics data) (St56, NO), each of the vehicles C1A, . . . executes the driving-characteristics improving assistance based on the current driving-characteristics data (that is, the driving skill) on the driver and the improving effect data corresponding to the driving situation information (St58).

Each of the vehicles C1A, . . . performs image analysis on the image captured by the interior camera 13A, and analyzes a reaction of the driver (emotion data) to the executed driving-characteristics improving assistance and the behavior-characteristics data on the driver. Each of the vehicles C1A, . . . accumulates and stores the driving-characteristics data including the acquired behavior-characteristics data in the memory 15A. Each of the vehicles C1A, . . . transmits the driving situation information, the emotion data on the driver for the driving-characteristics improving assistance, the driving-characteristics data, and the user ID to the driving-characteristics improving server S3 in association. Each of the vehicles C1A, . . . acquires the new improving effect data transmitted from the driving-characteristics improving server S3, and updates (changes) the current improving effect data on the driving situation information to the acquired new improving effect data (St59).

On the other hand, if it is determined in the process of step St55 that the current driving situation is a driving situation that requires the safety confirmation behavior and the degree of risk (score) of the current driving situation is not equal to or greater than the predetermined value (St55, NO), each of the vehicles C1A, . . . determines whether the execution of the safety confirmation behavior by the driver is detected based on the acquired driving-characteristics data (specifically, the behavior-characteristics data) (St60).

If it is determined in the process of step St60 that the execution of the safety confirmation behavior by the driver is detected based on the acquired driving-characteristics data (specifically, the behavior-characteristics data) (St60, YES), each of the vehicles C1A, . . . transmits to the driving-characteristics improving server S3 and stores in the memory 15A the acquired driving-characteristics data in association with the driving situation information, the emotion data on the driver for the driving-characteristics improving assistance, and the user ID. Each of the vehicles C1A, . . . acquires the new improving effect data transmitted from the driving-characteristics improving server S3, and updates (changes) the current improving effect data on the driving situation information to the acquired new improving effect data (St57).

On the other hand, if it is determined in the process of step St60 that the execution of the safety confirmation behavior by the driver is not detected based on the acquired driving-characteristics data (specifically, the behavior-characteristics data) (St60, NO), each of the vehicles C1A, . . . determines whether to execute the driving-characteristics improving assistance and prompt the safety confirmation behavior corresponding to the driving situation based on the current driving-characteristics of the driver (that is, the latest frequency of the safety confirmation behavior in the current driving situation) (St61).

Specifically, in the process of step St61, each of the vehicles C1A, . . . calculates the latest frequency of the safety confirmation behavior in the current driving situation indicated by the current driving-characteristics. Each of the vehicles C1A, . . . determines whether the calculated latest frequency of the safety confirmation behavior is equal to or greater than a threshold related to the frequency of the safety confirmation behavior set corresponding to the degree of risk (score) of the current driving situation.

For example, if the driving situation is “traveling on straight road” and the degree of risk (score) corresponding to the driving situation is “low”, the threshold related to the frequency of the safety confirmation behavior is set to ¼. In such a case, each of the vehicles C1A, . . . determines whether the latest frequency of the safety confirmation behavior of the driver in the driving situation “traveling on straight road” is ¼ or more.

For example, if the driving situation is “lane change” and the degree of risk (score) corresponding to the driving situation is “high”, the threshold related to the frequency of the safety confirmation behavior is set to ½. In such a case, each of the vehicles C1A, . . . determines whether the latest frequency of the safety confirmation behavior of the driver in the driving situation “lane change” is ½ or more.

If it is determined in the process of step St61 to execute the driving-characteristics improving assistance and prompt the safety confirmation behavior corresponding to the driving situation based on the current driving-characteristics of the driver (St61, YES), each of the vehicles C1A, . . . executes the driving-characteristics improving assistance based on the current driving-characteristics data (that is, the driving skill) on the driver and the improving effect data corresponding to the driving situation information (St58). Specifically, if it is determined that the calculated latest frequency of the safety confirmation behavior is not equal to or greater than the threshold related to the frequency of the safety confirmation behavior set in correspondence with the degree of risk (score) of the current driving situation, each of the vehicles C1A, . . . determines to execute the driving-characteristics improving assistance and prompt the safety confirmation behavior corresponding to the driving situation (St61, YES).

On the other hand, if it is determined in the process of step St61 not to execute the driving-characteristics improving assistance and prompt the safety confirmation behavior corresponding to the driving situation based on the current driving-characteristics of the driver (St61, NO), each of the vehicles C1A, . . . transmits to the driving-characteristics improving server S3 and stores in the memory 15A the acquired driving-characteristics data in association with the driving situation information, the emotion data on the driver for the driving-characteristics improving assistance, and the user ID. Each of the vehicles C1A, . . . acquires the new improving effect data transmitted from the driving-characteristics improving server S3, and updates (changes) the current improving effect data on the driving situation information to the acquired new improving effect data (St57). Specifically, if it is determined that the calculated latest frequency of the safety confirmation behavior is equal to or greater than the threshold related to the frequency of the safety confirmation behavior set in correspondence with the degree of risk (score) of the current driving situation, each of the vehicles C1A, . . . determines not to execute the driving-characteristics improving assistance and prompt the safety confirmation behavior corresponding to the driving situation (St61, NO).

Each of the vehicles C1A, . . . determines whether the end of driving by the driver is detected (St). The end of driving referred to here may be when the driver exits the vehicle and leaves the host vehicle by a predetermined distance or more.

If it is determined in the process of step St62 that the end of driving by the driver is detected (St62, YES), each of the vehicles C1A, . . . ends the driving behavior sensing system (St63), and enters the sleep state and waits again (St51).

On the other hand, if each of the vehicles C1A, . . . determines in the process of step St62 that the end of driving performed by the driver is not detected (St62, NO), the process proceeds to the process of step St55, and each of the vehicles C1A, . . . determines again whether the current driving situation is a driving situation that requires the safety confirmation behavior and the degree of risk (score) of the current driving situation is equal to or greater than the predetermined value (St55).

As described above, each of the vehicles C1A, . . . in Embodiment 2 assists the safety confirmation behavior of the driver based on the driving situation and the driver's driving-characteristics (driving skills), thereby assisting to improve the driving-characteristics (driving skills) of the driver. The driving-characteristics improving server S3 according to Embodiment 2 can determine a driving-characteristics improving assistance method (improving effect data) more suitable for the driver based on the driving situation, the driving-characteristics (driving skill) of the driver, and the reaction of the driver (emotion data) for the driving-characteristics improving assistance. Accordingly, each of the vehicles C1A, . . . can assist to improve the driving-characteristics (driving skills) of the driver by assisting a safety confirmation behavior more suitable for the driver by the driving-characteristics improving assistance method based on the improving effect data generated by the driving-characteristics improving server S3.

As described above, the driving-characteristics improving server S3 according to Embodiment 2 is one or more computers that can communicate with the at least one of the vehicles C1A, . . . . The management method for driving-characteristics improving assistance data executed by the driving-characteristics improving server S3 is a management method for driving-characteristics improving effect data executed by one or more computers capable of communicating with at least one of the vehicles C1A, . . . , including: registering a plurality of pieces of driving situation information indicating the driving situations of the vehicle C1A, . . . , improving effect data (an example of assistance data) corresponding to the driving situation information for assisting to improve the safety confirmation behavior of the driver who drives the vehicle C1A, . . . , and driving-characteristics data on the driver in the driving situation information in association with each user ID (an example of a driver ID) of the plurality of drivers; transmitting the driving situation information to the vehicle C1A, . . . in association with the improving effect data; acquiring the user ID of the driver who drives the vehicle C1A, . . . , the driving-characteristics data on the driver corresponding to the driving situation information, and the emotion data on the driver for assistance based on the improving effect data; comparing the user ID of each of the plurality of drivers with the acquired user ID; generating new improving effect data corresponding to the acquired driving situation information based on the driving-characteristics data associated with a matching user ID and the acquired driving-characteristics data and emotion data; and updating the improving effect data associated with driving situation information the same as the acquired driving situation information among the plurality of pieces of driving situation information associated with the matching user ID to the generated new improving effect data. The computer referred to here includes at least the driving-characteristics improving server S3.

Accordingly, the driving-characteristics improving server S3 according to Embodiment 2 can acquire the driving situation information, the driving-characteristics of the driver, and the emotion data on the driver for the driving-characteristics improving assistance (an example of assistance of the safety confirmation behavior) indicated by the improving effect data as the driving-characteristics improving assistance result using the improving effect data transmitted in advance to each of the vehicles C1A, . . . . The driving-characteristics improving server S3 can generate new improving effect data based on the acquired current state of the driver (that is, the driving-characteristics (driving skill) and emotion of the driver), and associate the generated new improving effect data with the driving situation information used for generating the new improving effect data, the driving-characteristics data, and the emotion data with the user ID, thereby more efficiently managing the improving effect data for each user ID.

Further, the driving-characteristics improving server S3 according to Embodiment 2 determines whether the driving-characteristics of the driver in the driving situation are improved using the acquired driving-characteristics data and the registered driving-characteristics data, and generates the new improving effect data based on the emotion data and the determination result as to whether the driving-characteristics are improved. Accordingly, the driving-characteristics improving server S3 according to Embodiment 2 can generate improving effect data more suitable for the current state of the driver (that is, the driving-characteristics (driving skills) and the emotion of the driver).

If it is determined that the emotion data is positive and the driving-characteristics are improved, the driving-characteristics improving server S3 according to Embodiment 2 updates the improving effect data associated with the plurality of pieces of driving situation information associated with the matching user ID to the generated new improving effect data. Accordingly, the driving-characteristics improving server S3 according to Embodiment 2 can generate and update the improving effect data (that is, the driving-characteristics improving assistance method) determined as improving the driving-characteristics of the driver and felt pleased (that is, positive) by the driver as new improving effect data for another driving situation while continuing in the current driving situation, thereby more efficiently managing improving effect data indicating a driving-characteristics improving assistance method more suitable for the driver.

If it is determined that the emotion data is positive and the driving-characteristics are not improved, the driving-characteristics improving server S3 according to Embodiment 2 generates new improving effect data at a frequency of assistance increased relative to the improving effect data corresponding to the acquired driving situation information, and updates the improving effect data associated with the driving situation information the same as the acquired driving situation information to the generated new improving effect data. Accordingly, the driving-characteristics improving server S3 according to Embodiment 2 can generate and update new improving effect data (that is, driving-characteristics improving assistance method) at a frequency of assistance increased relative to the improving effect data felt pleased (that is, positive) by the driver, thereby more efficiently managing improving effect data indicating a driving-characteristics improving assistance method more suitable for the driver.

If it is determined that the emotion data is negative and the driving-characteristics are improved, the driving-characteristics improving server S3 according to Embodiment 2 generates the new improving effect data different from the improving effect data corresponding to the acquired driving situation information, updates the improving effect data associated with other driving situation information different from the acquired driving situation information to the generated new improving effect data, and omits the change of the improving effect data associated with the driving situation information the same as the acquired driving situation information. Accordingly, the driving-characteristics improving server S3 according to Embodiment 2 can generate and update the improving effect data (that is, the driving-characteristics improving assistance method) determined as improving the driving-characteristics of the driver and felt unpleased (that is, negative) by the driver as new improving effect data in the same driving situation, and can generate and update improving effect data different from the improving effect data felt unpleased (that is, negative) by the driver as new improving effect data in another driving situation, thereby more efficiently managing improving effect data indicating a driving-characteristics improving assistance method more suitable for the driver.

If it is determined that the emotion data is negative and the driving-characteristics are not improved, the driving-characteristics improving server S3 according to Embodiment 2 generates new improving effect data different from the improving effect data corresponding to the acquired driving situation information, and updates the improving effect data associated with the driving situation information the same as the acquired driving situation information to the generated new improving effect data. Accordingly, the driving-characteristics improving server S3 according to Embodiment 2 can generate and update improving effect data different from the improving effect data (that is, the driving-characteristics improving assistance method) determined as not improving the driving-characteristics of the driver and felt unpleased (that is, negative) by the driver as new improving effect data in the current driving situation, and can similarly generate and update improving effect data different from the improving effect data felt unpleased (that is, negative) by the driver as new improving effect data in another driving situation, thereby more efficiently managing improving effect data indicating a driving-characteristics improving assistance method more suitable for the driver.

The improving effect data generated by the driving-characteristics improving server S3 according to Embodiment 2 is a control command for controlling the speakers 25 or the warning display lamps 26 (an example of a safe driving assistance device) mounted on each of the vehicles C1A, . . . and performs driving-characteristics improving assistance by voice or light. Accordingly, the driving-characteristics improving server S3 according to Embodiment 2 can more efficiently manage the control command of the speakers 25 or the warning display lamps 26 for the driving-characteristics improving assistance executed in each of the vehicles C1A, . . . .

The improving effect data generated by the driving-characteristics improving server S3 according to Embodiment 2 is a control command for controlling a safe driving assistance device mounted on each of the vehicles C1A, . . . for executing the assistance by voice or light. The new improving effect data for executing the assistance by either the voice or the light is generated if the emotion data is negative. Accordingly, if it is determined that the driver feels unpleased (that is, negative) to the assistance method based on the current improving effect data, the driving-characteristics improving server S3 according to Embodiment 2 can generate and update new improving effect data changed to an assistance method more suitable for the driver, thereby more efficiently managing improving effect data indicating a driving-characteristics improving assistance method more suitable for the driver. For example, the driving-characteristics improving server S3 generates new improving effect data for executing the safety confirmation behavior using either the speakers 25 or the warning display lamps 26 if the current improving effect data is an assistance method for executing the safety confirmation behavior using the speakers 25 and the warning display lamps 26, or generates new improving effect data for executing the safety confirmation behavior using the speakers 25 if the current improving effect data is an assistance method for executing the safety confirmation behavior using the warning display lamps 26.

The improving effect data generated by the driving-characteristics improving server S3 according to Embodiment 2 is a control command for controlling a safe driving assistance device mounted on each of the vehicles C1A, . . . for executing the assistance by voice or light. The new improving effect data at a decreased frequency of the assistance by the voice or the light relative to the improving effect data corresponding to the acquired driving situation information is generated if the emotion data is negative. Accordingly, if it is determined that the driver feels unpleased (that is, negative) to the assistance method based on the current improving effect data, the driving-characteristics improving server S3 according to Embodiment 2 can generate and update new improving effect data at a decreased frequency of driving-characteristics improving assistance, thereby more efficiently managing improving effect data indicating a driving-characteristics improving assistance method more suitable for the driver.

As described above, the vehicles C1A, . . . according to Embodiment 2: stores a plurality of pieces of driving situation information indicating driving situations of the vehicles C1A, . . . , improving effect data corresponding to the driving situation information for assisting to improve a safety confirmation behavior of a driver who drives the vehicles C1A, . . . in association with the user ID of the driver; acquires, by the various sensors (an example of a sensor), the driving-characteristics data on the driver in the driving situation information, and the emotion data on the driver for assistance based on the improving effect data corresponding to the driving situation information; transmits the acquired driving-characteristics data and emotion data, and the driving situation information for which the driving-characteristics data and the emotion data are acquired to an external device in association with the user ID; acquires new improving effect data corresponding to the driving situation information transmitted from the external device; and updates the improving effect data associated with the driving situation information to the acquired new improving effect data. The one or more computers mounted on the vehicles C1A, . . . referred to here may be implemented with the terminal device 22, the ECU 16A, or the like.

Thus, the vehicles C1A, . . . according to Embodiment 2 can transmit the driving situation information, the driving-characteristics of the driver, and the emotion data on the driver for the driving-characteristics improving assistance (an example of the safety confirmation behavior assistance) to the driving-characteristics improving server S3 as the driving-characteristics improving assistance result based on the improving effect data transmitted and acquired from the driving-characteristics improving server S3, thereby acquiring new improving effect data based on the current state of the driver (that is, the current driving-characteristics data and emotion data on the driver). In addition, each of the vehicles C1A, . . . can associate the acquired new improving effect data, the driving situation information used for generating the new improving effect data, the driving-characteristics data, and the emotion data with the user ID, thereby managing the improving effect data more efficiently.

### (Background of Embodiment 3)

In recent years, as a technique for preventing an increase in accidents caused due to driving operation errors, forgetting to confirm the safety, or the like due to the aging of elderly drivers and extending the driving life of elderly drivers, there is a driving assistance method of performing driving assistance for improving the driving-characteristics of a driver by using a learning model (hereinafter, referred to as “artificial intelligence”) obtained by learning a driving operation history of a driver as learning data. However, in such a driving assistance method, if the driver drives two or more vehicles (for example, a private car, a rental car, and the like), the arrangement, types, numbers, and the like of the devices for performing driving assistance (for example, warning display lamps at the pillars, side mirrors, and room mirror, and voice output devices such as speakers) are different for each vehicle. Therefore, the method for driving assistance and the obtained driving assistance effect are different for each vehicle. Therefore, in the driving assistance method, it is desired to transfer driving assistance and driving assistance data for the same driver to obtain the same driving assistance effect between a plurality of vehicles driven by the driver.

In the related art, Patent Literature 5 discloses an information processing device that transfers learning data used for learning of artificial intelligence between artificial intelligence using two different algorithms. In the learning of the artificial intelligence using two different algorithms, the information processing device omits transferring the raw data before changing the data format and the learning data to which the learning result by each artificial intelligence is attached. However, among the artificial intelligence modules using different algorithms corresponding to each vehicle, it is difficult for the information processing device to transfer the learning data including the learning result of the driving assistance suitable for the driver, or to manage the base artificial intelligence corresponding to each vehicle and the artificial intelligence trained for the driving assistance of the driver who drives each vehicle.

Patent Literature 6 discloses an artificial intelligence service that generates an artificial intelligence model suitable for the characteristics of a user by converting or correcting a base artificial intelligence model serving as the basis to fit the characteristics extracted from the information on the user. In Patent Literature 7, two artificial intelligence applications are used to manage a generated artificial intelligence (learning result) by one of the artificial intelligence applications in a secure environment, and to manage the personal information on the user by the other artificial intelligence application in a non-secure environment. However, the artificial intelligence service and the artificial intelligence system are not assumed to separately manage the base artificial intelligence using different algorithms corresponding to each vehicle and the artificial intelligence trained appropriately for the driver who drives each vehicle, or to use data indicating the driving-characteristics of the driver (that is, learning data) transferred from a device other than the vehicle.

The following Embodiment 3 describes an example of a control method for assisting the management of driving-characteristics data on a driver collected by different vehicles and the transfer of the driving-characteristics data on the driver between the vehicles. In the following description, the same components as those in Embodiment 1 or Embodiment 2 are denoted by the same reference numerals, and thus the description thereof will be omitted.

The personal-characteristics data in Embodiment 3 indicates the information related to the vehicle (for example, the history information on vehicle inspection), the driving-characteristics data on the driver collected by the vehicle, the driving-characteristics evaluation result, the safety confirmation behavior data, the improving effect data, the emotion data on the driver for the driving-characteristics improving assistance, and the like. The personal information is data related to the driver acquired by a wireless terminal device or the like capable of receiving an input operation by the driver or a relative of the driver, and is information (data) such as the name, biological information (face image, iris, fingerprint, vein, voice, or the like of the driver), the license ID, and the life information (watching television, bathing, toilet, sleeping, or the like) on the driver.

### Embodiment 3

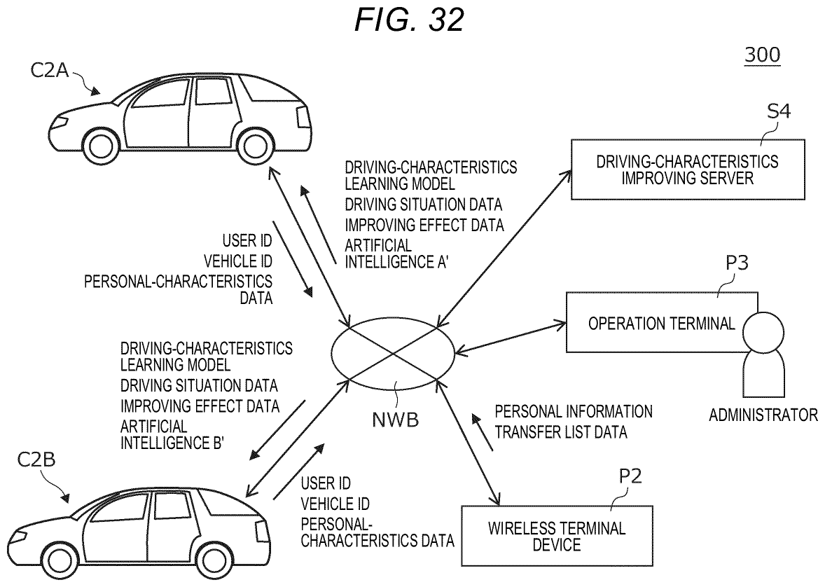

An example of a use case of a driving-characteristics improving assistance system 300 according to Embodiment 3 will be described with reference to FIG. 32. FIG. 32 is a diagram illustrating an example of a use case of the driving-characteristics improving assistance system 300 according to Embodiment 3.

The driving-characteristics improving assistance system 300 includes two or more vehicles C2A, C2B, . . . , a driving-characteristics improving server S4, a network NWB, a wireless terminal device P2, and an operation terminal P3. The operation terminal P3 is not essential and may be omitted.

Similarly to the driving-characteristics improving assistance system 200 described in Embodiment 2, the driving-characteristics improving assistance system 300 acquires driving-characteristics data as personal-characteristics data on the driver and safety confirmation behavior data from one vehicle C2A. The driving-characteristics improving assistance system 300 transmits the acquired personal-characteristics data to the driving-characteristics improving server S4. The driving-characteristics improving assistance system 300 determines whether the driving-characteristics of the driver based on the driving skills of the driver indicated by the driving-characteristics data and the safety confirmation behavior of the driver during driving indicated by the safety confirmation behavior data are improved, records the driving-characteristics improving evaluation result in the driving-characteristics improving server S4, and transmits the driving-characteristics improving evaluation result to the vehicle C2A. The driving-characteristics improving assistance system 300 updates the improving effect data indicating the driving assistance content for the driver (an example of new improving effect data) in the vehicle C2A based on the driving-characteristics improving evaluation result, and executes the driving-characteristics improving assistance based on the updated improving effect data.

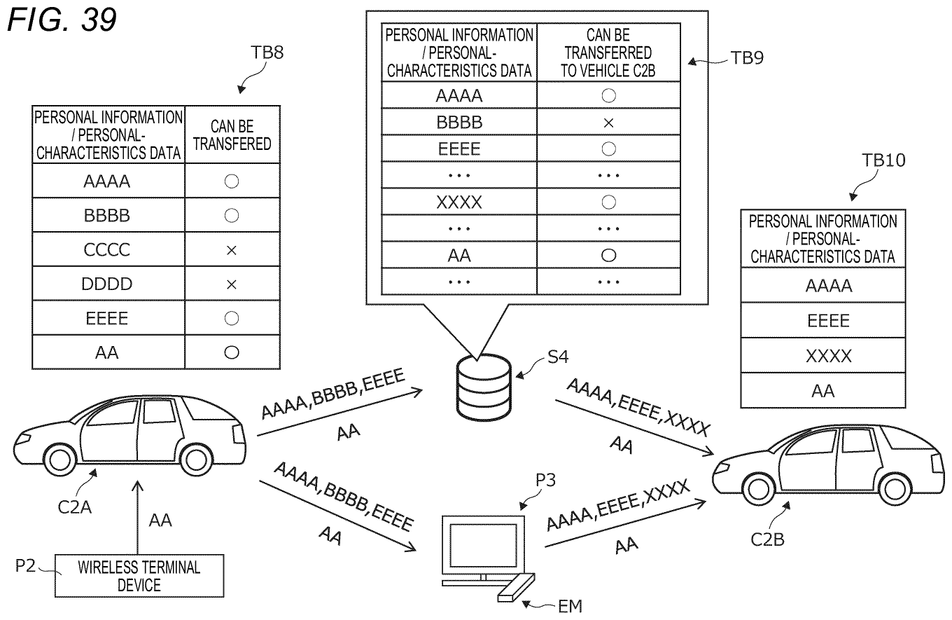

If it is detected that the driver who drives the vehicle C2A enters the vehicle C2B different from the vehicle C2A, the driving-characteristics improving assistance system 300 transmits the transfer data acquired by the vehicle C2A to the vehicle C2B based on a transfer data list TB9 (see FIG. 39) set by the driver in advance. The driving-characteristics improving assistance system 300 generates artificial intelligence (learned data) for the driving-characteristics improving assistance executed by the vehicle C2B by learning the driving-characteristics improving evaluation result of the driver in the vehicle C2A and the personal information or the personal-characteristics data on the driver, and transmits the artificial intelligence to the vehicle C2B, thereby executing the driving-characteristics improving assistance of the driver in the vehicle C2B.

The transfer data list TB9 referred to here is set in advance by the driver or a relative of the driver, and is data indicating whether the personal information and the personal-characteristics data on each driver can be transferred among the plurality of different vehicles C2A, C2B, . . . . The driving-characteristics improving assistance system 300 implements the driving-characteristics improving assistance of the driver in the plurality of vehicles by transferring the personal information or personal-characteristics data that can be transferred between the different vehicles in the transfer data list TB9 (hereinafter, referred to as “transfer data”).

The transfer data list may be set or generated for each vehicle as a transfer destination. For example, the transfer data list corresponding to a specific vehicle owned by a relative and the transfer data list corresponding to a vehicle shared by car sharing, a rental car, or the like may include different personal information and personal-characteristics data that can be transferred. Accordingly, the driving-characteristics improving assistance system 300 can prevent the personal information and the personal-characteristics data from being transferred to a vehicle unintended by the driver.

Each of the vehicles C2A, . . . is wirelessly communicably connected between the driving-characteristics improving server S4 and the operation terminal P3 via the network NWB. The wireless communication referred to here is, for example, a wireless LAN represented by Wi-Fi (registered trademark), a cellular communication system (mobile communication system), or the like, and the type thereof is not particularly limited. Each of the vehicles C2A, . . . may be connected to the wireless terminal device P2 for wireless communication.

Each of the vehicles C2A, . . . identifies the driver who drives the host vehicle, and starts the driving-characteristics improving assistance for the driver and the acquisition of the driving-characteristics data on the driver described in Embodiment 2 using the artificial intelligence for the driving-characteristics improving assistance corresponding to the identified driver. Each of the vehicles C2A, . . . starts determining (identifying) the driving situation. Each of the vehicles C2A, . . . executes the driving-characteristics improving assistance (that is, assistance of safety confirmation behavior) for the driver using artificial intelligence, and acquires the emotion data on the driver for the driving-characteristics improving assistance.

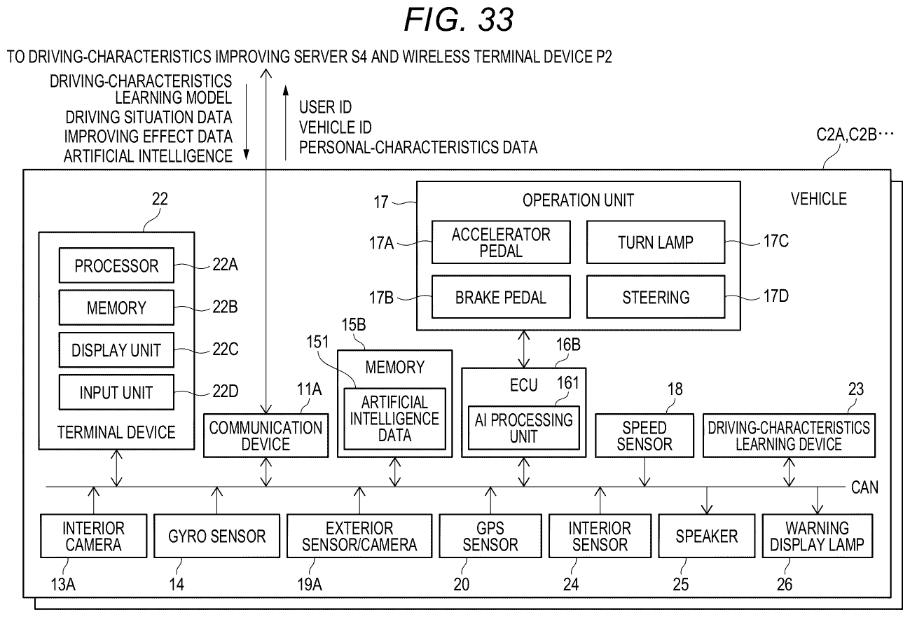

The artificial intelligence referred to here is learned data for executing the driving-characteristics improving assistance of the driver in each vehicle. The artificial intelligence is generated by the driving-characteristics improving server S4 training the artificial intelligence (hereinafter, referred to as “base artificial intelligence”) which is a base for each vehicle using the personal information (for example, age, gender, and life information) on the driver, the personal-characteristics data, the improving effect data for each driving situation, and the like. The artificial intelligence may be generated by an ECU 16B, the terminal device 22 (see FIG. 33), and the like of each vehicle.

Each of the vehicles C2A, . . . transmits the personal-characteristics data that is newly acquired (that is, not transmitted to the driving-characteristics improving server S4) to the driving-characteristics improving server S4 in association with the user ID of the driver and the vehicle ID of the host vehicle. The timing of transmitting the data may be periodically executed or may be a timing of detecting the end of driving by the driver.

For ease of understanding, the following will describe an example in which the driver switches from the vehicle C2A to the vehicle C2B.

The driving-characteristics improving server S4 as an example of a computer can implement the function that can be implemented by the driving-characteristics server S1 according to Embodiment 1 (driver authentication) and the function that can be implemented by the driving-characteristics improving server S3 according to Embodiment 2 (driving-characteristics improving assistance by generating and updating the improving effect data).

The driving-characteristics improving server S4 is connected to each of the vehicles C2A, . . . and the wireless terminal device P2 via the network NWB for data communication. The driving-characteristics improving server S4 acquires the user ID of the driver, the vehicle ID of the host vehicle, and new personal-characteristics data transmitted from each of the vehicles C2A, . . . . The driving-characteristics improving server S4 acquires the personal information on the driver, the transfer data list, and the like transmitted from the wireless terminal device P2.

The driving-characteristics improving server S4 executes re-training using the acquired new personal-characteristics data or personal information as learning data, and updates artificial intelligence “A′” currently used in the vehicle C2A.

The driving-characteristics improving server S4 identifies the driver and the vehicle (that is, the vehicle C2B) based on the personal information on the driver (for example, the biological information on the driver, the information related to the license, and the like) and the vehicle ID transmitted from the vehicle C2B. The driving-characteristics improving server S4 extracts the personal information and the personal-characteristics data on the driver transferred to the identified vehicle C2B based on the transfer data list corresponding to the identified driver. The driving-characteristics improving server S4 executes re-training using the extracted personal information and personal-characteristics data as learning data to the base artificial intelligence module “B” corresponding to the identified vehicle C2B to generate and transmit to the vehicle C2B artificial intelligence “B′” suitable for the driver identified in the vehicle C2A.

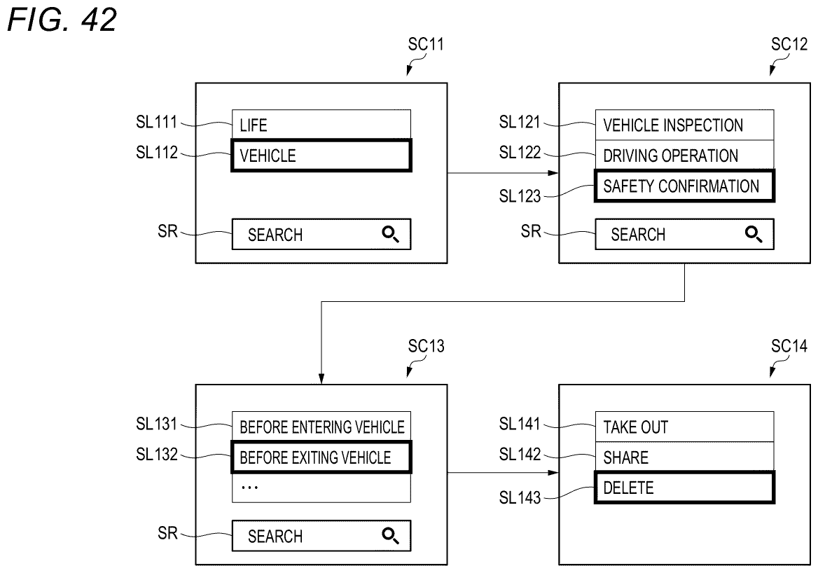

The wireless terminal device P2 can receive an input operation by the driver, a relative of the driver, or the like, and implements a function similar to that of the wireless terminal devices P1 and P1A, a function of generating a transfer data list based on the input operation, a function of transmitting the life information or the like on the driver to each of the vehicles C2A, . . . or the driving-characteristics improving server S4. The wireless terminal device P2 displays on a monitor (not illustrated) a transfer list setting screen (see FIGS. 42 to 45) for generating the transfer data list of the transfer data on the driver to be transferred between the vehicles. The wireless terminal device P2 receives a setting operation (selection, deletion, editing, or the like) of the transfer data on the driver to be transferred between the vehicles based on an operation of the driver using the transfer list setting screen, and generates and transmits to the driving-characteristics improving server S4 the transfer data list TB9 (see FIG. 39).

The transfer of the transfer data may be performed by an administrator (for example, a dealer) having the authority for viewing and managing the information (data) using an external storage medium EM (refer to FIG. 39) such as a USB memory. In such a case, the administrator transfers the transfer data on the driver (personal information, personal-characteristics data) based on the transfer data list TB9 between the vehicles using the operation terminal P3, which can accept the administrator operation and is connected to each of the vehicles C2A, C2B, . . . for wireless or wired communication.

The operation terminal P3 as an example of a computer can receive an input operation by the administrator or the like, and is implemented with, for example, a PC, a notebook PC, or the like. The operation terminal P3 is connected to the driving-characteristics improving server S4 and each of the vehicles C2A, . . . for wireless communication or wired communication.

The operation terminal P3 acquires the transfer data list TB9 of the driver designated by the administrator operation from the driving-characteristics improving server S4. The operation terminal P3 acquires and records in the external storage medium EM (for example, a USB memory) the transfer data on the driver corresponding to the transfer data list TB9 from the vehicle C2A.

The operation terminal P3 transmits the transfer data on the driver recorded in the external storage medium EM a control command for requesting the update of the artificial intelligence “B” used in the vehicle C2B to the driving-characteristics improving server S4 in association, and causes the driving-characteristics improving server S4 to update the artificial intelligence “B”.

If the same operation terminal P3 is used to transfer the transfer data from the vehicle C2A to the vehicle C2B, the transfer data on the driver may be stored (written) in an internal storage medium such as a memory 63 of the operation terminal P3.

The operation terminal P3 may be implemented by using an on-vehicle ECU mounted on each vehicle. In such a case, the operation terminal P3 may, for example, connect the external storage medium EM to the on-vehicle ECU of the vehicle C2A to transmit and receive data and record the transfer data on the driver, or connect the external storage medium EM to the on-vehicle ECU of the vehicle C2B to transmit and receive data and transmit (write) the transfer data on the driver.

The network NWB is connected to each of the vehicles C2A, . . . , the driving-characteristics improving server S4, the wireless terminal device P2, and the operation terminal P3 for wireless communication or wired communication.

Next, the example of the internal configuration of the vehicle C2A, . . . according to Embodiment 3 will be described with reference to FIG. 33. FIG. 33 is a block diagram illustrating an example of the internal configuration of vehicles C2A, . . . according to Embodiment 3. The internal configuration of the vehicles C2A, . . . illustrated in FIG. 33 illustrates an example of the internal configuration in a case where a face image of the driver is used as biological information, and the illustration of the sensors for acquiring the other biological information, the license reader, and the like is omitted.

Since the vehicles C2A, . . . have the same internal configuration, the internal configuration of the vehicle C2A will be mainly described below. In addition, the vehicles C2A, . . . implement the functions that can be implemented by the vehicles C1, . . . in Embodiment 1 and the functions that can be implemented by the vehicles C1A, . . . in Embodiment 2, and have configurations similar to those of the vehicles C1, . . . , C1A, . . . Therefore, in the following description, the same reference numerals are given to the same configurations as those of the vehicles C1, . . . , C1A, . . . , and the description thereof will be omitted.

The vehicle C2A includes at least the communication device 11A, the terminal device 22, the interior camera 13A, the gyro sensor 14, a memory 15B, and the ECU 16B. Each unit inside the vehicle C2A is connected to a CAN or the like to transmit and receive data.

The memory 15B includes, for example, a RAM as a work memory used when each process of the ECU 16B is executed, and a ROM that stores a program and data that define an operation of the ECU 16B. The RAM temporarily stores data or information generated or acquired by the ECU 16B. The program that defines the operation of the ECU 16B is written into the ROM. The memory 15B may store one or more user ID driving the vehicle C2A and the driving-characteristics history table TB3 (see FIG. 19).

The memory 15B stores artificial intelligence data 151. The artificial intelligence data 151 includes the base artificial intelligence “A” of the vehicle C1A and the artificial intelligence “A′” for executing the driving-characteristics improving assistance suitable for the driver. If there are a plurality of drivers, the memory 15B may include artificial intelligence suitable for each driver.

The ECU 16B collectively executes the processing and control of each unit. The ECU 16B is implemented with a so-called electronic circuit control device, and implements the function of each unit of an AI processing unit 161 by referring to programs and data stored in the memory 15B and executing the programs. The ECU 16B is capable of implementing functions that can be implemented by the ECUs 16 and 16A (see FIGS. 2 and 18). The ECU 16B acquires information output from the various sensors as the driving-characteristics data (personal-characteristics data). The ECU 16B outputs the driving-characteristics data to the processor 22A.

The AI processing unit 161 controls the speakers 25, the warning display lamps 26, and the like using the artificial intelligence “A′” recorded in the memory 15B to execute the driving-characteristics improving assistance. The driving-characteristics improving assistance method executes the driving-characteristics improving assistance based on the personal information on the driver in addition to the driving-characteristics improving assistance method executed by the ECU 16A described in Embodiment 2.

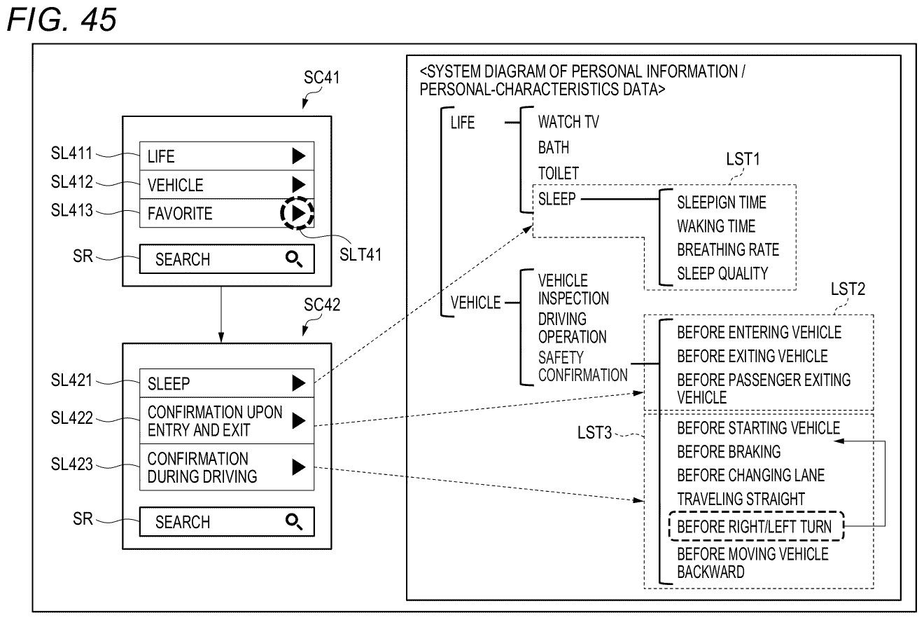

For example, the artificial intelligence “A′” is an artificial intelligence that is re-trained using the sleeping time, the waking time, the breathing rate, and the sleep quality of the driver included in the life information “sleep” on the driver (see FIG. 45) as learning data. If the sleeping period of the driver is short, the AI processing unit 161 advances the timing of executing the driving-characteristics improving assistance. Accordingly, even if the reaction to the driving-characteristics improving assistance of the driver is slow due to the lack of sleep, the vehicle C1A can execute the driving-characteristics improving assistance earlier, thereby assisting the driver to execute the safety confirmation behavior at the timing for executing the safety confirmation behavior.

If the vehicle C1A is to re-train (update) the artificial intelligence “A′”, the ECU 16B may re-train the artificial intelligence “A′” using the information acquired by the various sensors (personal-characteristics data) or the personal information on the driver transmitted from the wireless terminal device P2 as learning data. The ECU 16B executes the driving-characteristics improving assistance for the driver using re-trained artificial intelligence “A″”.

The execution of the driving-characteristics improving assistance using the artificial intelligence data 151 and the re-training of the artificial intelligence may be executed by the processor 22A of the terminal device 22.

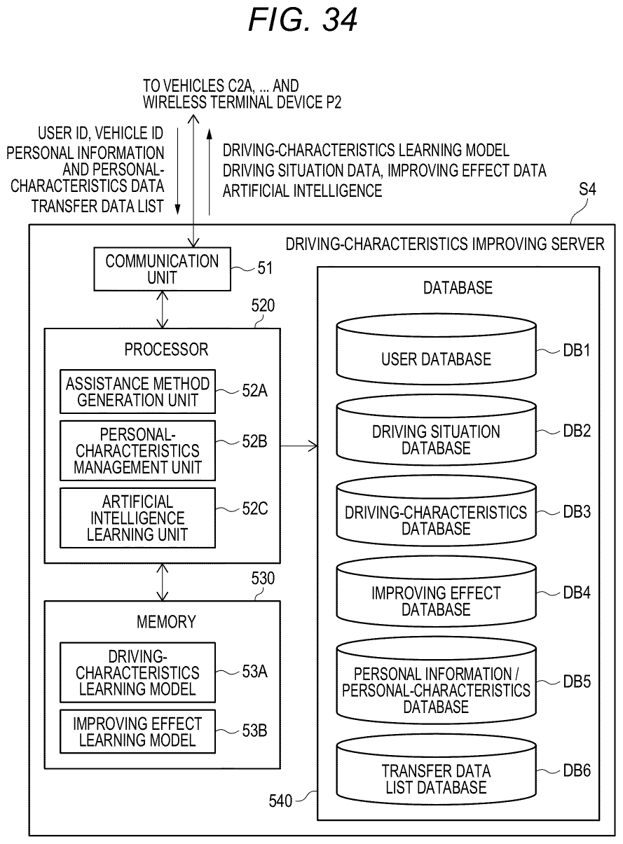

Next, an example of the internal configuration of the driving-characteristics improving server S4 will be described with reference to FIG. 34. FIG. 34 is a block diagram illustrating the example of the internal configuration of the driving-characteristics improving server S4 according to Embodiment 3.

he driving-characteristics improving server S4 implements the function that can be implemented with the driving-characteristics server S1 in Embodiment 1 and the function that can be implemented with the driving-characteristics improving server S3 in Embodiment 2, and has the same configuration as the driving-characteristics improving server S3. Therefore, in the following description, the same reference numerals are given to the same configurations as those of the driving-characteristics improving server S3, and the description thereof will be omitted.

The driving-characteristics improving server S4 includes a communication unit 51, a processor 520, a memory 530, and a database 540. The database 540 may be configured as a separate body connected to the driving-characteristics improving server S4 for data communication.

The processor 520 is implemented with, for example, a CPU, a DSP, or an FPGA, and controls the operation of each unit. The processor 520 performs the overall processing and control in cooperation with the memory 530. Specifically, the processor 520 implements the function of each of an assistance method generation unit 52A, a personal-characteristics management unit 52B, and an artificial intelligence training unit 52C by referring to a program and data stored in the memory 530 and executing the program. The processor 520 implements the function of each unit that can be implemented by the processors 32 and 52 (see FIGS. 3 and 20).

When the driving-characteristics learning model or the driving situation data is updated, the processor 520 transmits the updated driving-characteristics learning model or driving situation data to each of the vehicles C2A, . . . .

The processor 520 acquires the user ID, the vehicle ID, and the new personal-characteristics data from each of the vehicles C2A, . . . , and acquires the personal information on the driver, the transfer data list, and the like from the wireless terminal device P2. The processor 520 executes the transfer of the transfer data (personal information and personal-characteristics data), the generation and re-training (update) of the artificial intelligence, and the like based on the acquired data (information). The processor 520 transmits the generated or re-trained artificial intelligence to each of the vehicles C2A, . . . .

The personal-characteristics management unit 52B stores (registers) the personal information and the personal-characteristics data acquired from each of the vehicles C2A, . . . and the personal information acquired from the wireless terminal device P2 in a personal information/personal-characteristics data table TB7 for each vehicle ID driven by the user ID.

The personal-characteristics management unit 52B refers to a transfer data list database DB6 based on the acquired user ID or the personal information on the driver. The personal-characteristics management unit 52B extracts the transfer data on the driver to be transferred from the vehicle C2A to the vehicle C2B from the personal information on the driver and the personal-characteristics data stored in a personal information/personal-characteristics database DB5 based on the obtained transfer data list TB9 (see FIG. 39) corresponding to the user ID or the personal information on the driver. The personal-characteristics management unit 52B outputs the extracted transfer data on the driver to the artificial intelligence training unit 52C in association with the user ID and the vehicle ID.

The artificial intelligence training unit 52C refers to the improving effect learning model 53B based on the vehicle ID output from the personal-characteristics management unit 52B, and acquires the base artificial intelligence of the vehicle corresponding to the vehicle ID. The artificial intelligence training unit 52C executes learning using the extracted transfer data on the driver as learning data for the acquired base artificial intelligence, and generates artificial intelligence capable of executing driving-characteristics improving suitable for the driver. The artificial intelligence training unit 52C outputs the generated artificial intelligence to the communication unit 51 and transmits the artificial intelligence to the corresponding vehicle.

If the artificial intelligence associated with the information on the acquired user ID is stored in the improving effect learning model 53B, the artificial intelligence training unit 52C may execute re-training (update) using the transfer data on the driver extracted by the artificial intelligence as learning data. For example, if the acquired vehicle ID indicates the vehicle C2A and the artificial intelligence “A′” associated with the information on the acquired user ID is stored in the improving effect learning model 53B, the artificial intelligence training unit 52C generates the artificial intelligence “A″” obtained by re-training the artificial intelligence “A′”.

The memory 530 includes, for example, a RAM as a work memory used when each process of the processor 520 is executed, and a ROM that stores a program and data that define an operation of the processor 520. The RAM temporarily stores data or information generated or acquired by the processor 520. The program that defines the operation of the processor 520 is written into the ROM.

The memory 530 stores the driving-characteristics learning model 53A and the improving effect learning model 53B. The memory 530 stores programs and data stored in each of the memories 33 and 53 (see FIGS. 3 and 20), and enables the processor 520 to implement the function of each unit that can be implemented with the processors 32 and 52 (see FIGS. 3 and 20).

In Embodiment 3, the improving effect learning model 53B stores, for each vehicle ID, a base artificial intelligence model for executing similar driving-characteristics improving assistance in each of the plurality of different vehicles in accordance with the number and arrangement of the speakers 25, the warning display lamps 26, and the like included in each of the vehicles C2A, . . . . The improving effect learning model 53B stores the artificial intelligence for each driver (for example, the artificial intelligence “A′” and “B′”) generated by executing learning using the personal information and the personal-characteristics data as learning data, the user ID, and the vehicle ID in association with the base artificial intelligence for each vehicle (for example, the base artificial intelligence “A” and “B”).

The database 540 records the user database DB1, the driving situation database DB2, a driving-characteristics database DB3, the improving effect database DB4, the personal information/personal-characteristics database DB5, and the transfer data list database DB6.

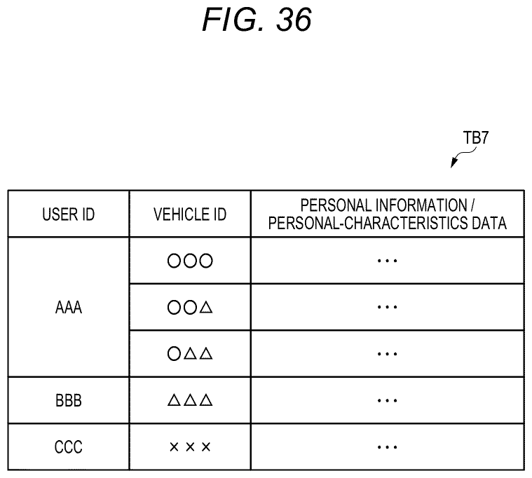

The personal information/personal-characteristics database DB5 stores (registers) one or more vehicle IDs driven by the driver and the personal information and the personal-characteristics data on the driver acquired by the vehicle corresponding to each vehicle ID in the personal information/personal-characteristics data table TB7 (see FIG. 36) for each user ID. The personal information/personal-characteristics database DB5 may be a database that collectively stores (registers) and manages the personal information on the driver registered in the user database DB1, the life information on the driver transmitted from the wireless terminal device P2, and the personal-characteristics data registered in each of the driving-characteristics database DB3 and the improving effect database DB4.

The transfer data list database DB6 stores (registers) the transfer data list transmitted from the wireless terminal device P2 for each user ID.

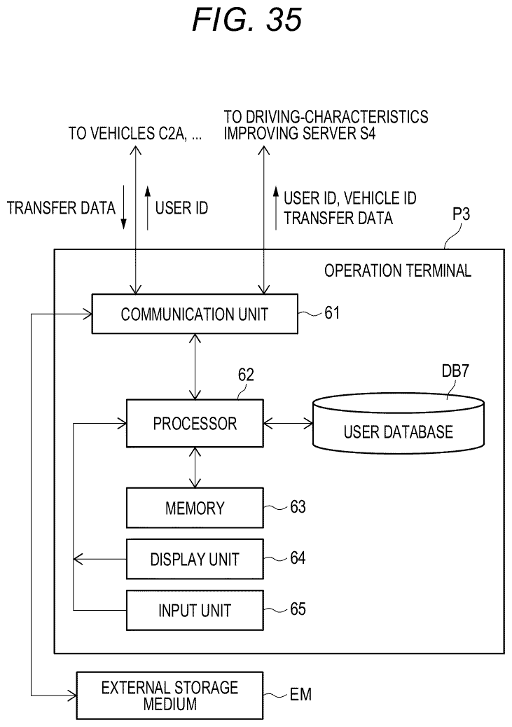

Next, an example of the internal configuration of the operation terminal P3 will be described with reference to FIG. 35. FIG. 35 is a block diagram illustrating an example of the internal configuration of the operation terminal P3 according to Embodiment 3.

The operation terminal P3 includes a communication unit 61, a processor 62, a memory 63, a display unit 64, an input unit 65, and a user database DB7. The user database DB7 is not an essential component and may be omitted.

The communication unit 61 includes a transmission circuit and a reception circuit that transmit and receive data between the vehicle C2A, . . . and the driving-characteristics improving server S4 via the network NW. The communication unit 61 includes a transmission circuit and a reception circuit that transmit and receive data to and from the external storage medium EM such as a USB memory or an SD card.

The processor 62 is implemented with, for example, a CPU, a DSP, or an FPGA, and controls the operation of each unit. The processor 62 performs the overall processing and control in cooperation with the memory 63. Specifically, the processor 62 implements functions of each unit by referring to a program and data stored in the memory 63 and executing the program.

The memory 63 includes, for example, a RAM as a work memory used when each processing of the processor 62 is executed, and a ROM that stores a program and data that define an operation of the processor 62. The RAM temporarily stores data or information generated or acquired by the processor 62. The program that defines the operation of the processor 62 is written into the ROM.

The display unit 64 is implemented with, for example, an LCD or an organic EL, and displays various screens for transferring the transfer data on the driver among the plurality of vehicles C2A, . . . . For example, the display unit 64 displays a selection screen (not illustrated) for selecting (designating) the driver as the target for transferring the transfer data, a selection screen (not illustrated) for selecting (designating) the vehicle as the target for transferring the transfer data (that is, the switch destination), and the like.

The input unit 65 is implemented with, for example, a keyboard, a mouse, a touch panel, or the like, and receives an administrator operation. The input unit 65 converts the received administrator operation into an electric signal and outputs the electric signal to the processor 62. The input unit 65 may be a user interface integrated with the display unit 64.

The user database DB7 stores (registers), for each driver, the personal information or the user ID of the driver as the target for transferring the transfer data. The user database DB7 is not essential and may be omitted or may be configured separately from the operation terminal P3.

If the user database DB7 is omitted, the administrator may designate (identify) the driver as the target for transferring the transfer data by inputting, to the input unit 65, the personal information on the driver other than the user ID (for example, the license ID, the information related to the driver (name, age, date of birth and the like), various numbers assigned for identifying the driver and the like).

The external storage medium EM is, for example, a USB memory, an SD card, or the like, and is a storage medium capable of recording the transfer data. The external storage medium EM records (writes) the transfer data transmitted from the operation terminal P3 for each driver, and reads the recorded transfer data to the operation terminal P3.

Next, the personal information/personal-characteristics data table TB7 recorded by the driving-characteristics improving server S4 will be described with reference to FIG. 36. FIG. 36 is a diagram illustrating an example of the personal information/personal-characteristics data table TB7.

The personal information/personal-characteristics data table TB7 records and manages the vehicle ID and the personal information and the personal-characteristics data acquired by the vehicle corresponding to the vehicle ID in association with the user ID. The user ID may be a license ID.

For example, the personal information/personal-characteristics data table TB7 illustrated in FIG. 36 records the vehicle IDs “MMM”, “MMN”, and “MNN” and the personal information and the personal-characteristics data acquired by the vehicles corresponding to the vehicle ID “MMM”, “MMN”, and “MNN” in association with the user ID “AAA”, records the vehicle ID “NNN” and the personal information and the personal-characteristics data acquired by the vehicle corresponding to the vehicle ID “NNN” in association with the user ID “BBB”, and records the vehicle ID “OOO” and the personal information and the personal-characteristics data acquired by the vehicle corresponding to the vehicle ID “OOO” in association with the user ID “CCC”. Accordingly, the personal information/personal-characteristics data table TB7 can efficiently manage the personal information and the personal-characteristics data on the driver even if one driver drives a plurality of different vehicles.

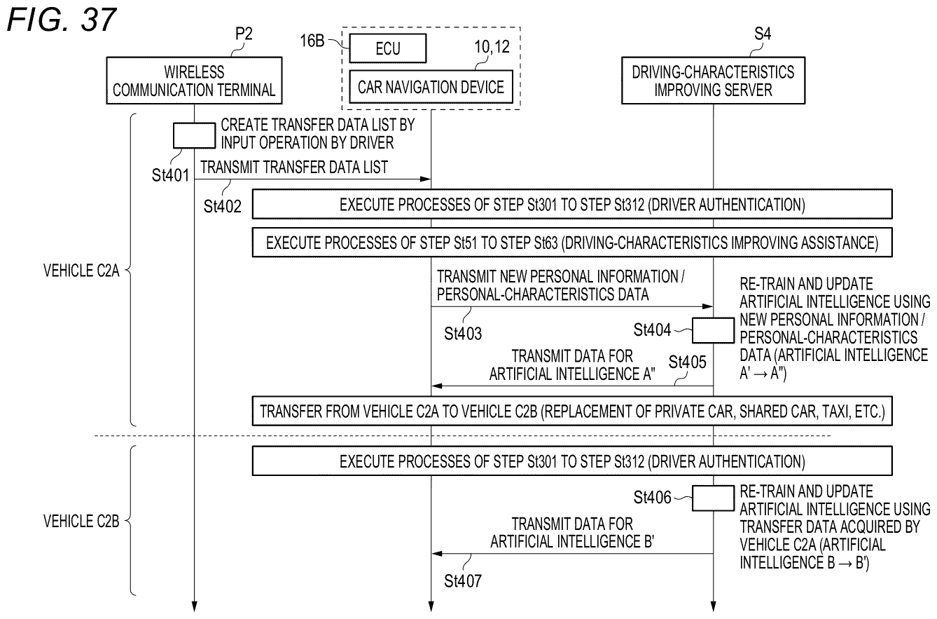

A transfer procedure example 1 according to the driving-characteristics improving assistance system 300 according to Embodiment 3 will be described with reference to FIG. 37. FIG. 37 is a sequence diagram illustrating a transfer procedure example 1 of transfer data on a driver in the driving-characteristics improving assistance system 300 according to Embodiment 3. The transfer procedure example 1 of transfer data referred to here is a transfer procedure of transfer data executed by each of the wireless terminal device P2, the vehicles C2A, . . . , and the driving-characteristics improving server S4.

The following will describe an example in which the initial registration of the driver illustrated in FIG. 5 (step St101 to step St111) is completed in each of the vehicles C2A and C2B.

The transfer procedure example 1 of the personal information data and the personal-characteristics data on the driver illustrated in FIG. 37 will describe an example in which the driving-characteristics improving server S4 re-trains (updates) the artificial intelligence, but is not limited thereto. The re-training (update) of the artificial intelligence may be executed in each of the vehicles C2A and C2B. In such a case, each of the vehicles C2A and C2B re-trains (updates) the artificial intelligence using the transfer data transmitted from the driving-characteristics improving server S4.

The wireless terminal device P2 receives an input operation by the driver or a relative of the driver, generates the transfer data list TB9 (see FIG. 39) (St401), and transmits the transfer data list TB9 to the vehicle C2A (St402). FIG. 37 illustrates an example in which the transfer data list TB9 is transmitted to the vehicle C2A, but the wireless terminal device P2 may transmit the same transfer data list TB9 to the driving-characteristics improving server S4. The transfer data list TB9 may be further transmitted to the driving-characteristics improving server S4 by the vehicle C2A after being transmitted to the vehicle C2A, or may be further transmitted to the vehicle C2A by the driving-characteristics improving server S4 after being transmitted to the driving-characteristics improving server S4.

The driving-characteristics improving assistance system 300 executes the driver authentication process (step St301 to step St312) illustrated in FIG. 14 between the vehicle C2A and the driving-characteristics improving server S4 capable of implementing the function of the driving-characteristics server S1.

After the authentication of the driver is completed, the driving-characteristics improving assistance system 300 executes the driving-characteristics improving process (step St51 to step St63) illustrated in FIG. 30 and FIG. 31 between the vehicle C2A and the driving-characteristics improving server S4 capable of implementing the function of the driving-characteristics improving server S3. Although not illustrated in the example illustrated in FIG. 37, the driving-characteristics improving process may be executed using the artificial intelligence “A′” obtained by learning the personal information and the personal-characteristics data (transfer data) on the driver at the time of the previous driving as the learning data.

In the driving-characteristics improving assistance using the artificial intelligence according to Embodiment 3, the vehicle C2A may further execute driving-characteristics improving assistance using life information (for example, sleep information) included in the personal information on the driver. For example, when acquiring the sleep information (for example, the sleeping time, the waking time, the breathing rate, the sleep quality, and the like) which is the personal information on the driver from the wireless terminal device P2 using the artificial intelligence “A′”, the vehicle C2A executes the evaluation related to the sleep of the driver. If it is determined that the driver is insufficient in sleep as the result of the evaluation, the vehicle C2A executes the driving-characteristics improving assistance suitable for the physical condition of the driver by advancing the execution timing of the driving-characteristics improving assistance during driving.

The vehicle C2A transmits the user ID, the vehicle ID, and the new personal information and personal-characteristics data on the driver acquired in the current driving in association to the driving-characteristics improving server S4 at a timing of detecting the end of driving by the driver (St403). The data transmission timing may be executed periodically (for example, 30 minutes, 1 hour, or the like), or may be executed at the timing of the end of driving as described above.

The driving-characteristics improving server S4 stores (registers) the new personal information and personal-characteristics data transmitted from the vehicle C2A in the personal information/personal-characteristics database DB5 based on the user ID and the vehicle ID (St404). In addition, the driving-characteristics improving server S4 generates the artificial intelligence “A″” by re-training (updating) the current artificial intelligence “A′” of the vehicle C2A using the new personal information and the personal-characteristics data as the learning data (St404). The driving-characteristics improving server S4 stores (registers) in the improving effect learning model 53B and transmits to the vehicle C2A the vehicle ID of the vehicle C2A and the user ID of the user who drives the vehicle C2A in association with the generated artificial intelligence “A″” (St405).

The vehicle C2A records the artificial intelligence “A″” transmitted from the driving-characteristics improving server S4 in the memory 15B.

Here, the driving-characteristics improving assistance process in a case where the driver switches from the vehicle C2A to the vehicle C2B due to the replacement of a private car, use of a shared car, or the like will be described. If it is determined that the driver enters the vehicle C2A as a passenger of the vehicle C2B, for example, if the driver rides together as an instructor on a road practice with a provisional driver's license, the driving-characteristics improving assistance system 300 may execute the driving-characteristics improving assistance process for the driver who is the passenger.

The driving-characteristics improving assistance system 300 executes the driver authentication process (step St301 to step St312) illustrated in FIG. 14 between the vehicle C2B and the driving-characteristics improving server S4 capable of implementing the function of the driving-characteristics server S1.

The driving-characteristics improving server S4 refers to the transfer data list database DB6 based on the user ID (the biological information, the license information, and the like of the driver) and the vehicle ID transmitted from the vehicle C2B. The driving-characteristics improving server S4 extracts the transfer data on the driver that can be transferred from the vehicle C2A to the vehicle C2B from the personal information/personal-characteristics database DB5 based on the transfer data list TB9 (see FIG. 39) of the driver corresponding to the user ID.

The driving-characteristics improving server S4 re-trains (updates) the base artificial intelligence “B” of the vehicle C2B using the extracted transfer data as learning data to generate the artificial intelligence “B′” (St406). The driving-characteristics improving server S4 stores (registers) in the improving effect learning model 53B and transmits to the vehicle C2B the vehicle ID of the vehicle C2A and the user ID of the user who drives the vehicle C2A in association with the generated artificial intelligence “B′” (St407).

The vehicle C2B records the artificial intelligence “B′” transmitted from the driving-characteristics improving server S4 in the memory 15B and starts the driving-characteristics improving assistance of the driver.

As described above, even if the driver drives a plurality of different vehicles, the driving-characteristics improving assistance system 300 according to Embodiment 3 can execute the driving-characteristics improving assistance in the vehicle C2B the same as or similar to the vehicle C2A based on the artificial intelligence “B′” generated by learning the transfer data on the driver acquired by the vehicle C2A last driven by the driver. In addition, if the artificial intelligence can be re-trained (updated) in each of the vehicles C2A and C2B, the driving-characteristics improving assistance system 300 can transfer the transfer data on the driver acquired by the vehicle C2A to the latest vehicle C2B, thereby executing the driving-characteristics improving assistance in the vehicle C2B the same as or similar to the vehicle C2A.

The driving-characteristics improving assistance system 300 extracts and transfers the transfer data based on the transfer data list obtained by selecting the transfer data (personal information and personal-characteristics data) that the driver desires to transfer among the plurality of different vehicles. Accordingly, the driving-characteristics improving assistance system 300 can protect the personal information on the driver by preventing to transfer (share) the personal information and the personal-characteristics data that the driver does not desire to, and can implement driving-characteristics improving assistance more suitable for the driver in different vehicles.

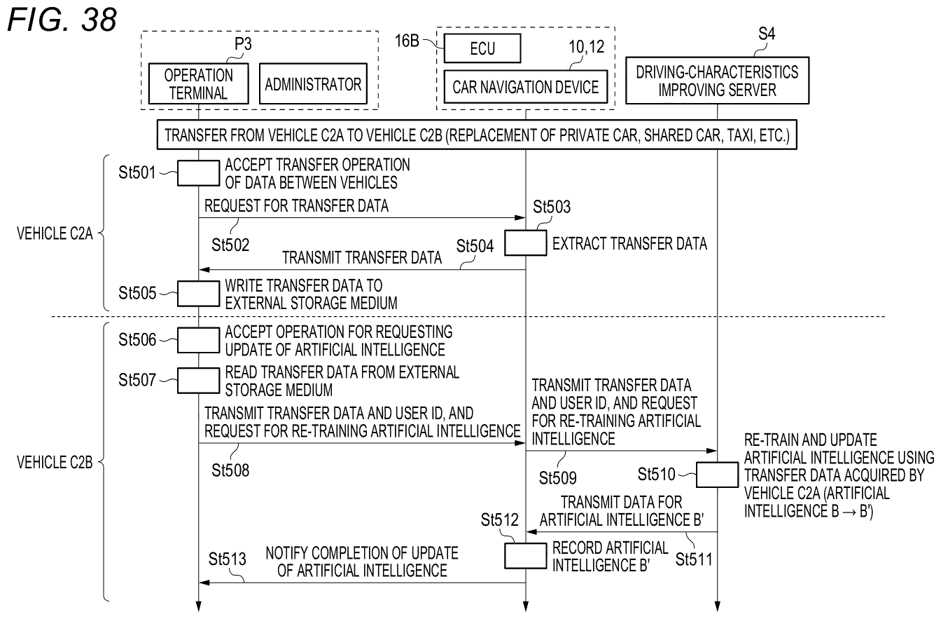

A transfer procedure example 2 according to the driving-characteristics improving assistance system 300 according to Embodiment 3 will be described with reference to FIG. 38. FIG. 38 is a sequence diagram illustrating a transfer procedure example 2 of transfer data on a driver in the driving-characteristics improving assistance system 300 according to Embodiment 3. The transfer procedure example 2 of the transfer data referred to here is a transfer procedure of the transfer data executed by an administrator operation and executed by each of the operation terminal P3, the vehicles C2A, . . . , and the driving-characteristics improving server S4.

The following will describe an example in which the initial registration of the driver illustrated in FIG. 5 (step St101 to step St111) is completed in each of the vehicles C2A and C2B.

The following will describe an example in which the generation of the transfer data list TB9 illustrated in FIG. 37 (Step St401) and the registration of the transfer data list TB9 to the driving-characteristics improving server S4 (Step St402) are completed.

The operation terminal P3 receives an operation by the administrator for starting the transfer of the transfer data on the driver between the vehicle C2A and the vehicle C2B (St501). The operation terminal P3 generates and transmits to the vehicle C2A a control command for requesting the transmission of the transfer data (personal information and personal-characteristics data) (St502).

Based on the transmitted control command, the vehicle C2A refers to the transfer data list TB9 transmitted in advance from the wireless terminal device P2 and recorded in the memory 15B (St503). The vehicle C2A extracts the transfer data based on the transfer data list TB9 and transmits the transfer data to the operation terminal P3 (St504).

The operation terminal P3 acquires the transfer data transmitted from the vehicle C2A. The operation terminal P3 writes the acquired transfer data to the external storage medium EM (for example, a USB memory, an SD card, or the like; see FIG. 39) based on the administrator operation (St505).

The operation terminal P3 receives an administrator operation for re-training (updating) the base artificial intelligence module “B” of the vehicle C2B with the artificial intelligence module “B′” capable of executing the driving improving assistance of the driver (St506). The operation terminal P3 reads the transfer data on the driver who drives the vehicle C2B from the external storage medium EM (St507). The operation terminal P3 generates a control command for requesting the re-training (update) of the base artificial intelligence module “B” of the vehicle C2B, and transmits the generated control command to the vehicle C2B in association with the user ID of the driver and the transfer data on the driver (St508).

The vehicle C2B generates a control command for requesting the re-training (update) of the base artificial intelligence module “B” of the vehicle C2B based on the control command transmitted from the operation terminal P3, and transmits the acquired user ID of the driver and the transfer data on the driver to the driving-characteristics improving server S4 in association (St509).

Based on the control command transmitted from the vehicle C2B, the driving-characteristics improving server S4 re-trains (updates) the base artificial intelligence “B” of the vehicle C2B using the acquired driver transfer data as learning data to generate the artificial intelligence “B′” (St510). The driving-characteristics improving server S4 transmits the generated artificial intelligence “B′” to the vehicle C2B (St511). The driving-characteristics improving server S4 may store (register) the generated artificial intelligence “B′” in the improving effect learning model 53B in association with the user ID.

The vehicle C2B acquires the artificial intelligence “B′” transmitted from the driving-characteristics improving server S4, records the artificial intelligence “B′” in the memory 15B (St513), generates a notification of completion of re-training (update) to the artificial intelligence “B′”, and transmits the notification to the operation terminal P3 (St513).

As described above, the driving-characteristics improving assistance system 300 according to Embodiment 3 can execute the driving-characteristics improving assistance similar to that of the vehicle C2A even in the vehicle C2B by transferring the transfer data by the administrator using the external storage medium EM.

As described above, even if the driver drives a plurality of different vehicles, the driving-characteristics improving assistance system 300 according to Embodiment 3 can transfer the transfer data on the driver acquired by the vehicle C2A driven last by the driver to the vehicle C2B using the external storage medium EM.

Based on an instruction (operation) by the administrator, the driving-characteristics improving assistance system 300 extracts and transfers the transfer data based on the transfer data list obtained by selecting the transfer data (personal information and personal-characteristics data) that the driver desires to transfer among the plurality of different vehicles. Accordingly, the driving-characteristics improving assistance system 300 can protect the personal information on the driver by preventing to transfer (share) the personal information and the personal-characteristics data that the driver does not desire to, and can implement driving-characteristics improving assistance more suitable for the driver in different vehicles.

With reference to FIG. 39, a transfer example 1 of the transfer data executed via the driving-characteristics improving server S4 corresponding to the transfer procedure example 1 illustrated in FIG. 37 and a transfer example 2 of the transfer data executed via the external storage medium EM corresponding to the transfer procedure example 2 illustrated in FIG. 38 will be described. FIG. 39 is a diagram illustrating the transfer examples 1 and 2 of the transfer data on the driver.

The transfer data list TB8 is a table in which each piece of the personal information and the personal-characteristics data acquired by the vehicle C2A in the current driving is associated with information on whether each piece of the personal information and the personal-characteristics data can be transferred to another vehicle (here, the vehicle C2B).

The transfer data list TB9 is a table in which each piece of the personal information and the personal-characteristics data acquired by the vehicle C2A in the driving is associated with information on whether each piece of the personal information and the personal-characteristics data can be transferred to the vehicle C2B.

A personal information/personal-characteristics data table TB10 indicates the personal information/personal-characteristics data on the driver transferred to the vehicle C2A by the driving-characteristics improving server S4.

First, the transfer example 1 of the transfer data will be described.

The vehicle C2A acquires the personal information “AA” on the driver and the personal-characteristics data “AAAA”, “BBBB”, “CCCC”, “DDDD”, and “EEEE”, acquired from the wireless terminal device P2 during a period from the timing of the start of driving to the timing of the end of driving by the driver. Based on the transfer data list recorded in the memory 15B, the vehicle C2A extracts from the transfer data list TB8 and transmits to the driving-characteristics improving server S4 the personal information “AA” and the personal-characteristics data “AAAA”, “BBBB”, and “EEEE” that can be transferred to the driving-characteristics improving server S4.

The driving-characteristics improving server S4 extracts from the transfer data list TB9 and transmits to the vehicle C2B the personal information “AA” and the personal-characteristics data “AAAA”, “EEEE”, and “XXXX” that can be transferred from the vehicle C2A to the vehicle C2B.

The vehicle C2B re-trains (updates) the base artificial intelligence “B” to generate the artificial intelligence “B′” using the personal information “AA” and the personal-characteristics data “AAAA”, “EEEE”, and “XXXX” transmitted from the driving-characteristics improving server S4 as learning data. The vehicle C2B executes the driving-characteristics improving assistance of the driver using the generated artificial intelligence “B′”.

In FIG. 39, for ease of understanding, the transfer data (personal information or personal-characteristics data) transferred between the vehicle C2A and the vehicle C2B will be specifically described using the transfer data lists TB8 and TB9 and the personal information/personal-characteristics data table TB10, but the generation of the transfer data lists TB8 and TB9 or the personal information/personal-characteristics data table TB10 is not essential and may be omitted as a matter of course.

FIG. 39 has described an example in which the vehicle C2A and the driving-characteristics improving server S4 have different transfer data lists. In such a case, the vehicle C2A extracts and transmits to the driving-characteristics improving server S4 the transfer data based on the transfer data list transmitted from the wireless terminal device P2 in advance and recorded in the memory 15B. The driving-characteristics improving server S4 extracts the transfer data to be transferred to the vehicle C2B based on a transfer data list different from the transfer data list of the vehicle C2A.

Next, the transfer example 2 of the transfer data will be described.

The vehicle C2A acquires the personal information “AA” on the driver and the personal-characteristics data “AAAA”, “BBBB”, “CCCC”, “DDDD”, and “EEEE”, acquired from the wireless terminal device P2 during a period from the timing of the start of driving to the timing of the end of driving by the driver. Based on the control command transmitted from the operation terminal P3, the vehicle C2A extracts from the transfer data list TB8 and transmits to the operation terminal P3 the personal information “AA” and the personal-characteristics data “AAAA”, “BBBB”, and “EEEE” that can be transferred to the vehicle C2B.

Based on the administrator operation, the operation terminal P3 writes the personal information “AA” that can be transferred to the vehicle C2B and the personal-characteristics data “AAAA”, “BBBB”, and “EEEE” to the external storage medium EM. Based on the administrator operation, the operation terminal P3 reads and transmits to the vehicle C2B the personal information “AA” and the personal-characteristics data “AAAA”, “BBBB”, and “EEEE” written to the external storage medium EM.

The vehicle C2B acquires the personal information “AA” and the personal-characteristics data “AAAA”, “EEEE”, and “XXXX” transmitted from the operation terminal P3. The vehicle C2B transmits to the driving-characteristics improving server S4 a control command for requesting the re-training (update) of the base artificial intelligence “B”, the personal information “AA” used for re-training the base artificial intelligence “B”, and the personal-characteristics data “AAAA”, “BBBB”, and “EEEE”.

Based on the control command transmitted from the vehicle C2B, the driving-characteristics improving server S4 re-trains (updates) the base artificial intelligence “B” to generate the artificial intelligence “B′” using the personal information “AA” and the personal-characteristics data “AAAA”, “BBBB”, and “EEEE” as learning data. The driving-characteristics improving server S4 transmits the artificial intelligence “B′” generated by the re-training to the vehicle C2B.

However, the vehicles C2A and C2B may have different numbers, arrangements, and the like of the speakers and warning display lamps. In such a case, it is difficult for the vehicle C2B, which is the transfer destination of the transfer data, to execute the driving-characteristics improving assistance by a device arranged at the same position as the vehicle C2A or the same method (for example, a lighting control method of various lighting and pillars or the like, and a voice output method).

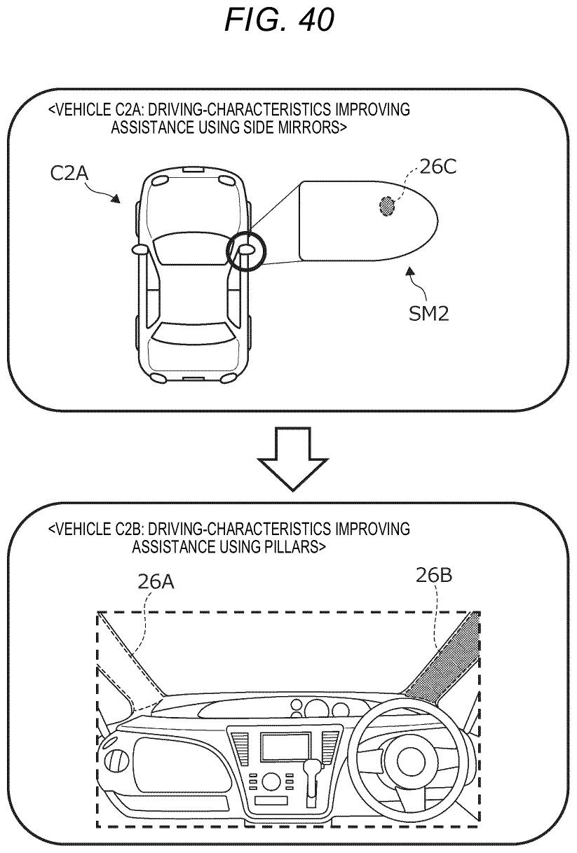

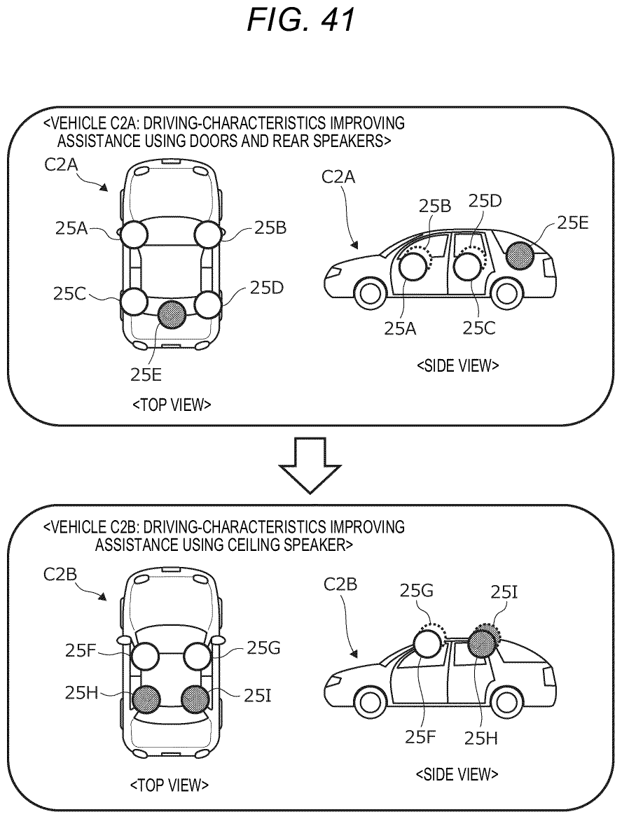

The base artificial intelligence stored in each vehicle in Embodiment 3 changes the method, the device (speakers, warning display lamps, or the like), the position of the device, or the like for executing the driving-characteristics improving assistance transferred from the other vehicle based on the number and arrangement of the speakers 25, the warning display lamps 26, and the like provided in the host vehicle, which enables driving-characteristics improving assistance expected to achieve an effect the same as or similar to the driving-characteristics improving assistance in the other vehicle. Hereinafter, a modification of the driving-characteristics improving assistance operation (method or device) between the vehicles C2A and C2B will be specifically described with reference to FIGS. 40 and 41.

Modification 1 of the driving-characteristics improving assistance operation will be described with reference to FIG. 40. FIG. 40 is a diagram illustrating Modification 1 of the driving-characteristics improving assistance operation between the vehicles C2A and C2B.

In the example illustrated in FIG. 40, for example, in the vehicle C2A, the warning display lamps 26A and 26B are not provided in each of the pair of front pillars (A pillars), and the warning display lamp 26C (for example, an LED or the like) is provided in the right side mirror SM2. Further, for example, in the vehicle C2B, the warning display lamp 26C is not provided in the right side mirror SM2, and the warning display lamps 26A and 26B are respectively provided in the pair of front pillars (A pillars).

The vehicle C2A uses, for example, artificial intelligence trained using the improving assistance data (personal-characteristics data) to control the lighting and blinking of the warning display lamp 26C (for example, an LED) provided in the right side mirror SM2 in a predetermined color (for example, yellow, orange, red, or the like). Accordingly, the vehicle C2A executes driving-characteristics improving assistance for prompting the driver to visually confirm the presence or absence of an approaching object (for example, a pedestrian, another vehicle, a two-wheeler, or the like) from the rear right of the host vehicle (safety confirmation behavior).

In such a case, the artificial intelligence “B′” trained using the transfer data acquired by the vehicle C2A as the learning data to the base artificial intelligence “B” of the vehicle C2B changes the driving-characteristics improving assistance performed using the warning display lamp 26C of the right side mirror SM2 to be executed by the warning display lamp 26B which is the front right pillar (A pillar).

The vehicle C2B uses the artificial intelligence “B′” to control the lighting and blinking of the warning display lamp 26B, which is the front right pillar (A pillar), in a predetermined color (for example, yellow, orange, red, or the like). Accordingly, the vehicle C2B executes driving-characteristics improving assistance for prompting the driver to visually confirm the presence or absence of an approaching object (for example, a pedestrian, another vehicle, a two-wheeler, or the like) from the rear right of the host vehicle (safety confirmation behavior).

As described above, the driving-characteristics improving assistance system 300 according to Embodiment 3 can change the method, the device, or the position of the device for implementing the same driving-characteristics improving assistance in each vehicle by using the base artificial intelligence corresponding to each vehicle even if there is no same device (in the above-described example, the warning display lamp 26C of the right side mirror SM2) between vehicles. Accordingly, the driving-characteristics improving assistance system 300 can assist the driver to obtain the same or similar effect of the driving-characteristics improving assistance even in different vehicles.

Next, Modification 2 of the driving-characteristics improving assistance operation will be described with reference to FIG. 41. FIG. 41 is a diagram illustrating Modification 2 of the driving-characteristics improving assistance operation between the vehicles C2A and C2B.

In the example illustrated in FIG. 41, for example, in the vehicle C2A, five speakers 25A to 25E are arranged at each door and at the rear of the vehicle. In addition, for example, in the vehicle C2B, four speakers 25F, 25G, 25H, and 25I respectively correspond to the position of the doors and are arranged near the ceiling.

For example, the vehicle C2A outputs voice from the speaker 25E provided at the rear of the vehicle using artificial intelligence trained using the improving assistance data (personal-characteristics data). Accordingly, the vehicle C2A executes driving-characteristics improving assistance for prompting the driver to confirm the safety behind the vehicle.

In such a case, the artificial intelligence “B′” trained using the transfer data acquired by the vehicle C2A as the learning data to the base artificial intelligence “B” of the vehicle C2B changes the driving-characteristics improving assistance performed using the speaker 25E to be executed by the two speakers 25H and 25I arranged at the rear of the vehicle.

The vehicle C2B outputs voice from the speakers 25H and 25I at the rear of the vehicle using the artificial intelligence “B′”. Accordingly, the vehicle C2A executes driving-characteristics improving assistance for prompting the driver to confirm the safety behind the vehicle.

As described above, the driving-characteristics improving assistance system 300 according to Embodiment 3 can change the method, the device, or the position of the device for implementing the same driving-characteristics improving assistance in each vehicle by using the base artificial intelligence corresponding to each vehicle even if there is no device of the same arrangement (in the above-described example, the speaker 25E) between vehicles. Accordingly, the driving-characteristics improving assistance system 300 can assist the driver to obtain the same or similar effect of the driving-characteristics improving assistance even in different vehicles.

The driving-characteristics improving assistance system 300 may change the driving-characteristics improving assistance using the voice from the speakers 25 to the driving-characteristics improving assistance using the lighting, blinking, or the like of the warning display lamps 26. The driving-characteristics improving assistance system 300 may change the type of the voice output from the speakers 25, the pattern of the lighting control by the warning display lamps 26, or the lighting color of the warning display lamps 26.

The driving-characteristics improving server S4 may include a database (not illustrated) recording the number, arrangement, or control method of the speakers 25 and the warning display lamps 26 (for example, the voice pattern, the lighting color, the lighting pattern, or the like) for each vehicle. In such a case, the driving-characteristics improving server S4 compares the information on the number, arrangement, or control method of the speakers 25 and the warning display lamps 26 of the vehicle C2A from which the transfer data is acquired (collected) with the information on the number, arrangement, or control method of the speakers 25 and the warning display lamps 26 of the vehicle C2B which is the transfer destination of the transfer data, and assigns a method or a device capable of implementing each driving-characteristics improving assistance. The driving-characteristics improving server S4 may train the base artificial intelligence “B” of the vehicle C2B using the assignment result, the personal information on the driver, and the driving-characteristics data as learning data.

Next, an example of generating a transfer data list executed by the wireless terminal device P2 will be described with reference to FIGS. 42 to 45. FIG. 42 is a screen transition diagram for explaining an example of deleting the transfer data. Each of transfer data setting screens SC11, SC12, SC13, and SC14 illustrated in FIG. 42 is an example, and is not limited thereto as a matter of course.

The transfer data list TB9 (see FIG. 39) is generated by the wireless terminal device P2 capable of receiving an operation by the driver or a relative of the driver, and is transmitted to the driving-characteristics improving server S4 to be managed. For ease of understanding, the following will describe an example in which the driver creates the transfer data.

The wireless terminal device P2 generates and displays on a monitor (not illustrated) a transfer data setting screen SC11 capable of receiving an operation of the driver.

The transfer data setting screen SC11 includes a major classification item SL111 “life” and a major classification item SL112 “vehicle” of the transfer data, and a search bar SR. The major classification item SL111 “life” indicates a group for grouping the personal information related to the life information on the driver. The major classification item SL112 “vehicle” indicates a group for grouping the driving-characteristics data related to the driving-characteristics data on the driver.

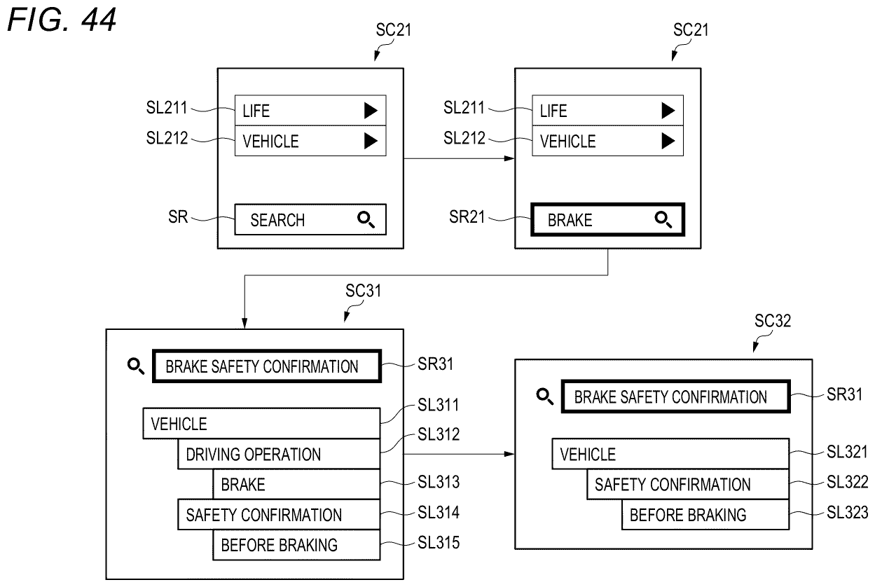

The search bar SR searches for the personal information or personal-characteristics data including a search condition (for example, a word) input by an operation of the driver from each of the personal information and personal-characteristics data on the driver. The wireless terminal device P2 generates a search result screen including the search result and displays the screen on the monitor. The search process using the search bar SR will be described in detail later with reference to FIG. 44.

When receiving an operation of selecting (pressing) the major classification item SL112 “vehicle” by the driver on the transfer data setting screen SC11 illustrated in FIG. 42, the wireless terminal device P2 generates and displays on the monitor the transfer data setting screen SC12 including a medium classification item SL121 “vehicle inspection”, a medium classification item SL122 “driving operation”, and a medium classification item SL123 “safety confirmation” grouped into the major classification item SL112 “vehicle”.

The transfer data setting screen SC12 includes each of medium classification items SL121 to SL123 of the transfer data and the search bar SR. Here, the medium classification item SL121 “vehicle inspection” indicates a group for grouping the improving assistance data (driving-characteristics improving assistance) related to the vehicle inspection. The medium classification item SL122 “driving operation” indicates a group for grouping the improving assistance data (driving-characteristics improving assistance) related to the driving operation by the driver. The medium classification item SL123 “safety confirmation” indicates a group for grouping the improving assistance data (driving-characteristics improving assistance) related to confirm the safety by the driver. The medium classification item SL123 “safety confirmation” may include the improving assistance data (driving-characteristics improving assistance) related to the safety confirmation in a case where the driver is a passenger.

When receiving an operation of selecting (pressing) the medium classification item SL123 “safety confirmation” by the driver on the transfer data setting screen SC12 illustrated in FIG. 42, the wireless terminal device P2 generates and displays on the monitor the transfer data setting screen SC13 including a minor classification item SL131 “before entering vehicle”, a minor classification item SL132 “before exiting vehicle”, . . . that are grouped into the medium classification item SL123 “safety confirmation”.

The transfer data setting screen SC13 includes each of minor classification items SL131, . . . of the transfer data and the search bar SR. Here, the minor classification item SL131 “before entering vehicle” indicates the improving assistance data (driving-characteristics improving assistance) on the safety confirmation behavior in the driving situation “before entering vehicle”. The minor classification item SL132 “before exiting vehicle” indicates the improving assistance data (driving-characteristics improving assistance) on the safety confirmation behavior in the driving situation “before exiting vehicle”.

When receiving an operation of selecting (pressing) the minor classification item SL132 “before exiting vehicle” by the driver on the transfer data setting screen SC13 illustrated in FIG. 42, the wireless terminal device P2 generates and displays on the monitor the transfer data setting screen SC14 including an operation button SL141 “take out”, an operation button SL142 “share”, and an operation button SL143 “delete” related to the improving assistance data (driving-characteristics improving assistance) on the safety confirmation behavior in the driving situation “before exiting vehicle”.

The transfer data setting screen SC14 includes each of the transfer data operation buttons SL141 to SL143.

When the operation button SL143 “delete” is selected by the driver on the transfer data setting screen SC14 illustrated in FIG. 42, the wireless terminal device P2 sets the improving assistance data on the safety confirmation behavior in the driving situation “before exiting vehicle” as cannot be shared (that is, cannot be transferred) to another vehicle. When the operation button SL143 “delete” is selected, the wireless terminal device P2 deletes the personal information or the personal-characteristics data corresponding to the operation button SL143 (here, the improving assistance data on the safety confirmation behavior in the driving situation “before exiting vehicle”) from the transfer data list including the information on the personal information and the personal-characteristics data that can be transferred.

The operation button SL141 “take out” is a button for writing the improving assistance data on the safety confirmation behavior in the driving situation “before exiting vehicle” to the external storage medium EM to transfer the safety confirmation behavior from the vehicle C2A to the vehicle C2B. When the operation button SL141 “take out” is selected by the driver, the wireless terminal device P2 transmits to the operation terminal P3 and writes to the external storage medium EM the improving assistance data on the safety confirmation behavior in the driving situation “before exiting vehicle”.

The operation button SL142 “share” is a button for setting the improving assistance data on the safety confirmation behavior in the driving situation “before exiting vehicle” as can be shared (that is, can be transferred) to another vehicle. When the operation button SL142 “share” is selected, the wireless terminal device P2 generates a transfer data list in which the information that can be transferred is added to the personal information or the personal-characteristics data indicated by the corresponding minor classification item. The personal information or the personal-characteristics data added with the information that can be transferred is used as learning data for the base artificial intelligence of another vehicle.

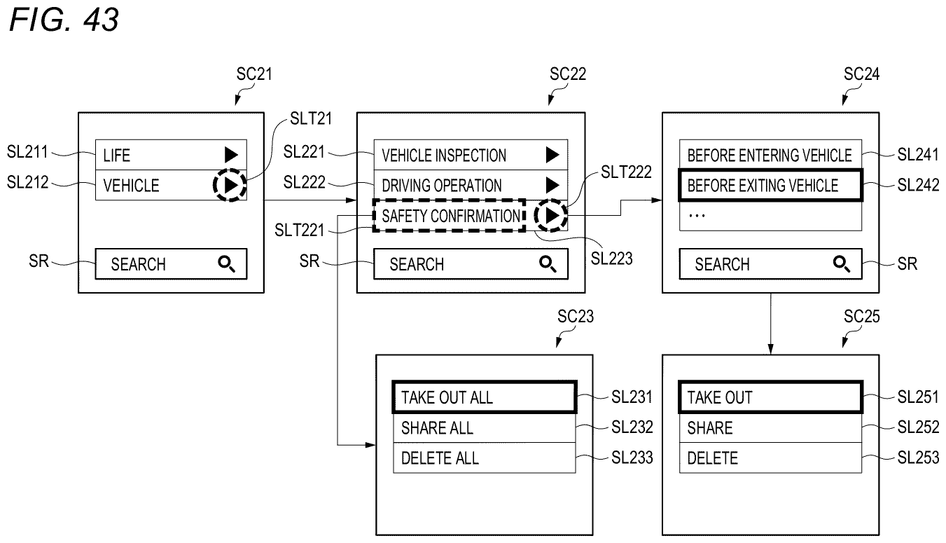

FIG. 43 is a screen transition diagram for explaining an example of setting the transfer data. Each of transfer data setting screens SC21, SC22, SC23, SC24, and SC25 illustrated in FIG. 43 is an example, and is not limited thereto as a matter of course.

The wireless terminal device P2 generates and displays on a monitor (not illustrated) a transfer data setting screen SC21 capable of receiving an operation of the driver.

The transfer data setting screen SC21 includes a major classification item SL211 “life” and a major classification item SL212 “vehicle” of the transfer data, and the search bar SR. The major classification item SL211 “life” indicates a group for grouping the personal information related to the life information on the driver. The major classification item SL212 “vehicle” indicates a group for grouping the driving-characteristics data related to the driving-characteristics data on the driver.

When receiving an operation of selecting (pressing) a medium classification item display button SLT21 of the major classification item SL212 “vehicle” by the driver on the transfer data setting screen SC21 illustrated in FIG. 43, the wireless terminal device P2 generates and displays on the monitor the transfer data setting screen SC22 including a medium classification item SL221 “vehicle inspection”, a medium classification item SL222 “driving operation”, and a medium classification item SL223 “safety confirmation” associated with the major classification item SL212 “vehicle”.

The transfer data setting screen SC22 includes each of medium classification items SL221 to SL223 of the transfer data and the search bar SR. Here, the medium classification item SL221 “vehicle inspection” indicates a group for grouping the improving assistance data (driving-characteristics improving assistance) related to the vehicle inspection. The medium classification item SL222 “driving operation” indicates a group for grouping the improving assistance data (driving-characteristics improving assistance) related to the driving operation by the driver. The medium classification item SL223 “safety confirmation” indicates a group for grouping the improving assistance data (driving-characteristics improving assistance) related to confirm the safety by the driver. The medium classification item SL223 “safety confirmation” may include the improving assistance data (driving-characteristics improving assistance) related to the safety confirmation in a case where the driver is a passenger.

When receiving an operation of selecting (pressing) a selection region SLT221 for batch selecting all the minor classification items included in the medium classification item SL223 “safety confirmation” by the driver on the transfer data setting screen SC22 illustrated in FIG. 43, the wireless terminal device P2 generates and displays on the monitor the transfer data setting screen SC23 including a batch operation button SL231 “take out all”, a batch operation button SL232 “share all”, and a batch operation button SL233 “delete all”.

The transfer data setting screen SC23 includes the batch operation buttons SL231 to SL233. Here, the batch operation button SL231 “take out all” is a button for transmitting the personal information or personal-characteristics data corresponding to each of all minor classification items SL241, SL242, . . . grouped into the medium classification item SL223 “safety confirmation” to the driving-characteristics improving server S4 and executing the management by the driving-characteristics improving server S4.

When the batch operation button SL231 “take out all” is selected by the driver, the wireless terminal device P2 transmits to the operation terminal P3 and writes to the external storage medium EM the personal information or the personal-characteristics data corresponding to each of all the minor classification items SL241, SL242, . . . grouped into the medium classification item SL223 “safety confirmation”.

When the batch operation button SL232 “share all” is selected by the driver, the wireless terminal device P2 sets the personal information or the personal-characteristics data corresponding to each of all the minor classification items SL241, SL242, . . . grouped into the medium classification item SL223 “safety confirmation” as can be shared (that is, can be transferred) to another vehicle, and generates a transfer data list to which the information that can be transferred is added.

When receiving an operation of selecting (pressing) the batch operation button SL233 “delete all” by the driver, the wireless terminal device P2 sets the personal information or the personal-characteristics data corresponding to each of all the minor classification items SL241, SL242, . . . grouped into the medium classification item SL223 “safety confirmation” as cannot be shared (that is, cannot be transferred) to another vehicle, and deletes the personal information or the personal-characteristics data grouped into the medium classification item SL223 “safety confirmation” from the transfer data list.

When receiving an operation of selecting (pressing) a selection region SLT222 for displaying all the minor classification items included in the medium classification item SL223 “safety confirmation” by the driver on the transfer data setting screen SC22 illustrated in FIG. 43, the wireless terminal device P2 generates and displays on the monitor the transfer data setting screen SC23 including all the minor classification items SL241, SL242, . . . included in the medium classification item SL223 “safety confirmation”.

The transfer data setting screen SC24 includes minor classification items SL241, . . . and the search bar SR.

When receiving an operation of selecting (pressing) the minor classification item SL242 “before exiting vehicle” by the driver on the transfer data setting screen SC24 illustrated in FIG. 43, the wireless terminal device P2 generates and displays on the monitor the transfer data setting screen SC25 including an operation button SL251 “take out”, an operation button SL252 “share”, and an operation button SL253 “delete” related to the improving assistance data (driving-characteristics improving assistance) on the safety confirmation behavior in the driving situation “before exiting vehicle”.

The transfer data setting screen SC25 includes each of the transfer data operation buttons SL251 to SL253.

When receiving an operation of selecting (pressing) the operation button SL251 “take out” by the driver on the transfer data setting screen SC25 illustrated in FIG. 43, the wireless terminal device P2 transmits to the operation terminal P3 and writes to the external storage medium EM the improving assistance data on the safety confirmation behavior in the driving situation “before exiting vehicle”. Since the operation button SL252 is the same as the operation button SL142 illustrated in FIG. 42, the description thereof is omitted. Moreover, since the operation button SL253 is the same as the operation button SL143 illustrated in FIG. 42, the description thereof is omitted.

FIG. 44 is a screen transition diagram for explaining an example of searching the transfer data. Each of the transfer data setting screens SC21, SC22, SC31, and SC32 illustrated in FIG. 44 is an example, and is not limited thereto as a matter of course.

The wireless terminal device P2 receives an input operation of a search condition “brake” by the search bar SR21 in the search bar SR21 on the transfer data setting screen SC21 illustrated in FIG. 44. The wireless terminal device P2 searches for the personal information or the personal-characteristics data satisfying the search condition “brake” among all the personal information and the personal-characteristics data, and generates and displays on the monitor the transfer data setting screen SC31 including the search result.

The transfer data setting screen SC31 includes minor classification items SL313 and SL315 that satisfy the search condition “brake”, medium classification items SL312 and SL314 for grouping the minor classification items SL313 and SL315, and a major classification item SL311 for grouping the medium classification items SL312 and SL314. The transfer data setting screen SC31 may be generated to include only the minor classification items SL313 and SL315 satisfying the search condition “brake”.

The wireless terminal device P2 receives an input operation of the search condition “brake+safety confirmation” by the search bar SR31 in the search bar SR31 of the transfer data setting screen SC31 illustrated in FIG. 44. The wireless terminal device P2 searches for the personal information or the personal-characteristics data satisfying the search condition “brake+safety confirmation” among all the personal information and the personal-characteristics data, and generates and displays on the monitor the transfer data setting screen SC32 including the search result.

The transfer data setting screen SC32 includes a medium classification item SL322 satisfying the search condition “brake+safety confirmation”, a major classification item SL321 for grouping the medium classification item SL322, and a minor classification item SL323 for grouping the medium classification item SL322. The transfer data setting screen SC32 may be generated to include only the medium classification item SL322 satisfying the search condition “brake+safety confirmation”.

The search bar SR may receive input of a search condition via an input interface (for example, a touch panel, a keyboard, or the like) included in the wireless terminal device P2 or connected to the wireless terminal device P2, or may receive an input of a search condition by performing voice recognition on a spoken voice received by a microphone (not illustrated) included in the wireless terminal device P2.

FIG. 45 is a screen transition diagram for explaining an example of editing the transfer data. Each of transfer data setting screens SC41 and SC42 and the system diagram of the personal information/personal-characteristics data illustrated in FIG. 45 is an example, and is not limited thereto as a matter of course.

The wireless terminal device P2 generates and displays on a monitor (not illustrated) a transfer data setting screen SC21 capable of receiving an operation of the driver.

The transfer data setting screen SC41 includes a major classification item SL411 “life”, a major classification item SL412 “vehicle” and a favorite item SL413 of the transfer data, and a search bar SR. The major classification item SL411 “life” indicates a group for grouping the personal information related to the life information on the driver. The major classification item SL412 “vehicle” indicates a group for grouping the driving-characteristics data related to the driving-characteristics data on the driver. The favorite item SL413 indicates one or more pieces of the personal information or the personal-characteristics data grouped based on an operation of the driver.

When receiving an operation of selecting (pressing) an entry button SLT41 by the driver on the transfer data setting screen SC41 illustrated in FIG. 45, the wireless terminal device P2 generates and displays on the monitor the transfer data setting screen SC42 including items grouped into the favorite item SL413.

The transfer data setting screen SC42 includes a grouping item SL421 “sleep” grouped by the driver, a grouping item SL422 “confirmation upon entry and exit”, a grouping item SL423 “confirmation during driving”, and the search bar SR.

When receiving an operation of selecting (pressing) the grouping item SL421 “sleep” by the driver on the transfer data setting screen SC41 illustrated in FIG. 45, the wireless terminal device P2 generates and displays on the monitor a transfer data setting screen (not illustrated) including a list LST1 grouped into the grouping item SL421 “sleep”. In the example illustrated in FIG. 45, the list LST1 includes the grouping item SL421 and the plurality of minor classification items “sleeping time”, “waking time”, “breathing rate”, and “sleep quality” grouped into the grouping item SL421.

When receiving an operation of selecting (pressing) the grouping item SL422 “confirmation upon entry and exit” by the driver on the transfer data setting screen SC41 illustrated in FIG. 45, the wireless terminal device P2 generates and displays on the monitor a transfer data setting screen (not illustrated) including various items (list LST2) created by the driver and grouped into the grouping item SL422 “confirmation upon entry and exit”. In the example illustrated in FIG. 45, the list LST2 includes the plurality of minor classification items “before entering vehicle”, “before exiting vehicle”, and “before passenger exiting vehicle”.

When receiving an operation of selecting (pressing) the grouping item SL423 “confirmation during driving” by the driver on the transfer data setting screen SC41 illustrated in FIG. 45, the wireless terminal device P2 generates and displays on the monitor a transfer data setting screen (not illustrated) including various items (list LST3) created by the driver and grouped into the grouping item SL423 “confirmation during driving”. In the example illustrated in FIG. 45, the list LST3 includes the plurality of minor classification items “before starting vehicle”, “before braking”, “before changing lane”, “traveling straight”, “before right/left turn”, and “before moving vehicle backward”.

The wireless terminal device P2 changes and rearranges the names of the various items (major classification items, medium classification items, and minor classification items) included in the respective lists LST1 to LST3 based on an operation of the driver.

For example, when receiving an operation of editing a grouping item by the driver, the wireless terminal device P2 further receives an operation of generating or changing the name “confirmation during driving” of the grouping item, and an operation of selecting, rearranging, or deleting the various items grouped into the grouping item. Accordingly, the wireless terminal device P2 generates the grouping item SL422 “confirmation upon entry and exit” including each of the plurality of minor classification items “before entering vehicle”, “before exiting vehicle”, and “before passenger exiting vehicle”.

For example, the wireless terminal device P2 rearranges the minor classification item “before right/left turn” after the minor classification item “before starting vehicle” based on an operation of the driver. Accordingly, the wireless terminal device P2 can change the order of the minor classification items displayed on the subsequent transfer data setting screen to “before starting vehicle”, “before right/left turn”, “before braking”, . . . .

As described above, the driving-characteristics improving assistance system 300 according to Embodiment 3 is a control method executable by the driving-characteristics improving server S4 or the operation terminal P3 (an example of a computer) that can cooperate with at least the vehicle C2A (an example of a first vehicle) and the vehicle C2B (an example of a second vehicle). The control method includes: receiving input of the personal-characteristics data corresponding to the driver who drives the vehicle C2A, the personal-characteristics data being acquired by the vehicle C2A and being used for the improving assistance of the driving-characteristics of the driver; and, if a predetermined condition is satisfied, outputting the personal-characteristics data corresponding to the driver such that the personal-characteristics data can be used by the vehicle C2B.

Accordingly, the driving-characteristics improving assistance system 300 according to Embodiment 3 can receive the input of the personal information and the personal-characteristics data on the driver from the external storage medium EM or the vehicle C2A before the switching, and, if the driver switches to a different vehicle, transmit to the vehicle C2B after the switching the personal information and the personal-characteristics data on the driver collected (acquired) by the vehicle C2A before switching. Accordingly, the driving-characteristics improving assistance system 300 can protect the personal information on the driver by preventing to transfer (share) the personal information and the personal-characteristics data that the driver does not desire to, and can implement driving-characteristics improving assistance more suitable for the driver in different vehicles.

The driving-characteristics improving server S4 or the operation terminal P3 of the driving-characteristics improving assistance system 300 according to Embodiment 3 is implemented with at least one computer. Accordingly, the driving-characteristics improving assistance system 300 according to Embodiment 3 can manage the driving-characteristics data on the driver collected in each of the different vehicles C2A and C2B using the computer.

The predetermined condition in the driving-characteristics improving assistance system 300 according to Embodiment 3 is when the driving-characteristics improving server S4 or the operation terminal P3 receives a predetermined instruction (specifically, a control command indicating the detection of the switch of the driver to another vehicle, an operation of the administrator starting transferring the transfer data on the driver, or the like). Accordingly, the driving-characteristics improving assistance system 300 according to Embodiment 3 can transfer the driving-characteristics data on the driver between the vehicles C2A and C2B when the driver switches from the vehicle C2A or at a timing desired by the administrator. Accordingly, the driving-characteristics improving assistance system 300 can protect the personal information on the driver by preventing to transfer (share) the personal information and the personal-characteristics data that the driver does not desire to, and can implement driving-characteristics improving assistance more suitable for the driver in different vehicles.

The predetermined instruction in the driving-characteristics improving assistance system 300 according to Embodiment 3 includes information identifying (designating) the driver. Accordingly, the driving-characteristics improving assistance system 300 according to Embodiment 3 transfers only the personal information or the personal-characteristics data on the identified driver between the vehicles, and thus can prevent to transfer (share) the personal information and the personal-characteristics data that the driver does not desire to.

The driving-characteristics improving server S4 or the operation terminal P3 of the driving-characteristics improving assistance system 300 according to Embodiment 3 is a control method including a transmission circuit and a reception circuit (that is, the communication units 51, 61). The personal-characteristics data corresponding to the driver who drives the vehicle C2A is received from the vehicle C2A by the reception circuit. The personal-characteristics data is acquired by the vehicle C2A and is used for the improving assistance of the driving-characteristics of the driver. If the predetermined condition is satisfied, the personal-characteristics data corresponding to the driver is transmitted to the vehicle C2B by the transmission circuit. The predetermined condition is when it is detected that the driver enters the vehicle C2B. Accordingly, the driving-characteristics improving assistance system 300 according to Embodiment 3 transfers only the personal information or the personal-characteristics data on the identified driver between the vehicles, and thus can prevent to transfer (share) the personal information and the personal-characteristics data that the driver does not desire to.

If the driver is defined as a first driver, the driving-characteristics improving assistance system 300 according to Embodiment 3: receives first personal-characteristics data corresponding to the first driver who drives the vehicle C2A, the first personal-characteristics data being acquired by the vehicle C2A and being used for the improving assistance of the driving-characteristics of the first driver; receives second personal-characteristics data corresponding to a second driver who drives the vehicle C2A, the second personal-characteristics data being acquired by the vehicle C2A and being used for improving assistance of driving-characteristics of the second driver; transmits the first personal-characteristics data corresponding to the first driver to the vehicle C2B if it is detected that the first driver enters the vehicle C2B; and transmits the second personal-characteristics data corresponding to the second driver to the vehicle C2B if it is detected that the second driver enters the vehicle C2B. Accordingly, the driving-characteristics improving assistance system 300 according to Embodiment 3 can protect the personal information on the driver by preventing to transfer (share) the personal information and the personal-characteristics data that the driver does not desire to, and can implement driving-characteristics improving assistance more suitable for the driver in different vehicles.

In the driving-characteristics improving assistance system 300 according to Embodiment 3, the personal-characteristics data is learning data for a driving assistance model configured to be executed by the vehicle C2B. The driving assistance model is used for the improving assistance of the driving-characteristics of the driver. Accordingly, the driving-characteristics improving assistance system 300 according to Embodiment 3 is capable of implementing driving-characteristics improving assistance more suitable for the driver even in the vehicle C2B different from the vehicle C2A.

In the personal-characteristics data in the driving-characteristics improving assistance system 300 according to Embodiment 3, the personal-characteristics data is at least one piece of personal-characteristics data designated by the driver among a plurality of pieces of personal-characteristics data acquired by the vehicle C2A. Accordingly, even if the personal information and the personal-characteristics data on a predetermined driver are to be transferred between a private car used by the driver and a vehicle that can be used by an unspecified number of drivers (rental car, car shared vehicle) or the like, the driving-characteristics improving assistance system 300 according to Embodiment 3 can transfer (share) only the personal information and the personal-characteristics data on the driver desired by the driver. Therefore, it is possible to protect the personal information on the driver and implement driving-characteristics improving assistance more suitable for the driver in different vehicles.

The driving-characteristics improving server S4 or the operation terminal P3 in the driving-characteristics improving assistance system 300 according to Embodiment 3 receives input of predetermined personal-characteristics data among a plurality of pieces of personal-characteristics data acquired by the vehicle C2A. Accordingly, the driving-characteristics improving assistance system 300 according to Embodiment 3 can protect the personal information on the driver by preventing to transfer (share) the personal information and the personal-characteristics data that the driver does not desire to, and can implement driving-characteristics improving assistance more suitable for the driver in different vehicles.

The driving-characteristics improving server S4 in the driving-characteristics improving assistance system 300 according to Embodiment 3 receives designation of the predetermined personal-characteristics data from the outside (for example, the wireless terminal device P2 operated by the driver). Accordingly, the driving-characteristics improving assistance system 300 according to Embodiment 3 can transfer (share) only the personal information and the personal-characteristics data desired by the driver.

The driving-characteristics improving server S4 in the driving-characteristics improving assistance system 300 according to Embodiment 3 can store a plurality of pieces of personal-characteristics data acquired by the vehicle C2A, and outputs predetermined personal-characteristics data among the plurality of pieces of stored personal-characteristics data. Accordingly, the driving-characteristics improving assistance system 300 according to Embodiment 3 can transfer (share) only the personal information and the personal-characteristics data desired by the driver.

The driving-characteristics improving server S4 in the driving-characteristics improving assistance system 300 according to Embodiment 3 receives designation of the predetermined personal-characteristics data from the outside (for example, the wireless terminal device P2 operated by the driver). Accordingly, the driving-characteristics improving assistance system 300 according to Embodiment 3 can transfer (share) only the personal information and the personal-characteristics data desired by the driver.

The driving-characteristics improving server S4 in the driving-characteristics improving assistance system 300 according to Embodiment 3 can store a plurality of pieces of personal-characteristics data acquired by the first vehicle, and can delete at least one among the plurality of pieces of stored personal-characteristics data according to an instruction from the outside (for example, the wireless terminal device P2 operated by the driver). Accordingly, the driving-characteristics improving assistance system 300 according to Embodiment 3 can transfer (share) only the personal information and the personal-characteristics data desired by the driver.

The present disclosure also includes technical ideas defined in the following items.

### (A-1)

A management method for driving-characteristics data executed by one or more computers, the management method for driving-characteristics data including:
registering registered biological information on a plurality of drivers in association with license IDs of the drivers;
acquiring biological information on a driver who drives a vehicle and the driving-characteristics data indicating driving-characteristics of the drivers; and
if it is determined some registered biological information is the same as or similar to the biological information among the registered biological information on the plurality of drivers, recording a license ID associated with the same or similar registered biological information in association with the driving-characteristics data.

### (A-2)

The management method for driving-characteristics data according to (A-1), further including:
acquiring the biological information, the driving-characteristics data, and vehicle identification information for identifying the vehicle; and
if it is determined that some registered biological information is the same as or similar to the biological information among the registered biological information on the plurality of drivers, recording the license ID associated with the same or similar registered biological information in association with the driving-characteristics data and the vehicle identification information.

### (A-3)

The management method for driving-characteristics data according to (A-2), further including:
temporarily storing the driving-characteristics data in association with the vehicle identification information if it is determined that no registered biological information is the same as or similar to the biological information among the registered biological information on the plurality of registered drivers.

### (A-4)

The management method for driving-characteristics data according to (A-3), further including:
further acquiring end-of-driving information on the vehicle; and
temporarily storing the driving-characteristics data in association with the vehicle identification information if it is determined that no registered biological information is the same as or similar to the biological information among the registered biological information on the plurality of registered drivers at a timing of acquiring the end-of-driving information.

### (A-5)

The management method for driving-characteristics data according to (A-3), further including:
acquiring new biological information on the driver who drives the vehicle if it is determined that no registered biological information the same as or similar to the biological information among the registered biological information on the plurality of registered drivers; and
recording a license ID associated with the same or similar registered biological information in association with the temporarily stored driving-characteristics data and the vehicle identification information if it is determined that some registered biological information the same as or similar to the biological information among the registered biological information on the plurality of registered drivers.

### (A-6)

The management method for driving-characteristics data according to (A-1), further including:
deleting the driving-characteristics data if it is determined that no registered biological information is the same as or similar to the biological information among the registered biological information on the plurality of registered drivers.

### (A-7)

The management method for driving-characteristics data according to (A-1), further including:
further acquiring end-of-driving information on the vehicle; and
deleting the driving-characteristics data if it is determined that no registered biological information is the same as or similar to the biological information among the registered biological information on the plurality of registered drivers at a timing of acquiring the end-of-driving information.

### (A-8)

The management method for driving-characteristics data according to (A-1), further including:
acquiring the registered biological information on the driver and a license ID of a driver corresponding to the registered biological information; and
registering the registered biological information and the license ID in association if it is determined that the registered biological information matches a face image of the driver included in the license ID.

### (A-9)

The management method for driving-characteristics data according to (A-1), in which
the registered biological information is face images of the plurality of drivers, and
the biological information is a face image of the driver who drives the vehicle.

### (A-10)

The management method for driving-characteristics data according to (A-1), further including:
registering a first registered face image in which a face of the driver faces a first direction and a second registered face image in which the face of the driver faces a second direction different from the first direction, in association with the license ID;
acquiring a first face image in which the face of the driver who drives the vehicle faces the first direction and a second face image in which the face of the driver faces the second direction, and the driving-characteristics data;
comparing whether a first registered face image is the same as or similar to the first face image among the first registered face images of the plurality of registered drivers and whether a second registered face image is the same as or similar to the second face image among the second registered face images of the plurality of registered drivers; and
if it is determined that a first registered face image is the same as or similar to the first face image and a second registered face image is the same as or similar to the second face image, recording a license ID associated with the same or similar first registered face image and second registered face image in association with the driving-characteristics data.

### (A-11)

The management method for driving-characteristics data according to (A-10), further including:
if it is determined that no first registered face images are the same as or similar to the first face image, acquiring a new first face image and determining again whether any first registered face image is the same as or similar to the new first face image among the first registered face images of the plurality of registered drivers; and
if it is determined that no second registered face images are the same as or similar to the second face image, acquiring a new second face image and determining again whether any second registered face image is the same as or similar to the new second face image among the second registered face images of the plurality of registered drivers.

### (A-12)

An on-vehicle device for being mounted on a vehicle, the on-vehicle device including:
a communication unit configured to perform data communication with an external device;
a first acquiring unit configured to acquire biological information on a driver who drives the vehicle;
a second acquiring unit configured to acquire driving-characteristics data indicating driving-characteristics of the driver; and
a control unit configured to output the biological information in association with the driving-characteristics data, in which
the control unit outputs to the communication unit and transmits to the external device the associated biological information and driving-characteristics data.

### (A-13)

The on-vehicle device according to (A-12), further including:

a recording unit configured to record vehicle identification information for identifying the vehicle, in which
the control unit outputs to the communication unit and transmits to the external device the acquired biological information and driving-characteristics data in association with the vehicle identification information.

### (A-14)

The on-vehicle device according to (A-12), further including:
a third acquiring unit configured to acquire entry information or exit information on the driver to/from the vehicle, in which
the control unit causes the first acquiring unit to start acquiring the biological information and causes the second acquiring unit to start acquiring the driving-characteristics data from a timing of acquiring the entry information on the driver by the third acquiring unit.

### (A-15)

The on-vehicle device according to (A-14), in which
the control unit causes the first acquiring unit to end acquiring the biological information and causes the second acquiring unit to end acquiring the driving-characteristics data from a timing of acquiring the exit information on the driver by the third acquiring unit.

### (A-16)

The on-vehicle device according to (A-12), in which
the first acquiring unit is a camera configured to image a face of the driver, and
the biological information is a face image of the driver captured by the first acquiring unit.

### (A-17)

The on-vehicle device according to (A-16), in which
the control unit outputs to the communication unit and transmits to the external device the face image in association with the driving-characteristics data if it is determined that a face orientation of the driver appearing in the face image captured by the first acquiring unit is a predetermined orientation.

### (A-18)

The on-vehicle device according to (A-16), in which
the communication unit receives designation of a face orientation of the driver appearing in the face image from the external device, and
the control unit outputs to the communication unit and transmits to the external device the face image in association with the driving-characteristics data if it is determined that the face orientation of the driver appearing in the face image is the designated face orientation of the driver.

### (A-19)

The on-vehicle device according to (A-13), further including:
a fourth acquiring unit configured to acquire a license ID of the driver, in which
the control unit outputs to the communication unit and transmits to the external device the biological information and the vehicle identification information in association with the license ID.

The present disclosure also includes technical ideas defined in the following items.

### (B-1)

A management method for driving-characteristics improving assistance data executed by one or more computers configured to communicate with at least one vehicle, the management method for driving-characteristics improving assistance data including:
registering a plurality of pieces of driving situation information indicating driving situations of the vehicle, assistance data corresponding to the driving situation information for assisting to improve a safety confirmation behavior of a driver who drives the vehicle, and driving-characteristics data on the driver in the driving situation information in association with each driver ID of a plurality of drivers;
transmitting the driving situation information to the vehicle in association with the assistance data;
acquiring the driver ID of the driver who drives the vehicle, the driving-characteristics data on the driver corresponding to the driving situation information, and emotion data on the driver for assistance based on the assistance data;
comparing the driver ID of each of the plurality of drivers with the acquired driver ID;
generating new assistance data corresponding to the acquired driving situation information based on the driving-characteristics data associated with a matching driver ID and the acquired driving-characteristics data and emotion data; and
updating the assistance data associated with driving situation information the same as the acquired driving situation information among a plurality of pieces of driving situation information associated with the matching driver ID to the generated new assistance data.

### (B-2)

The management method for driving-characteristics improving assistance data according to (B-1), further including:
determining whether driving-characteristics of the driver in the driving situation are improved using the acquired driving-characteristics data and the registered driving-characteristics data; and
generating the new assistance data based on a determination result on the emotion data and as to whether the driving-characteristics are improved.

### (B-3)

The management method for driving-characteristics improving assistance data according to (B-2), further including:
if it is determined that the emotion data is positive and the driving-characteristics are improved,
   updating the assistance data associated with the plurality of pieces of driving situation information associated with the matching driver ID to the generated new assistance data.

### (B-4)

The management method for driving-characteristics improving assistance data according to (B-2), further including:
if it is determined that the emotion data is positive and the driving-characteristics are not improved,
   generating the new assistance data at a frequency of assistance increased relative to the assistance data corresponding to the acquired driving situation information, and
   updating the assistance data associated with the driving situation information the same as the acquired driving situation information to the generated new assistance data.

### (B-5)

The management method for driving-characteristics improving assistance data according to (B-2), further including:
if it is determined that the emotion data is negative and the driving-characteristics are improved,
   generating the new improving effect data different from the assistance data corresponding to the acquired driving situation information,
   updating assistance data associated with other driving situation information different from the acquired driving situation information to the generated new assistance data, and
   omitting change of the assistance data associated with the driving situation information the same as the acquired driving situation information.

### (B-6)

The management method for driving-characteristics improving assistance data according to (B-2), further including:
if it is determined that the emotion data is negative and the driving-characteristics are not improved,
   generating the new improving effect data different from the assistance data corresponding to the acquired driving situation information, and
   updating the assistance data associated with the driving situation information the same as the acquired driving situation information to the generated new assistance data.

### (B-7)

The management method for driving-characteristics improving assistance data according to (B-1), in which
the assistance data is a control command for controlling a safe driving assistance device configured to be mounted on the vehicle and execute the assistance by voice or light.

### (B-8)

The management method for driving-characteristics improving assistance data according to (B-5) or (B-6), in which
the assistance data is a control command for controlling a safe driving assistance device configured to be mounted on the vehicle and execute the assistance by voice or light, and
the method further includes:
   generating the new assistance data for executing the assistance by either the voice or the light if the emotion data is negative.

### (B-9)

The management method for driving-characteristics improving assistance data according to (B-5) or (B-6), in which
the assistance data is a control command for controlling a safe driving assistance device configured to be mounted on the vehicle and execute the assistance by voice or light, and
the method further includes:
   generating the new assistance data at a decreased frequency of the assistance by the voice or the light relative to the assistance data corresponding to the acquired driving situation information if the emotion data is negative.

### (B-10)

A management method for driving-characteristics improving assistance data executed by a vehicle, the management method for driving-characteristics improving assistance data including:
storing a plurality of pieces of driving situation information indicating driving situations of the vehicle, and assistance data corresponding to the driving situation information for assisting to improve a safety confirmation behavior of a driver who drives the vehicle, in association with a driver ID of the driver;
acquiring, by a sensor, driving-characteristics data on the driver in the driving situation information, and emotion data on the driver for assistance based on the assistance data corresponding to the driving situation information;
transmitting the acquired driving-characteristics data and emotion data and the driving situation information for which the driving-characteristics data and the emotion data are acquired to an external device in association with the driver ID;
acquiring new assistance data corresponding to the driving situation information transmitted from the external device; and
updating the assistance data associated with the driving situation information to the acquired new assistance data.

### (B-11)

A management method for driving-characteristics improving assistance data executed by one or more computers mounted on a vehicle, the management method for driving-characteristics improving assistance data including:
storing a plurality of pieces of driving situation information indicating driving situations of the vehicle, and assistance data corresponding to the driving situation information for assisting to improve a safety confirmation behavior of a driver who drives the vehicle, in association with a driver ID of the driver;
acquiring, by a sensor, driving-characteristics data on the driver in the driving situation information, and emotion data on the driver for assistance based on the assistance data corresponding to the driving situation information;
transmitting the acquired driving-characteristics data and emotion data and the driving situation information for which the driving-characteristics data and the emotion data are acquired to an external device in association with the driver ID;
acquiring new assistance data corresponding to the driving situation information transmitted from the external device; and
updating the assistance data associated with the driving situation information to the acquired new assistance data.

Although various embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the invention.

### INDUSTRIAL APPLICABILITY

The present disclosure is useful as a control method for assisting the management of driving-characteristics data on a driver collected by different vehicles and the transfer of the driving-characteristics data on the driver between the vehicles.

What is claimed is:

1. A control method executable by a computer configured to cooperate with at least a first vehicle and a second vehicle, the control method comprising:
receiving input of personal-characteristics data corresponding to a driver who drives the first vehicle, the personal-characteristics data being acquired by the first vehicle and being used for improving assistance of driving-characteristics of the driver; and
when a predetermined condition is satisfied, outputting the personal-characteristics data corresponding to the driver such that the personal-characteristics data can be used by the second vehicle.

2. The control method according to claim 1,
wherein the computer includes at least one computer.

3. The control method according to claim 1,
wherein the predetermined condition is when the computer receives a predetermined instruction.

4. The control method according to claim 3,
wherein the predetermined instruction includes information identifying the driver.

5. The control method according to claim 1,
wherein the computer includes a transmission circuit and a reception circuit,
wherein the personal-characteristics data corresponding to the driver who drives the first vehicle is received from the first vehicle by the reception circuit, the personal-characteristics data being acquired by the first vehicle and being used for the improving assistance of the driving-characteristics of the driver,
wherein, when the predetermined condition is satisfied, the personal-characteristics data corresponding to the driver is transmitted to the second vehicle by the transmission circuit, and
wherein the predetermined condition is when it is detected that the driver enters the second vehicle.

6. The control method according to claim 5,
wherein the driver is defined as a first driver, and
wherein the control method comprises:
receiving first personal-characteristics data corresponding to the first driver who drives the first vehicle, the first personal-characteristics data being acquired by the first vehicle and being used for the improving assistance of the driving-characteristics of the first driver;
receiving second personal-characteristics data corresponding to a second driver who drives the first vehicle, the second personal-characteristics data being acquired by the first vehicle and being used for improving assistance of driving-characteristics of the second driver;
transmitting the first personal-characteristics data corresponding to the first driver to the second vehicle if it is detected that the first driver enters the second vehicle; and
transmitting the second personal-characteristics data corresponding to the second driver to the second vehicle if it is detected that the second driver enters the second vehicle.

7. The control method according to claim 1,
wherein the personal-characteristics data is learning data for a driving assistance model configured to be executed by the second vehicle, the driving assistance model being used for the improving assistance of the driving-characteristics of the driver.

8. The control method according to claim 1,
wherein the personal-characteristics data is at least one piece of personal-characteristics data designated by the driver among a plurality of pieces of personal-characteristics data acquired by the first vehicle.

9. The control method according to claim 1,
wherein the computer receives input of predetermined personal-characteristics data among a plurality of pieces of personal-characteristics data acquired by the first vehicle.

10. The control method according to claim 9,
wherein the computer receives designation of the predetermined personal-characteristics data from outside.

11. The control method according to claim 1,
wherein the computer is configured to store a plurality of pieces of personal-characteristics data acquired by the first vehicle, and output predetermined personal-characteristics data among the plurality of pieces of stored personal-characteristics data.

12. The control method according to claim 11,
wherein the computer receives designation of the predetermined personal-characteristics data from outside.

13. The control method according to claim 1,
wherein the computer is configured to store a plurality of pieces of personal-characteristics data acquired by the first vehicle, and delete at least one among the stored plurality of pieces of personal-characteristics data in response to an instruction from outside.
